(19) United States
(12) Patent Application Publication
(10) Pub. No.: US 2012/0059865 A1
(43) Pub. Date: Mar. 8, 2012

(54) ANALYSIS METHOD USING FINITE ELEMENT METHOD, AND ANALYTICAL COMPUTATION PROGRAM USING FINITE ELEMENT METHOD

(75) Inventors: Changcheng SHAO, Nagoya-City (JP); Toshiya IINUMA, Nishio-City (JP)

(73) Assignee: AISIN AW CO., LTD., Anjo-shi (JP)

(21) Appl. No.: 13/223,390

(22) Filed: Sep. 1, 2011

(30) Foreign Application Priority Data
Sep. 3, 2010 (JP) 2010-198386
Mar. 4, 2011 (JP) 2011-047445

(51) Int. Cl. G06F 1/02; G06F 17/16; G06F 17/11

(52) U.S. Cl. 708/270

(57) ABSTRACT

An analysis method using a finite element method includes: selecting an analysis domain to be analyzed; dividing the analysis domain into elements as calculation objects; creating a matrix of each element; integrating a general function term as a product of a Galerkin weight function and a general function; creating simultaneous equations, based on the sum of matrices of respective elements and the sum of values obtained by integrating the general function term, and obtaining a numerical solution from the simultaneous equations. In integrating the general function term, the concept of a nodal domain defined based on a result of discretization of a second-order differential term according to a Galerkin finite element method is introduced, and the general function term using a typical value of the element is integrated.

### INCORPORATION BY REFERENCE

The disclosure of Japanese Patent Application No. 2011-047445 filed on Mar. 4, 2011 including the specification, drawings and abstract is incorporated herein by reference in its entirety.

### BACKGROUND OF THE INVENTION

The present invention relates to an analysis method using a finite element method, and an analytical computation program using the finite element method. In particular, the invention is concerned with an analysis method using the finite element method, which aims at reducing errors that occur depending on the shape of elements (or mesh pattern), and an analytical computation program using the finite element method.

### Description of the Related Art

Generally, in the finite element method, a Galerkin weight function having the same form as a shape function is applied to each term of a differential equation, which is then integrated over an element domain around a node, so as to obtain numerical solutions. The finite element method, which is characterized by clear evaluation of errors and high versatility, is one of the most widely used numerical solutions. However, the finite element method still suffers from problems that analysis results differ or numerical errors increase, depending on the mesh pattern.

(Two-dimensional Triangle Problem using Known Finite Element Method) When a Poisson equation is discretized on a linear triangular mesh, for example, the same solutions should be inherently obtained; however, different analysis results are obtained depending on the element shape. If algebraic equations obtained from meshes of two patterns indicated in “Basic Finite Element Method” written by Shao Changcheng (see, in particular, Chapter 5), published by Morikita Shuppan, 2008 are compared with each other, the results of discretization of second-order differential terms are in the same form, but the results of discretization of source terms are different from each other. By applying the weight function to the source term and integrating the term, the source amount is distributed almost evenly to algebraic equations of respective nodes, irrespective of the element shape, and consistency with other terms cannot be achieved, resulting in a situation where the conservation law at the node level is not satisfied. Details of the inconsistency will be provided below.

A two-dimensional Poisson equation is indicated below.

$$\frac{\partial }{\partial x} ( λ \frac{\partial T}{\partial x} ) + \frac{\partial }{\partial y} ( λ \frac{\partial T}{\partial y} ) = - Q \qquad ( 1 )$$

While this equation describes physical phenomena of numerous fields, the following explanation is concerned with a heat conduction problem by way of example. In Equation (1), T is the temperature, λ is the thermal conductivity, and Q is the quantity of heat generated per unit time, per unit area, which is called “source term”. If the finite element method is applied to Equation (1), the following equation is obtained as an integral equation with respect to an object node P concerned.

$$- \int {\int }_{Ω} W \{ \frac{\partial }{\partial x} ( λ \frac{\partial T}{\partial x} ) + \frac{\partial }{\partial y} ( λ \frac{\partial T}{\partial y} ) \} d x d y = \int {\int }_{Ω} WQ d x d y \qquad ( 2 )$$

In Equation (2), Ω is a domain comprised of elements around node P as shown in FIG. 1, and W is a Galerkin weight function that takes 1 at node P defined on Ω and takes 0 at the boundary of Ω. Since the integral over Ω is the sum of integrals over the respective elements, Equation (2) may be rewritten into Equation (3) as follows.

$$- {\sum }_{e} \int {\int }_{e} W \{ \frac{\partial }{\partial x} ( λ \frac{\partial T}{\partial x} ) + \frac{\partial }{\partial y} ( λ \frac{\partial T}{\partial y} ) \} d x d y = {\sum }_{e} \int {\int }_{e} WQ d x d y \qquad ( 3 )$$

In Equation (3), e represents elements around node P, and

$${\sum }_{e}$$

means the sum of results of computations over the respective elements. If the element e is fitted or converted into a linear triangular element of FIG. 2, the result of element integration on the left-hand side of Equation (3) can be arranged as in the following equation, using integration by parts and the Gauss-Green theorem.

$$- \int {\int }_{e} W \{ \frac{\partial }{\partial x} ( λ \frac{\partial T}{\partial x} ) + \frac{\partial }{\partial y} ( λ \frac{\partial T}{\partial y} ) \} d x d y = {d}_{CI} \times λ \frac{{T}_{1} - {T}_{2}}{\sqrt{{x}_{2}^{2} + {y}_{2}^{2}}} + {d}_{CK} \times λ \frac{{T}_{1} - {T}_{3}}{\sqrt{{x}_{3}^{2} + {y}_{3}^{2}}} \qquad ( 4 )$$

where a local coordinate system is used, the object node P is denoted as local node 1, numerical subscripts represent node numbers, and boundary integration is separately considered.

$$λ \frac{{T}_{1} - {T}_{2}}{\sqrt{{x}_{2}^{2} + {y}_{2}^{2}}}$$

in the first term of the right-hand side of Equation (4) is a second-order accurate approximation of heat flux directed from node 1 to node 2, at a middle point I as shown in FIG. 3, and its coefficient d_{CI} is equal to the distance from point I to the circumcenter C. Namely, the first term of the right-hand side of Equation (4) is to evaluate the quantity of heat that passes a vertical segment IC, using second-order accurate heat flux at point I. Similarly, the second term is to evaluate the quantity of heat that passes a vertical segment CK, using second-order accurate heat flux at point K. It will be understood from the above discussion that the right-hand side of Equation (4) represents the quantity of heat flowing out through inspection lines denoted as IC and CK. In this case, a quadrangle 1 ICK is called a nodal domain of node 1, and is denoted as ND₁. If the element is in the form of a regular triangle, the circumcenter is located on the geometric center thereof, and therefore the nodal domain is one-third of the area of the element. If the element is in the form of a right triangle, the circumcenter is located at the middle point of one side thereof. If the element is in the form of an obtuse triangle, the circumcenter is located outside the element. The nodal domains of node 1 in the right-triangular element and obtuse-triangular element are shown in FIG. 4 and FIG. 5, respectively.

On the other hand, through the element integration of the source term of the right-hand side of Equation (3), the quantity of generated heat in the element is substantially uniformly distributed to three nodes, irrespective of the element shape. In particular, where Q is a constant in the element, the element integration of the source term is expressed by the following equation.

$$\int {\int }_{e} WQ d x d y = \frac{S}{3} Q \qquad ( 5 )$$

where S is the area of the element. Namely, no matter what shape the element has, the quantity of heat given to each node is only that of heat generated from one-third of the area of the element.

In the elements other than the regular triangular elements, an imbalance arises between the area of the nodal domain determined by the inspection lines and the area of the source term. Since this is also true with the other elements around node P, the conservation rule is not satisfied, and inconsistency appears between the source term and the other terms. As a result, new numerical errors are produced. FIG. 6 illustrates one example of temperature distribution obtained according to the finite element method. In a square domain of 0≦x≦1, 0≦y≦1, the result of analysis where λ=1, using a source distribution of Equation (6) and a boundary condition of Equation (7), is indicated by solid lines, and the element shape is represented by dotted lines. For example, exact solutions of the same value are obtained at the four points (marked with O, in FIG. 6), but differences appear in numerical solutions due to an influence of local mesh patterns.

Q=2π²sin(πx)sin (πy)

T=0(x=0, 1, or y=0, 1) (7)

(Known Method for Improvement in connection with Two-dimensional Triangle Problem) To solve the above-described inconsistency problem, the following two improvements or measures may be considered.

(Improvement Method 1): The element integral

∫∫ₑWQdxdy

of the right-hand side of Equation (3) is replaced by

∫∫_{ND}_{₁}Qdxdy

(Improvement Method 2): The improvement method 2 is obtained by further revising the above-indicated improvement method 1. In order to avoid integration outside the element in the case of the obtuse-triangular element, the integration of the source term is performed over a portion within the element as shown in FIG. 7. In accordance with this change, d_{CI} and d_{CK} in the right-hand side of Equation (4) are converted from the lengths from the middle points to the circumcenter, to the lengths as indicated in FIG. 7

In the above-described improvement method 1, the conservation rule is satisfied with second-order accuracy in all of the linear triangular elements, and the consistency between the respective terms can be maintained. In the case of obtuse-triangular elements, however, the range of integration of the source term extends to the outside of the element, which causes numerical vibrations. Also, in the above-described improvement method 2, the matrix of the left-hand side is forced to be changed, and therefore the superiority of the finite element method evaluated as the optimum discretization method for an elliptic operator is impaired. Consequently, satisfactory numerical solutions cannot be obtained by the improvement methods 1, 2, and the use of obtuse-triangular elements is avoided in practical applications, in other words, a substantial amount of time needs to be taken to create a mesh pattern that does not use any obtuse-triangular element.

(Three-dimensional Tetrahedron Problem using Known Finite Element Method) A three-dimensional Poisson equation is given by the following equation.

$$\frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) = - Q \qquad ( 8 )$$

If the finite element method is applied to this equation, the following equation is obtained as an integral equation with respect to an object node.

$$- \int \int {\int }_{Ω} W \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = \int \int {\int }_{Ω} WQ d x d y d z \qquad ( 9 )$$

Equation (9) may be expressed by the sum of the integrals of the elements around the node, as indicated by Equation (10).

$$- {\sum }_{e} \int \int {\int }_{e} W \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = {\sum }_{e} \int \int {\int }_{e} WQ d x d y d z \qquad ( 10 )$$

If Equation (10) is applied to a linear tetrahedral element of which three surfaces intersect at right angles at node 1, as shown in FIG. 8, the element integration of the left-hand side of Equation (10) provides the following equation, using integration by parts and the Gauss-Green theorem.

$$- \int \int {\int }_{e} W \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = \frac{{y}_{3} {z}_{4}}{6} \times λ \frac{{T}_{1} - {T}_{2}}{{x}_{2}} + \frac{{x}_{2} {x}_{4}}{6} \times λ \frac{{T}_{1} - {T}_{3}}{{y}_{3}} + \frac{{x}_{2} {y}_{3}}{6} \times λ \frac{{T}_{1} - {T}_{4}}{{z}_{4}} \qquad ( 11 )$$

where boundary integration is separately considered.

From the right-hand side of Equation (11), it is understood that the heat fluxes directed from node 1 to nodes 2, 3, 4, respectively,

$$λ \frac{{T}_{1} - {T}_{2}}{{x}_{2}} , λ \frac{{T}_{1} - {T}_{3}}{{y}_{3}} , λ \frac{{T}_{1} - {T}_{4}}{{z}_{4}}$$

pass through areas respectively expressed as:

$$\frac{{y}_{3} {z}_{4}}{6} , \frac{{x}_{2} {z}_{4}}{6} , \frac{{x}_{2} {y}_{3}}{6}$$

The areas through which the heat fluxes pass between other nodes are obtained by the same method, and are indicated in TABLE 1 below.

TABLE 1
Area of Passage of Heat Flux between Nodes

| | Node 1 | Node 2 | Node 3 | Node 4 |
|---|---|---|---|---|
| Node 1 | × | $\frac{{y}_{3} {z}_{4}}{6}$ | $\frac{{x}_{2} {z}_{4}}{6}$ | $\frac{{x}_{2} {y}_{3}}{6}$ |
| Node 2 | $\frac{{y}_{3} {z}_{4}}{6}$ | × | 0 | 0 |
| Node 3 | $\frac{{x}_{2} {z}_{4}}{6}$ | 0 | × | 0 |
| Node 4 | $\frac{{x}_{2} {y}_{3}}{6}$ | 0 | 0 | × |

On the other hand, if the element integration of the source term of the right-hand side of Equation (10) is performed, the quantity of generated heat within the element is substantially uniformly distributed to the four nodes, irrespective of the shape of the element. In particular, where Q is a constant in the element, the element integral of the source term is given by the following equation.

$$\int \int {\int }_{e} WQ d x d y d z = \frac{V}{4} Q \qquad ( 12 )$$

In Equation (12), V denotes the volume of the element. Namely, no matter what shape the element has, the quantity of heat given to each node is only that of heat generated from one-quarter of the volume V. If TABLE 1 and Equation (12) are examined in terms of the conservation rule, it is found that inconsistency appears between the areas of passage of heat flux which largely varies from one node to another, and the source term uniformly distributed to the nodes. As a result, new numeral errors are produced. FIGS. 9A and 9B show temperature distribution obtained by applying the finite element method to a source distribution of Equation (13) and a boundary condition of Equation (14), where λ=1, in a cubic domain of 0≦x≦1, 0≦y≦1, 0≦z≦1. For example exact solutions of the same value are obtained at four points marked with O in FIG. 9B, but numerical solutions differ among the points due to the influence of local mesh patterns.

Q=3π²sin(πx)sin (πy)sin (πz)

T=0(x=0, 1, or y=0, 1, or z=0, 1) (14)

(Known Improvement Method for Three-dimensional Tetrahedron Problem) As a method for improvement of the three-dimensional tetrahedron problem that suffers from the inconsistency as described above, it is proposed to define a hexahedron formed from eight points in total, i.e., the object node 1, the circumcenter C of the tetrahedron, circumcenters C₂, C₃, C₄ of triangles on the surface of the element, and middle points I, J, K of the sides of the element, as a nodal domain, as shown in FIG. 10, and correct matrix components into those obtained by dividing the areas of passage of the fluxes calculated from the nodal domain by the distances between the nodes. The matrix components are changed in this manner because the same interpretation as that for the two-dimensional finite element method cannot be applied to the discretization result of the three-dimensional finite element method. Namely, except for the case of a regular tetrahedral element, the integration of the left-hand side of Equation (11) does not result in the product of the heat flux at the middle point of the side and the area of a quadrilateral formed by the circumcenters and the middle point of the side. For example, in the case of the element of FIG. 8, the area of passage of the heat flux between node 1 and node 2 is

$$\frac{{y}_{3} {z}_{4}}{6}$$

whereas the area of the quadrilateral formed by the circumcenters C, C₃, C₄ and the middle point I is

$$\frac{{y}_{3} {z}_{4}}{4}$$

While the conservation rule is satisfied with second-order accuracy, the method for improvement of the three-dimensional problem cannot be applied to element shapes other than the element shape of Delaunay triangulation, namely, can only be applied to the element shape of Delaunay triangulation. Also, if the improvement method is applied to the tetrahedral element as shown in FIG. 8, for example, positive components that have an adverse influence on the numerical analysis appear at locations other than the diagonals because of changes of the matrix components, though components other than those on the diagonals are equal to zero according to the known finite element method.

(Two-dimensional Quadrangle Problem using Known Finite Element Method) While the above-described improvement methods have been proposed (see “MING-DER DONALD HUANG, The Constant-Flow Patch Test—A Unique Guideline for the Evaluation of Discretization Schemes for the Current Continuity Equations, IEEE Transactions on computer-aided design, V.CAD-4, No. 4, 1985, pp. 583-608”, and “Christian Cordes and Mario Putti, Accuracy of Galerkin finite element for groundwater flow simulations in two and three-dimensional triangulations, Int. J. Numer, Meth. Engng 2001, V52, P371-387”) with respect to the two-dimensional linear triangular mesh and three-dimensional linear tetrahedral mesh as described above, it seems that a two-dimensional linear quadrilateral mesh has not been discussed. When the Poisson equation is discretized according to the finite element method, all of the terms to which the same Galerkin weight function is applied are integrated; therefore, the source term may be substantially evenly or equally distributed to an algebraic equation of each of the nodes possessed by the same element, irrespective of the shape of the element, resulting in a situation where the consistency with discretization of other terms cannot be achieved, and the conservation rule is not satisfied at the node level. Details of this situation will be provided below.

As described above, the two-dimensional Poisson equation is indicated below.

$$- \frac{\partial }{\partial x} ( λ \frac{\partial T}{\partial x} ) - \frac{\partial }{\partial y} ( λ \frac{\partial T}{\partial y} ) = Q \qquad {( 1 )}^{′}$$

While this equation describes physical phenomena of numerous fields, the following explanation is concerned with a heat conduction problem by way of example. In Equation (1)′, T is the temperature, and λ is the thermal conductivity, while Q is the quantity of heat generated per unit time, unit area, which is called “source term”. If the finite element method is applied to Equation (1), Equation (3)′ that is substantially identical with Equation (3) indicated above is obtained as an integral equation with respect to an object node P.

$$- {\sum }_{e} \int {\int }_{e} {W}_{P} \{ \frac{\partial }{\partial x} ( λ \frac{\partial T}{\partial x} ) + \frac{\partial }{\partial y} ( λ \frac{\partial T}{\partial y} ) \} d x d y = {\sum }_{e} \int {\int }_{e} {W}_{P} Q d x d y \qquad {( 3 )}^{′}$$

In Equation (3)′, e represents elements around node P as shown in FIG. 11, and Σ represents the sum of results of computations over the respective elements. Also, W_{P} is a Galerkin weight function defined on an element domain around node P, which is a linear function that takes 1 at node P, and takes 0 at the boundaries of local domains of FIG. 11. If the left-hand side of Equation (3)′ is integrated, using integration by parts and the Gauss-Green theorem, and boundary integration is separately considered, the following equation is obtained.

$${\sum }_{e} \int {\int }_{e} λ ( \frac{\partial {W}_{P}}{\partial x} \frac{\partial T}{\partial x} + \frac{\partial {W}_{P}}{\partial y} \frac{\partial T}{\partial y} ) d x d y = {\sum }_{e} \int {\int }_{e} {W}_{P} Q d x d y \qquad ( 15 )$$

If the element e is fitted or converted into a bilinear rectangular element of FIG. 12, the element integration of the left-hand side of Equation (15) provides the following equation, where the local number of the object node P in the element is 1.

$$\int {\int }_{e} λ ( \frac{\partial {W}_{1}}{\partial x} \frac{\partial T}{\partial x} + \frac{\partial {W}_{1}}{\partial y} \frac{\partial T}{\partial y} ) d x d y = \frac{{h}_{y}}{2} \times λ [ \frac{2}{3} \frac{{T}_{1} - {T}_{2}}{{h}_{x}} + \frac{1}{3} \frac{{T}_{4} - {T}_{3}}{{h}_{x}} ] + \frac{{h}_{x}}{2} \times λ [ \frac{2}{3} \frac{{T}_{1} - {T}_{4}}{{h}_{y}} + \frac{1}{3} \frac{{T}_{2} - {T}_{3}}{{h}_{y}} ] \qquad ( 16 )$$

The physical meaning of the first term of the right-hand side of Equation (16) is the quantity of heat that passes a vertical segment IO, due to the weighed average of heat flux of second-order accuracy at middle point I, which flux is directed from node 1 toward node 2, and heat flux of second-order accuracy at middle point K, which flux is directed from node 4 toward node 3. Point O in FIG. 12 is located at the average values of the coordinates of the four nodes. Also, the physical meaning of the second term is the quantity of heat that passes a vertical segment OL, due to the weighed average of heat flux of second-order accuracy at middle point L, which flux is directed from node 1 toward node 4, and heat flux of second-order accuracy at middle point J, which flux is directed from node 2 toward node 3. Here, a domain surrounded by inspection line IOL and element sides LlI is called “control volume” of node 1, and denoted as CV₁. In view of the symmetry of the element shape, inspection lines where the other nodes are considered as object nodes are indicated by thin solid lines in FIG. 12, from which it will be understood that CV₁=CV₂=CV₃=CV₄=S/4.

In the above equation, S is the area of the element, and each subscript attached to CV represents the node to which the control volume belongs. In the case where Q is a constant in the element, the element integration of the right-hand side of Equation (15) provides the following equation.

$$\int {\int }_{e} {W}_{1} Q d x d y = \frac{S}{4} Q \qquad ( 17 )$$

Namely, the quantity of heat applied to node 1 is generated from S/4. It is understood from the definition of the weight function that the same quantity of heat is applied to each of the other nodes. Since the area of the control volume of each node coincides with the area of the source term, the conservation rule is satisfied with second-order accuracy. These results are indicated in TABLE 2.

TABLE 2
Result of Considerations under Conservation Rule

| | [symbol] | | | [symbol] | | | [symbol] | | |
|---|---|---|---|---|---|---|---|---|---|
| Node | CV | Source | ND | CV | Source | ND | CV | Source | ND |
| 1 | $\frac{S}{4}$ | $\frac{S}{4}$ | $\frac{S}{4}$ | $\frac{3 S}{8}$ | $\frac{S}{4}$ | $\frac{3 S}{8}$ | $\frac{S}{2}$ | $\frac{S}{3}$ | $\frac{S}{2}$ |
| 2 | $\frac{S}{4}$ | $\frac{S}{4}$ | $\frac{S}{4}$ | $\frac{S}{8}$ | $\frac{S}{4}$ | $\frac{S}{8}$ | $\frac{S}{4}$ | $\frac{S}{3}$ | $\frac{S}{4}$ |
| 3 | $\frac{S}{4}$ | $\frac{S}{4}$ | $\frac{S}{4}$ | $\frac{3 S}{8}$ | $\frac{S}{4}$ | $\frac{3 S}{8}$ | $\frac{S}{4}$ | $\frac{S}{3}$ | $\frac{S}{4}$ |
| 4 | $\frac{S}{4}$ | $\frac{S}{4}$ | $\frac{S}{4}$ | $\frac{S}{8}$ | $\frac{S}{4}$ | $\frac{S}{8}$ | | | |
| Total | S | S | S | S | S | S | S | S | S |

In the case of a bilinear parallelogram element as shown in FIG. 13, the element integration of the left-hand side of Equation (15) according to the finite element method provides the following equation.

$$\int {\int }_{e} λ ( \frac{\partial {W}_{1}}{\partial x} \frac{\partial T}{\partial x} + \frac{\partial {W}_{1}}{\partial y} \frac{\partial T}{\partial y} ) d x d y = \frac{h}{2} \times λ \frac{{T}_{1} - {T}_{2}}{h} + h \times λ \frac{{T}_{1} - {T}_{3}}{h} \qquad ( 18 )$$

The first term of the right-hand side of Equation (18) is the quantity of heat that passes a vertical segment IJ, due to the heat flux of second-order accuracy at a middle point I, which flux is directed from node 1 toward node 2. The second term is the quantity of heat that passes a vertical segment JL, due to the heat flux of second-order accuracy at point O which flux is directed from node 1 toward node 3. Consequently, the inspection line is IJL, and CV₁ is equal to 3S/8. Similarly, if the same analysis is made with respect to node 2 as an object node, the element integration of the left-hand side of Equation (15) provides the following equation.

$$\int {\int }_{e} λ ( \frac{\partial {W}_{2}}{\partial x} \frac{\partial T}{\partial x} + \frac{\partial {W}_{2}}{\partial y} \frac{\partial T}{\partial y} ) d x d y = \frac{h}{2} \times λ \frac{{T}_{2} - {T}_{1}}{h} \qquad ( 19 )$$

In this case, the inspection line is IJ, and CV₂ is equal to S/8. In view of the symmetry of the element shape, inspection lines as indicated by thin solid lines in FIG. 13 are obtained for the remaining two nodes.

On the other hand, if Q is a constant in the element, the element integration of the source term results in the quantity of heat generated from S/4. These results are indicated in the above TABLE 2. Since the area from which the quantity of heat applied to the node in question is generated does not coincide with the area of the control volume, the conservation rule is not satisfied.

In the case of a quadrilateral element in which node 3 gets infinitely close to node 4 as shown in FIG. 14, the element integration of the left-hand side of Equation (15) according to the finite element method provides the following equation, where T₃ may be regarded as being equal to T₄(T₃=T₄).

$$\int {\int }_{e} λ ( \frac{\partial {W}_{1}}{\partial x} \frac{\partial T}{\partial x} + \frac{\partial {W}_{1}}{\partial y} \frac{\partial T}{\partial y} ) d x d y = \frac{{h}_{y}}{2} \times λ \frac{{T}_{1} - {T}_{2}}{{h}_{x}} + \frac{{h}_{x}}{2} \times λ \frac{{T}_{1} - {T}_{4}}{{h}_{y}} \qquad ( 20 )$$

The first term of the right-hand side of Equation (20) is the quantity of heat that passes a vertical segment IJ, due to the heat flux of second-order accuracy at middle point I, which flux is directed from node 1 toward node 2. The second term is the quantity of heat that passes a vertical segment JL, due to the heat flux of second-order accuracy at point L, which flux is directed from node 1 toward node 4. Consequently, the inspection line is IJL, and CV₁ is equal to S/2. Similarly, if the same analysis is made with respect to node 2 as an object node, the element integration of the left-hand side of Equation (15) provides the following equation.

$$\int {\int }_{e} λ ( \frac{\partial {W}_{2}}{\partial x} \frac{\partial T}{\partial x} + \frac{\partial {W}_{2}}{\partial y} \frac{\partial T}{\partial y} ) d x d y = \frac{{h}_{y}}{2} \times λ \frac{{T}_{2} - {T}_{1}}{{h}_{x}} \qquad ( 21 )$$

The inspection line is IJ, and CV₂ is equal to S/4. Also, the results of integration with respect to node 3 and node 4 as an object node, in view of T₃=T₄, are indicated by Equation (22) and Equation (23) below.

$$\begin{matrix}\int {\int }_{e} λ ( \frac{\partial {W}_{3}}{\partial x} \frac{\partial T}{\partial x} + \frac{\partial {W}_{3}}{\partial y} \frac{\partial T}{\partial y} ) d x d y = \frac{{h}_{y}}{2} \times λ \frac{{T}_{2} - {T}_{1}}{{h}_{x}} + \frac{{h}_{x}}{2} \times λ \frac{{T}_{4} - {T}_{1}}{{h}_{y}} & ( 22 ) \\ \int {\int }_{e} λ ( \frac{\partial {W}_{4}}{\partial x} \frac{\partial T}{\partial x} + \frac{\partial {W}_{4}}{\partial y} \frac{\partial T}{\partial y} ) d x d y = - \frac{{h}_{y}}{2} \times λ \frac{{T}_{2} - {T}_{1}}{{h}_{x}} & ( 23 )\end{matrix}$$

Since both of node 3 and node 4 lie on the same point, and T₃ is equal to T₄, the algebraic equations may be added together when the inspection line is determined. It is understood from the sum of the right-hand sides of Equation (22) and Equation (23) that the inspection line is JL, and CV₃+CV₄=S/4. The inspection lines are indicated by thin solid lines in FIG. 14.

On the other hand, if Q is a constant in the element, the area of the source amount distributed to each of node 1 and node 2 is equal to S/3. The sum of the areas of the source amounts distributed to node 3 and node 4 is equal to S/3. These results are indicated in TABLE 2 above, from which it is understood that the conservation rule is not satisfied.

While it is presumed that quadrilateral elements having other general shapes also suffer from the problem that the conservation rule is not satisfied with second-order accuracy, it is difficult in theory to check the control volume.

(Three-dimensional Hexahedron and Three-dimensional Pentahedron Problems using Known Finite Element Method) While the above-described improvement methods have been proposed (see “MING-DER DONALD HUANG, The Constant-Flow Patch Test—A Unique Guideline for the Evaluation of Discretization Schemes for the Current Continuity Equations, IEEE Transactions on computer-aided design, V.CAD-4, No. 4, 1985, pp. 583-608”, and “Christian Cordes and Mario Putti, Accuracy of Galerkin finite element for groundwater flow simulations in two and three-dimensional triangulations, Int. J. Numer, Meth. Engng 2001, V52, P371-387”) with respect to the two-dimensional linear triangular mesh and three-dimensional linear tetrahedral mesh as described above, it seems that three-dimensional hexahedral elements and pentahedral elements that are often used in three-dimensional analyses have not been discussed. In the present invention, these elements are objects to be studied.

As described above, the three-dimensional Poisson equation is expressed by the above-indicated Equation (8).

$$\frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) = - Q \qquad ( 8 )$$

While this equation describes physical phenomena of numerous fields, the following explanation is concerned with a heat conduction problem. Thus, in Equation (8), T is the temperature, and λ is the thermal conductivity, while Q is the quantity of heat generated per unit time, unit area, which is called “source term”. If the finite element method is applied to Equation (8), the following equation is obtained as an integral equation with respect to an object node P concerned.

$$- {\sum }_{e} \int \int {\int }_{e} {W}_{P} \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = {\sum }_{e} \int \int {\int }_{e} {W}_{P} Q d x d y d z \qquad {( 10 )}^{′}$$

In Equation (10)′, e represents elements around node P as shown in FIG. 15, and Σ represents the sum of results of computations over the respective elements. Also, W_{P} is a Galerkin weight function defined on an element domain around node P, which function is a linear function that takes 1 at node P, and takes 0 at the boundary of a domain comprised of surrounding elements. If the left-hand side of Equation (10)′ is integrated, utilizing integration by parts and the Gauss-Green theorem, and boundary integration is separately considered, the following equation is obtained.

$${\sum }_{e} \int \int {\int }_{e}^{ } λ ( \frac{\partial {W}_{P}}{\partial x} \frac{\partial T}{\partial x} + \frac{\partial {W}_{P}}{\partial y} \frac{\partial T}{\partial y} + \frac{\partial {W}_{P}}{\partial z} \frac{\partial T}{\partial z} ) d x d y d z = {\sum }_{e} \int \int {\int }_{e} {W}_{P} Q d x d y d z \qquad ( 24 )$$

(In the case of Hexahedral Element) When the element e is fitted into a linear rectangular parallelepiped element of FIG. 16A, the element integration of the left-hand side of Equation (24) results in the following equation, where the local number of object node P in the element is 1.

$$\int \int {\int }_{e}^{ } λ ( \frac{\partial {W}_{P}}{\partial x} \frac{\partial T}{\partial x} + \frac{\partial {W}_{P}}{\partial y} \frac{\partial T}{\partial y} + \frac{\partial {W}_{P}}{\partial z} \frac{\partial T}{\partial z} ) d x d y d z = {h}_{y} {h}_{z} [ \frac{4}{9} \times λ \frac{{T}_{1} - {T}_{2}}{2 {h}_{x}} + \frac{2}{9} \times λ \frac{{T}_{4} - {T}_{3}}{2 {h}_{x}} + \frac{2}{9} \times λ \frac{{T}_{5} - {T}_{6}}{2 {h}_{x}} + \frac{1}{9} \times λ \frac{{T}_{8} - {T}_{7}}{2 {h}_{x}} ] + {h}_{x} {h}_{z} [ \frac{4}{9} \times λ \frac{{T}_{1} - {T}_{4}}{2 {h}_{y}} + \frac{2}{9} \times λ \frac{{T}_{2} - {T}_{3}}{2 {h}_{y}} + \frac{2}{9} \times λ \frac{{T}_{5} - {T}_{8}}{2 {h}_{y}} + \frac{1}{9} \times λ \frac{{T}_{6} - {T}_{7}}{2 {h}_{y}} ] + {h}_{x} {h}_{y} [ \frac{4}{9} \times λ \frac{{T}_{1} - {T}_{5}}{2 {h}_{z}} + \frac{2}{9} \times λ \frac{{T}_{2} - {T}_{6}}{2 {h}_{z}} + \frac{2}{9} \times λ \frac{{T}_{4} - {T}_{8}}{2 {h}_{z}} + \frac{1}{9} \times λ \frac{{T}_{3} - {T}_{7}}{2 {h}_{z}} ] \qquad ( 25 )$$

As shown in FIG. 16B, point Iij represents a middle point of a segment connecting nodes i and j. The physical meaning of the first term of the right-hand side of Equation (25) is the quantity of heat that passes through a cross-sectional area h_{y}h_{z} that is orthogonal to the heat flux and passes middle point I₁₂, due to the weighted average of the heat flux λ(T₁−T₂)/2hₓ of second-order accuracy at middle point I₁₂, which is directed from node 1 toward node 2, the heat flux λ(T₄−T₃)/2hₓ of second-order accuracy at middle point I₄₃, which is directed from node 4 toward node 3, the heat flux λ(T₅−T₆)/2hₓ of second-order accuracy at middle point I₅₆, which is directed from node 5 toward node 6, and the heat flux λ(T₈−T₇)/2hₓ of second-order accuracy at middle point I₈₇, which is directed from node 8 toward node 7. Also, the physical meaning of the second term of Equation (25) is the quantity of heat that passes through a cross-sectional area hₓh_{z} that is orthogonal to the heat flux and passes middle point I₁₄, due to the weighted average of the heat flux of second-order accuracy at middle point I₁₄, which is directed from node 1 toward node 4, the heat flux of second-order accuracy at middle point I₂₃, which is directed from node 2 toward node 3, the heat flux of second-order accuracy at middle point I₅₈, which is directed from node 5 toward node 8, and the heat flux of second-order accuracy at middle point I₆₇, which is directed from node 6 toward node 7. Also, the physical meaning of the third term of Equation (25) is the quantity of heat that passes through a cross-sectional area hₓh_{y} that is orthogonal to the heat flux and passes middle point I₁₅, due to the weighted average of the heat flux of second-order accuracy at middle point I₁₅, which is directed from node 1 toward node 5, the heat flux of second-order accuracy at middle point I₂₆, which is directed from node 2 toward node 6, the heat flux of second-order accuracy at middle point I₄₈, which is directed from node 4 toward node 8, and the heat flux of second-order accuracy at middle point I₃₇, which is directed from node 3 toward node 7. Here, the cross-sectional areas h_{y}h_{z}, hₓh_{z} and hₓh_{y} are considered as inspection planes, and a domain surrounded by these inspection planes is called “control volume” of node 1, and denoted as CV₁. The control volume is defined by the heat flux of second-order accuracy. It will be understood from the above discussion that CV₁ is a rectangular parallelepiped having the side lengths of hₓ, h_{y}, h_{z} as indicated in FIG. 16B, and its volume is expressed by the following equation.

$${CV}_{1} = {h}_{x} {h}_{y} {h}_{z} = \frac{V}{8} \qquad ( 26 )$$

In Equation (26), V is the volume of the element. In view of the symmetry of the element shape, the result that CVᵢ=V/8 (i=1, 2, . . . , 8) is obtained. The subscript attached to CV represents the node to which the control volume belongs. On the other hand, if Q is a constant in the element, the element integration of the right-hand side of Equation (24) provides the following equation.

$$\int \int {\int }_{e} {W}_{P} Q d x d y d z = \frac{V}{8} {Q}^{( e )} \qquad ( 27 )$$

In Equation (27), Q^{(e)} is the source term in the element. It is understood from Equation (27) that the quantity of heat distributed to node 1 is generated from V/8. It is understood from the definition of the Galerkin weight function that the quantity of heat distributed to each of the other nodes is also equal to VQ^{(e)/}8. Since the volume of the control volume of each node coincides with the volume of the source term, the conservation rule is satisfied with second-order accuracy.

In the case of a hexahedral element formed by pushing out a parallelogram on the yz plane in the x direction by a distance of 2hₓ as shown in FIG. 17A, the element integration of the left-hand side of Equation (24) according to the finite element method provides the following equation.

$$\int \int {\int }_{e} λ ( \frac{\partial {W}_{P}}{\partial x} \frac{\partial T}{\partial x} + \frac{\partial {W}_{P}}{\partial y} \frac{\partial T}{\partial y} + \frac{\partial {W}_{P}}{\partial z} \frac{\partial T}{\partial z} ) d x d y d z = hh [ \frac{4}{9} \times λ \frac{{T}_{1} - {T}_{2}}{2 {h}_{x}} + \frac{2}{9} \times λ \frac{{T}_{4} - {T}_{3}}{2 {h}_{x}} + \frac{2}{9} \times λ \frac{{T}_{5} - {T}_{6}}{2 {h}_{x}} + \frac{1}{9} \times λ \frac{{T}_{8} - {T}_{7}}{2 {h}_{x}} ] + {h}_{x} h [ \frac{2}{3} \times λ \frac{{T}_{1} - {T}_{4}}{2 h} + \frac{1}{3} \times λ \frac{{T}_{2} - {T}_{3}}{2 h} ] + 2 {h}_{x} h [ \frac{2}{3} \times λ \frac{{T}_{1} - {T}_{8}}{2 h} + \frac{1}{3} \times λ \frac{{T}_{2} - {T}_{7}}{2 h} ]$$

The physical meanings of the respective terms of the right-hand side of Equation (28) are the quantity of heat that passes through an area having the size of h² and passing middle point I₁₂, the quantity of heat that passes through an area having the size of hₓh and passing middle point I₁₄, and the quantity of heat that passes through an area having the size of 2hhₓ and passing middle point I₁₈. The control volume cannot be precisely obtained since the space defined by the inspection planes is not closed, but is considered to be larger than V/8, as compared with FIG. 16B. On the other hand, if Q is a constant in the element, the result of element integration of the source term for each node is still the quantity of heat generated from V/8. Namely, the volume from which the quantity of heat distributed to the node in question does not coincide with the volume of the control volume, and it is presumed that the conservation rule is not satisfied.

The problem that the conservation rule is not satisfied with second-order accuracy also exists in hexahedral elements of other general shapes. However, it is difficult in theory to check the control volume.

(In the case of Pentahedral Element) When the element e is fitted into a linear regular-triangular prism of FIG. 18A, the element integration of the left-hand side of Equation (24) provides Equation (29), where the local number of the object node P in the element is 1.

$$\int \int {\int }_{e} λ ( \frac{\partial {W}_{P}}{\partial x} \frac{\partial T}{\partial x} + \frac{\partial {W}_{P}}{\partial y} \frac{\partial T}{\partial y} + \frac{\partial {W}_{P}}{\partial z} \frac{\partial T}{\partial z} ) d x d y d z = \frac{{hh}_{z}}{2 \sqrt{3}} [ \frac{2}{3} \times λ \frac{{T}_{1} - {T}_{2}}{h} + \frac{1}{3} \times λ \frac{{T}_{4} - {T}_{5}}{h} ] + \frac{{hh}_{z}}{2 \sqrt{3}} [ \frac{2}{3} \times λ \frac{{T}_{1} - {T}_{3}}{h} + \frac{1}{3} \times λ \frac{{T}_{4} - {T}_{6}}{h} ] + \frac{{h}^{2}}{4 \sqrt{3}} [ \frac{2}{4} \times λ \frac{{T}_{1} - {T}_{4}}{2 {h}_{z}} + \frac{1}{4} \times λ \frac{{T}_{2} - {T}_{5}}{2 {h}_{z}} + \frac{1}{4} \times λ \frac{{T}_{3} - {T}_{6}}{2 {h}_{z}} ] \qquad ( 29 )$$

Similarly, if the physical meaning of the right-hand side of Equation (29) is studied, the inspection planes as indicated in FIG. 18B are obtained; therefore, the control volume of node 1 is given by the following equation.

$${CV}_{1} = \frac{{h}^{2} {h}_{z}}{4 \sqrt{3}} = \frac{V}{6} \qquad ( 30 )$$

In view of the symmetry of the element shape, the result of CVᵢ (i=1, 2, . . . , 6) is obtained. On the other hand, if Q is a constant in the element, the element integration of the right-hand side of Equation (24) provides the following equation.

$$\int \int {\int }_{e} {W}_{P} Q d x d y d z = \frac{V}{6} {Q}^{( e )} \qquad ( 31 )$$

Namely, the quantity of heat distributed to node 1 is generated from V/6. It is understood from the definition of the Galerkin weight function that the quantity of heat distributed to each of the other nodes is the same as that distributed to node 1. Since the volume of the control volume of each node coincides with the volume of the source term, the conservation rule is satisfied with second-order accuracy.

In the case of a right-triangular prism as shown in FIG. 19A, the element integration of the left-hand side of Equation (24) according to the finite element method provides the following equation.

$$\int \int {\int }_{e} λ ( \frac{\partial {W}_{P}}{\partial x} \frac{\partial T}{\partial x} + \frac{\partial {W}_{P}}{\partial y} \frac{\partial T}{\partial y} + \frac{\partial {W}_{P}}{\partial z} \frac{\partial T}{\partial z} ) d x d y d z = \frac{{h}_{y} {h}_{z}}{2} [ \frac{2}{3} \times λ \frac{{T}_{1} - {T}_{2}}{{h}_{x}} + \frac{1}{3} \times λ \frac{{T}_{4} - {T}_{5}}{{h}_{x}} ] + \frac{{h}_{x} {h}_{z}}{2} [ \frac{2}{3} \times λ \frac{{T}_{1} - {T}_{3}}{{h}_{y}} + \frac{1}{3} \times λ \frac{{T}_{4} - {T}_{6}}{{h}_{y}} ] + \frac{{h}_{x} {h}_{y}}{6} [ \frac{2}{4} \times λ \frac{{T}_{1} - {T}_{4}}{2 {h}_{z}} + \frac{1}{4} \times λ \frac{{T}_{2} - {T}_{5}}{2 {h}_{z}} + \frac{1}{4} \times λ \frac{{T}_{3} - {T}_{6}}{2 {h}_{z}} ] \qquad ( 32 )$$

The physical meanings of the respective terms of the right-hand side of Equation (32) are the quantity of heat that passes through an area having the size of h_{y}h_{z/}2 and passing middle point I₁₂, the quantity of heat that passes through an area having the size of hₓh_{z/}2 and passing middle point I₁₃, and the quantity of heat that passes through an area having the size of hₓh_{y/}6 and passing middle point I₁₄. The control volume is not precisely obtained since the space defined by the inspection planes is not closed, but is considered as being larger than V/6, as compared with FIG. 18B. On the other hand, if Q is a constant in the element, the result of the element integration of the source term of each node is still the quantity of heat generated from V/6. Thus, it may be considered that the volume from which the quantity of heat distributed to the node in question is generated does not coincide with the volume of the control volume, and that the conservation rule is not satisfied.

### SUMMARY OF THE INVENTION

In view of the problems as described above, (a) through (e) as follows are objects to be attained by the invention.

(a) In the above-described known improvement method 1 for two-dimensional triangle problems, a problem that, in the case of an obtuse-triangular element, an integral domain of the source term extends to the outside of the element is to be solved. At the same time, the manner of handling a boundary condition and the source term distributed on a line is to be proposed.

(b) The problem of inconsistency with the source term in a three-dimensional tetrahedron problem by the known finite element method is to be solved, and a drawback in the known improvement method for three-dimensional tetrahedron problems is to be avoided. At the same time, the manners of handling a boundary condition, the source term distributed on a line, and the source term distributed over a plane are to be proposed.

(c) The known problem of inconsistency with the source term in a two-dimensional quadrangle problem is to be solved.

(d) The known problem of inconsistency with the source term in a three-dimensional hexahedron/pentahedorn problem is to be solved.

(e) Since there is a problem that errors occur depending on the element shape in handling of the load, body force, and mass according to the finite element method, the method of improving the accuracy is to be proposed.

Thus, the object of the invention is to provide an analysis method using the finite element method, and an analytical computation program using the finite element method, according to which high-accuracy numerical solutions are obtained from lower-quality elements (lower-quality mesh patterns) than those of regular triangles, regular tetrahedrons, rectangles, and rectangular parallelepipeds, for example, by proposing a high-accuracy scheme in discretization of the finite element method using linear triangular elements, linear tetrahedral elements, linear quadrangular elements, linear hexahedral elements, and linear pentahedral elements, and reducing analysis errors due to the mesh pattern.

An analysis method using a finite element method according to a first aspect of the invention includes the steps of:

selecting an analysis domain to be analyzed,

dividing the analysis domain into a plurality of elements as calculation objects,

applying a Galerkin weight function (W) with respect to a given node (e.g., P whose node number in element e is 1, for example) in a given element (e.g., e) as one of the plurality of elements, and performing element integration so as to create a matrix of each of the elements,

integrating a general function term as a product of the Galerkin weight function (W) and a general function (e.g., Q, f),

creating simultaneous equations, based on a sum of matrices of respective elements in a domain (e.g., Ω) around the given node (e.g., P), and a sum of values obtained by integrating the general function term,

introducing a boundary condition into the simultaneous equations, and

obtaining a numerical solution by solving the simultaneous equations. In the general function term integrating step, a concept of a nodal domain defined based on a result of discretization of a second-order differential term according to a Galerkin finite element method is introduced, and the general function term using a typical value (e.g., Q_{G}, Q_{O}, f_{G}, f_{O}) of the element is integrated.

In the analysis method according to the first aspect of the invention, in the general function term integrating step, the general function may be distributed to the node in accordance with the size of the nodal domain.

In the analysis method according to the first aspect of the invention, the general function term integrating step may be a source term integrating step of integrating a source term as the general function term, and, in the source term integrating step, the source term using a typical source value of the element (e.g., a value at the geometric center, a value at the node average position, and an element average value) may be integrated.

In the analysis method according to the first aspect of the invention, the general function term integrating step may be a force term integrating step of integrating a force term as the general function term representing load, body force, and mass, and, in the force term integrating step, the force term using a typical force value of the element (e.g., a value at the geometric center, a value at the node average position, and an element average value) may be integrated.

More specifically, the above-indicated plurality of elements may be two-dimensional triangular elements, and, in the source term integrating step, (ND−S/3)Q_{G} may be added as an additional term to the source term, where ND is an area of a nodal domain in each of the elements, Q_{G} is a typical source value of the element, and S is an area of the element.

More specifically, the above-indicated plurality of elements may be two-dimensional triangular elements, and, in the force term integrating step, (ND−S/3)f_{G} may be added as an additional term to the force term, where ND is an area of a nodal domain in each of the elements, f_{G} is a typical force value of the element, and S is an area of the element.

More specifically, the above-indicated plurality of elements may be three-dimensional tetrahedral elements, and, in the source term integrating step, (ND−V/4)Q_{G} may be added as an additional term to the source term, where ND is a volume of a nodal domain in each of the elements, Q_{G} is a typical source value of the element, and V is a volume of the element, and the ND of node 1 may be given by

$$ND = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} )$$

More specifically, the above-indicated plurality of elements may be three-dimensional tetrahedral elements, and, in the force term integrating step, (ND−V/4)f_{G} may be added as an additional term to the force term, where ND is a volume of a nodal domain in each of the elements, f_{G} is a typical force value of the element, and V is a volume of the element, and the ND of node 1 may be given by

$$ND = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} )$$

More specifically, the above-indicated plurality of elements may be two-dimensional quadrangular elements, and, in the source term integrating step,

(ND_{P}−∫∫ₑW_{P}dxdy)Qₒ

may be added as an additional term to the source term, where ND_{P} is a nodal domain in each of the elements, W_{P} is the Galerkin weight function, and Q_{O} is a typical source value of the element.

More specifically, the above-indicated plurality of elements may be two-dimensional quadrangular elements, and, in the force term integrating step,

(ND_{P}−∫∫ₑW_{P}dxdy)fₒ

may be added as an additional term to the force term, where ND_{P} is a nodal domain in each of the elements, W_{P} is the Galerkin weight function, and f_{O} is a typical force value of the element.

More specifically, the above-indicated plurality of elements may be three-dimensional hexahedral or pentahedral elements, and, in the source term integrating step,

(ND_{P}−∫∫∫ₑW_{P}dxdydz)Qₒ

may be added as an additional term to the source term, where ND_{P} is a nodal domain in each of the elements, W_{P} is the Galerkin weight function, and Q_{O} is a typical source value of the element.

More specifically, the above-indicated plurality of elements may be three-dimensional hexahedral or pentahedral elements, and, in the force term integrating step,

(ND_{P}−∫∫∫ₑW_{P}dxdydz)ƒ_{O}

may be added as an additional term to the force term, where ND_{P} is a nodal domain in each of the elements, W_{P} is the Galerkin weight function, and f_{O} is a typical force value of the element.

In the above-mentioned boundary condition introducing step, when a heat flux that passes a natural boundary of each of the elements is not equal to zero, a boundary heat flux may be allocated to the node in accordance with a range of the nodal domain.

In the above-mentioned boundary condition introducing step, when the load, body force, or mass at a boundary of each of the elements is not equal to zero, the load, body force, or mass is allocated to the node in accordance with a range of the nodal domain.

A second aspect of the invention is concerned with an analytical computation program using a finite element method, for causing a computer to perform analytical computations using the finite element method. The analytical computation program causes the computer to execute the steps of:

selecting an analysis domain to be analyzed,

dividing the analysis domain into a plurality of elements as calculation objects,

applying a Galerkin weight function (W) with respect to a given node (e.g., P whose node number in element e is 1, for example) in a given element (e.g., e) as one of the plurality of elements, and performing element integration so as to create a matrix of each of the elements,

integrating a general function term as a product of the Galerkin weight function (W) and a general function (e.g., Q, f), wherein a concept of a nodal domain defined based on a result of discretization of a second-order differential term according to a Galerkin finite element method is introduced, and the general function term using a typical value of the element is integrated,

creating simultaneous equations, based on a sum of matrices of respective elements in a domain (e.g., Ω) around the given node (e.g., P), and a sum of values obtained by integrating the general function term,

introducing a boundary condition into the simultaneous equations, and

obtaining a numerical solution by solving the simultaneous equations.

According to the present invention, in the general function term integrating step of integrating a general function term as the product of a given weight function and a general function, the concept of the nodal domain defined based on the result of discretization of a second-order differential term according to the Galerkin finite element method is introduced, and the general function term using an element typical value (e.g., a value at the geometric center, a value at the node coordinate average position, and an element average value) is integrated, so that a value commensurate with the size of the nodal domain can be incorporated. As a result, analysis errors due to the mesh pattern can be reduced, and highly accurate numerical solutions can be obtained from low-quality elements (low-quality mesh patterns). Therefore, an operation to enhance the quality of the mesh pattern (an operation to make the mesh pattern closer to that of regular triangles, regular tetrahedrons, or squares) is not required, and substantially no increase in the calculation amount arises from correction of the algorithm (program); therefore, an otherwise possible increase in computations performed by the computer can be prevented, and the overall analysis time can be reduced.

### BRIEF DESCRIPTION OF THE DRAWINGS

FIG. 1 is a view showing an integral domain Ω of node P in a pattern of two-dimensional triangles;

FIG. 2 is a view showing a linear triangular element;

FIG. 3 is a view showing a nodal domain in a general triangular element;

FIG. 4 is a view showing a nodal domain in a right-triangular element;

FIG. 5 is a view showing a nodal domain in an obtuse-triangular element;

FIG. 6 is a view showing isopleths of temperature distribution;

FIG. 7 is a view useful for explaining correction of a nodal domain according to a known improvement method 2;

FIG. 8 is a view showing a linear right-angled tetrahedral element;

FIG. 9A and FIG. 9B are views showing a result of analysis on tetrahedral elements, wherein FIG. 9A is a view showing a mesh, and FIG. 9B is a view showing temperature distribution on a certain section of the mesh of FIG. 9A;

FIG. 10 is a view showing a nodal domain in a tetrahedral element according to a known improvement method;

FIG. 11 is a view showing an integral domain of node P in a pattern of two-dimensional quadrangles;

FIG. 12 is a view showing a result of integration in a rectangular element;

FIG. 13 is a view showing a result of integration in a parallelogram element;

FIG. 14 is a view showing a result of integration in a quadrilateral element in which two nodes overlap each other;

FIG. 15 is a view showing an integral domain of node P in a three-dimensional mesh;

FIG. 16A is a view showing the element shape of a rectangular parallelepiped element;

FIG. 16B is a view showing a result of integration in the rectangular parallelepiped element;

FIG. 17A is a view showing the element shape of a hexahedral element formed by pushing out a parallelogram;

FIG. 17B is a view showing a result of integration in the hexahedral element formed by pushing out a parallelogram;

FIG. 18A is a view showing the element shape of a regular-triangular prism element;

FIG. 18B is a view showing a result of integration in the regular-triangular prism element;

FIG. 19A is a view showing the element shape of a right-triangular prism element;

FIG. 19B is a view showing a result of integration in the right-triangular prism element;

FIG. 20 is a view showing nodal domains in an acute-triangular element;

FIG. 21 is a view showing nodal domains in a right-triangular element;

FIG. 22A and FIG. 22B are views showing nodal domains in an obtuse-triangular element, wherein FIG. 22A shows nodal domains whose areas are positive, and FIG. 22B shows nodal domains whose areas are negative;

FIG. 23A and FIG. 23B are views useful for explaining a natural boundary condition and processing of the source term distributed on a line, wherein FIG. 23A shows the case where the angle at node 3 is equal to or smaller than π/2, and FIG. 23B shows the case where the angle at node 3 is larger than π/2;

FIG. 24 is a view useful for explaining on-line distribution in a tetrahedron;

FIG. 25 is a view useful for explaining a problem of displacement caused by the self-weight;

FIG. 26 is a view showing a finite element model of a plate;

FIG. 27A-FIG. 27C are views each showing a pattern of a two-dimensional analysis mesh, wherein FIG. 27A shows a right-triangular mesh, FIG. 27B shows an obtuse-triangular mesh, and FIG. 27C shows an elongate-triangular mesh;

FIG. 28A-FIG. 28C are views each showing errors in two-dimensional heat conduction analyses, with respect to a known finite element method (GFE), improvement method 1 (NDFE), and the method of the invention (CNDFE), wherein FIG. 28A shows errors in the case of right-triangular meshes, FIG. 28B shows errors in the case of obtuse-triangular meshes, and FIG. 28C shows errors in the case of elongate triangular meshes;

FIG. 29 is a view showing a triangular mesh concerned with the load, body force, or mass, and constraint conditions;

FIG. 30 is a view showing an analysis result of radial displacements due to the interior pressure when the known finite element method is applied to the triangular mesh;

FIG. 31 is a view showing an analysis result of radial displacements due to rotation when the known finite element method is applied to the triangular mesh;

FIG. 32 is a view showing an analysis result of radial displacements due to the interior pressure when the invention is applied to the triangular mesh;

FIG. 33A-FIG. 33C are views showing three-dimensional analysis mesh patterns, wherein FIG. 33A shows a mesh formed by dividing a cube into six tetrahedrons, FIG. 33B shows a mesh formed by dividing a rectangular parallelepiped into fourteen tetrahedrons, and FIG. 33C shows a mesh formed by further dividing every tetrahedron of FIG. 33B into four tetrahedrons;

FIG. 34A-FIG. 34C are views showing errors in three-dimensional heat conduction analyses with respect to a known finite element method (GFE) and the method of the invention (CNDFE), wherein FIG. 34A shows errors in the case of the mesh formed by dividing a cube into six tetrahedrons, FIG. 34B shows errors in the case of the mesh formed by dividing a rectangular parallelepiped into fourteen tetrahedrons, and FIG. 34C shows errors in the case of the mesh formed by further dividing every tetrahedron of FIG. 34B into four tetrahedrons;

FIG. 35 is a view showing division of a square column into tetrahedral elements;

FIG. 36 is a view showing an analysis result of displacement due to the self-weight when the known finite element method is applied to the tetrahedral mesh;

FIG. 37 is a view showing an analysis result of displacement due to the self-weight when the invention is applied to the tetrahedral mesh;

FIG. 38 is a view useful for explaining the manner of defining nodal domains of terms including T₁;

FIG. 39A and FIG. 39B are views useful for explaining the manner of defining a nodal domain of a term that does not include T₁, wherein FIG. 39A shows a positive area, and FIG. 39B shows a negative area;

FIG. 40 is a view useful for explaining node positions of a quadrilateral element;

FIG. 41A-FIG. 41J are views showing various types of quadrilateral meshes, wherein FIG. 41A shows a square mesh, FIG. 41B shows a mesh composed of 3, 4, 5, 8 elements, FIG. 41C shows a rhombic mesh, FIG. 41D shows a parallelogram mesh, FIG. 41E shows a trapezoidal mesh, FIG. 41F shows a right-angled trapezoidal mesh, FIG. 41G is a right-triangle type trapezoidal mesh, FIG. 41H shows a straight-angle quadrilateral mesh, FIG. 411 shows a low straight-angle quadrilateral mesh, and FIG. 41J shows a high straight-angle quadrilateral mesh;

FIG. 42 is a view showing analysis errors for comparison under a Dirichlet boundary condition;

FIG. 43 is a view showing analysis errors for comparison under Dirichlet and Neumann boundary conditions;

FIG. 44 is a view showing the relationship between the number of nodes and analysis errors under the Dirichlet boundary condition;

FIG. 45 is a view showing the relationship between the number of nodes and analysis errors under the Dirichlet and Neumann boundary conditions;

FIG. 46 is a view showing a quadrangular mesh concerned with the load, body force or mass, and constraint conditions;

FIG. 47 is a view showing a result of analysis of radial displacements under an internal pressure when the known finite element method is applied to the quadrangular mesh;

FIG. 48 is a view showing a result of analysis of radial displacements under an internal pressure when the invention is applied to the triangular mesh;

FIG. 49 is a view showing a nodal domain concerned with the temperature at node 1 and node i;

FIG. 50 is a view useful for explaining a method of calculating coefficient Dⱼₖ;

FIG. 51 is a view showing a nodal domain concerned with the temperature at points other than node 1;

FIGS. 52A-52H are views showing hexahedral meshes, wherein FIG. 52A shows a rectangular parallelepiped mesh, FIG. 52B shows a mesh composed of 6, 8, 10, 16 elements, FIG. 52C shows a mesh of rhombic columns, FIG. 52D shows a mesh of parallelogram columns, FIG. 52E shows a mesh of trapezoidal columns, FIG. 52F shows a mesh of right-triangle type trapezoids, FIG. 52G shows a mesh of straight-angle columns, and FIG. 52H shows a mesh of low straight-angle columns;

FIG. 53A and FIG. 53B are views showing analysis errors in hexahedral elements, wherein FIG. 53A shows analysis errors under a Dirichlet boundary condition, and FIG. 53B shows analysis errors under Dirichlet and Neumann boundary conditions;

FIGS. 54A and 54B are views each showing the relationship between the number of nodes and analysis errors in the hexahedral elements, wherein FIG. 54A shows analysis errors under the Dirichlet boundary condition, and FIG. 54B shows analysis errors under Dirichlet and Neumann boundary conditions;

FIG. 55A-FIG. 55D are views showing pentahedral meshes, wherein FIG. 55A shows a mesh of right-triangular prisms, FIG. 55B shows a mesh of obtuse-triangular prisms, FIG. 55C shows a mesh of elongate triangular prisms, and FIG. 55D shows a mesh of directional, right-triangular prisms;

FIGS. 56A and FIG. 56B are views showing analysis errors in pentahedral elements, wherein FIG. 56A shows analysis errors under a Dirichlet boundary condition, and FIG. 56B shows analysis errors under Dirichlet and Neumann boundary conditions; and

FIG. 57 is a flowchart illustrating an analysis process of the finite element method according to the invention.

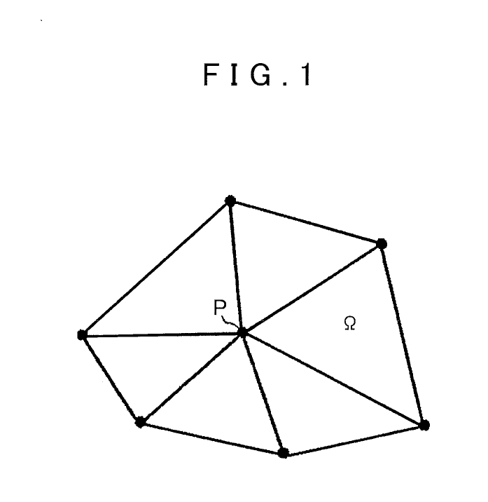

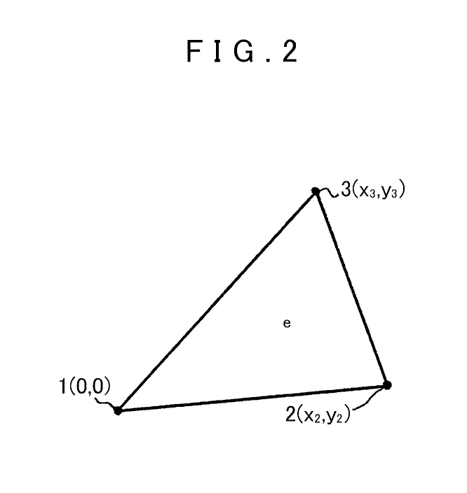

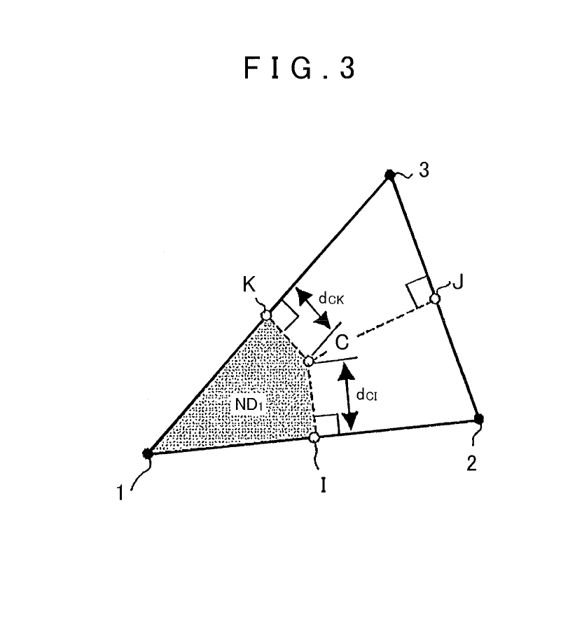

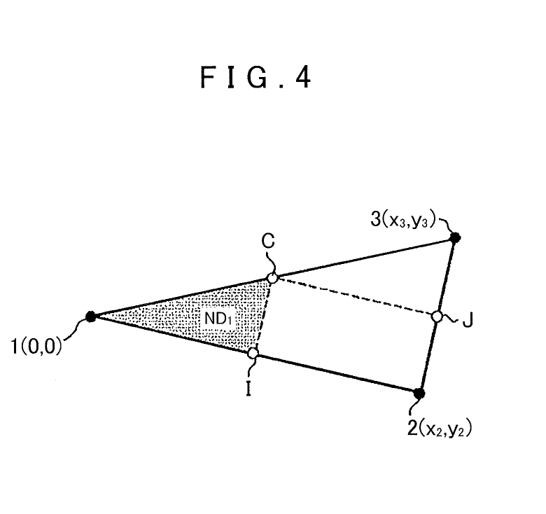

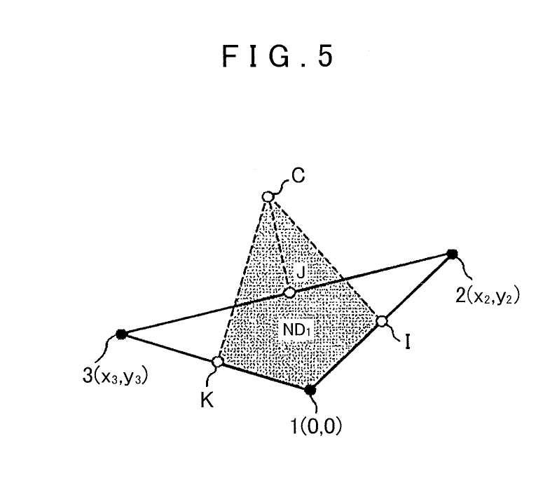

### DETAILED DESCRIPTION OF THE EMBODIMENTS

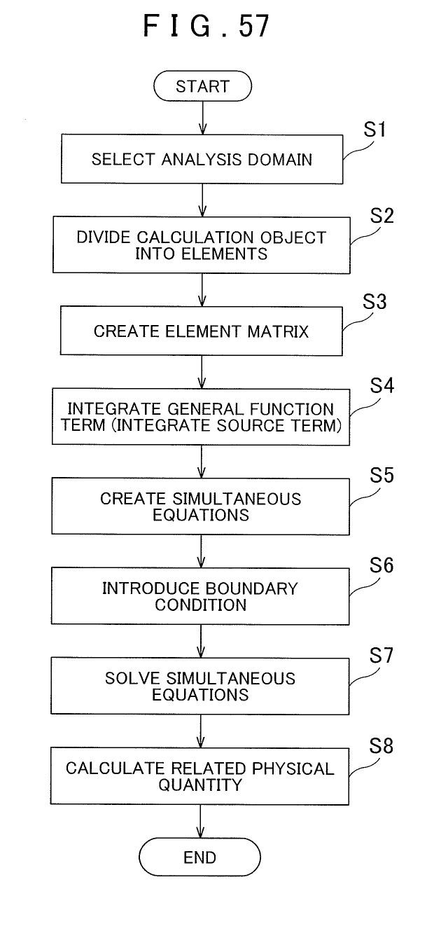

Some embodiments of the invention will be described in detail. In the following description, the embodiments are roughly classified into the case of a two-dimensional triangular element, the case of a three-dimensional tetrahedral element, the case of a two-dimensional quadrangular element, the case of a three-dimensional hexahedral element, and the case of a three-dimensional pentahedral element. While the analysis method of the finite element method is explained in the following description, the analysis method is generally programmed into an analysis program, according to which a computer performs arithmetic processing. In other words, each step illustrated in FIG. 57 constitutes an analytical computation program that causes the computer to perform analytical computations using the finite element method.

Initially, the flow of the analysis method using the finite element method will be roughly explained with reference to FIG. 57. When an object to be analyzed is numerically analyzed by the finite element method, an analysis domain of the analysis object (which may have any shape) is selected in step S1 (selecting step), and the analysis domain is divided into a plurality of elements as calculation objects in step S2 (dividing step). Subsequently, in step S3, the element integration is performed with a weight function W applied with respect to each node of the element e (nodes 1, 2, 3 in the case of a two-dimensional linear triangular element, nodes 1, 2, 3, 4 in the case of a three-dimensional linear tetrahedral element, nodes 1, 2, 3, 4 in the case of a two-dimensional linear quadrangular element, nodes 1, 2, 3, 4, 5, 6, 7, 8 in the case of a three-dimensional linear hexahedral element, nodes 1, 2, 3, 4, 5, 6 in the case of a three-dimensional linear pentahedral element), so that the matrix of each element is created (for example, the left-hand side of the above-indicated Equation (3) in the case of a two-dimensional triangular element, the left-hand side of Equation (10) in the case of a three-dimensional tetrahedral element, the left-hand side of the above-indicated Equation (3)′ or the left-hand side of Equation (15) in the case of a two-dimensional quadrangular element, and the left-hand side of Equation (24) in the case of a three-dimensional hexahedral element or three-dimensional pentahedral element) (element matrix creating step).

In step S4 that provides a principal part of this invention, a general function term as a product of the Galerkin weight function W and a general function (for example, Q if it is concerned with a heat program, or the like, f if it is concerned with a load, body force, and mass problem) is integrated (general function term integrating step). When a heat problem, or the like, is dealt with in step S4, for example, the source term of the Poisson equation (for example, the right-hand side of Equation (33) which will be described later in the case of a two-dimensional triangular element, the right-hand side of Equation (36) which will be described later in the case of a three-dimensional tetrahedral element, the right-hand side of Equation (46) which will be described later in the case of a two-dimensional quadrangular element, and the right-hand side of Equation (72) which will be described later in the case of a three-dimensional hexahedral or pentahedral element) is integrated (source term integrating step). Also, when the analysis is concerned with the load, body force, or mass, the element integration of the load, body force, or mass is performed, using Equation (33)′ in the case of a two-dimensional triangular element, Equation (36)′ in the case of a three-dimensional tetrahedral element, Equation (71) in the case of a two-dimensional quadrangular element, and Equation (96) in the case of a three-dimensional hexahedral or pentahedral element, namely, by replacing the first item of Equation (33)′, the first of Equation (36)′, the first of Equation (71), or the first of Equation (96) (force term integration step).

Then, in step S5, simultaneous equations are created based on the sum of the matrices of the respective elements in the element domain Ω around node P, and the sum of the integrals of the general function term (simultaneous equations creating step).

At this time, according to the invention, a boundary condition that matches the range of a nodal domain is introduced into each of the simultaneous equations created with respect to the elements around each node in step S6 (boundary condition introducing step), as will be described in detail later.

Then, the simultaneous equations are solved by, for example, an iteration method in step S7 (computing step), and numerical solutions are obtained by performing calculations of associated physical quantities in step S8 (computing step). With the above steps executed, the analysis is completed.

(Analysis of Two-dimensional Triangle) In the analysis method using the finite element method as described above, the general function term used in the general function term integrating step of step S4 is calculated, using a typical value (such as a value at the geometric center, a value at the position of the average of node coordinates, or an element average value) of the element e, according to the present invention.

More specifically, in the case of the Poisson equation, an elliptic operator on the left-hand side of Equation (1) is discretized according to the known finite element method, and the source term on the right-hand side is discretized according to the known finite element method, to provide

∫∫ₑWQdxdy

to which an additional term

$$( ND - \frac{S}{3} ) {Q}_{G}$$

is added. Namely, Equation (33) below is proposed which replaces the known Equation (3).

$$- {\sum }_{e} \int {\int }_{e} W \{ \frac{\partial }{\partial x} ( λ \frac{\partial T}{\partial x} ) + \frac{\partial }{\partial y} ( λ \frac{\partial T}{\partial y} ) \} d x d y = {\sum }_{e} \{ \int {\int }_{e} WQ d x d y + ( ND - \frac{S}{3} ) {Q}_{G} \} \qquad ( 33 )$$

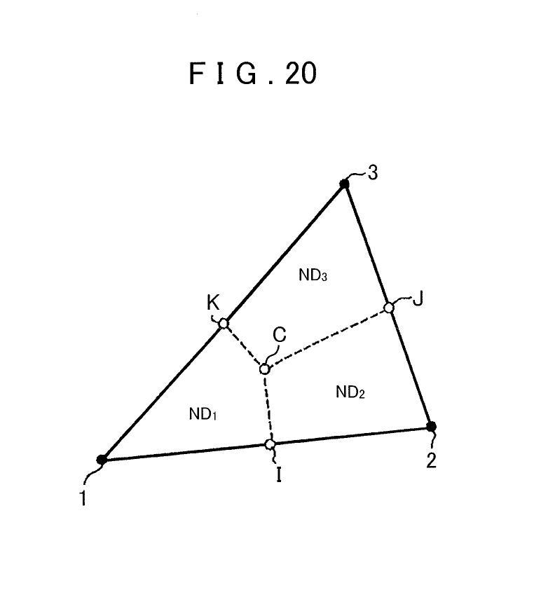

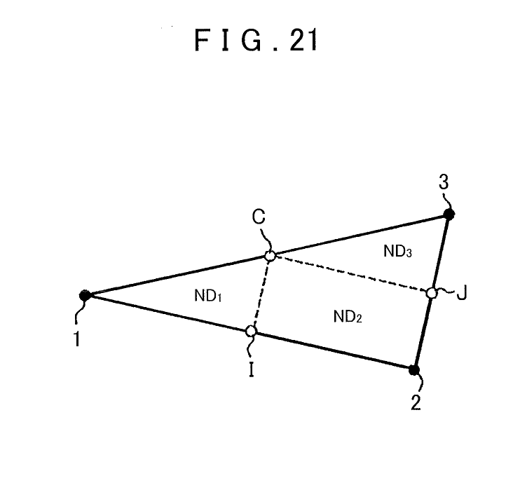

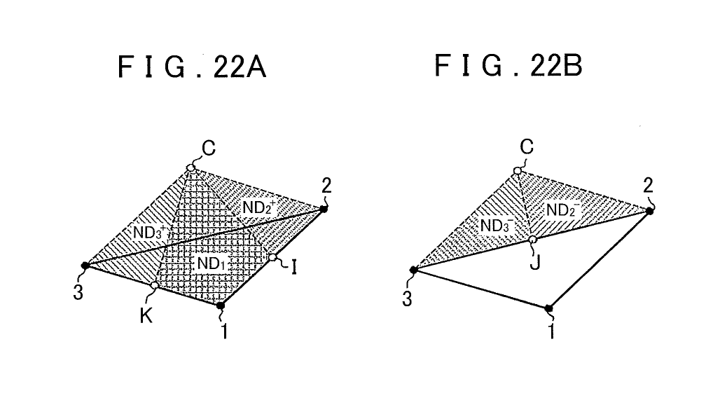

In Equation (33), Q_{G} is a typical source value of the element, and ND is the area of a nodal domain of an object node in the element e. The ND is defined as illustrated in FIG. 20 in the case of an acute-triangular element, defined as illustrated in FIG. 21 in the case of a right-triangular element, and is defined as illustrated in FIGS. 22A and 22B in the case of an obtuse-triangular element. In these figures, the subscript attached to ND represents the node to which the ND belongs, point C is the circumcenter, and points I, J, K are middle points. In the case of the obtuse-triangular element, the circumcenter is located outside the element; therefore, nodal domains ND₂⁻, ND₃⁻, possessed by node 2 and node 3 shown in FIG. 22B are negative. The respective nodal domains are finally calculated according to the following equations.

ND₂=ND₂⁺−|ND₂⁻| [symbol] ND₃=ND₃⁺−|ND₃⁻| (34)

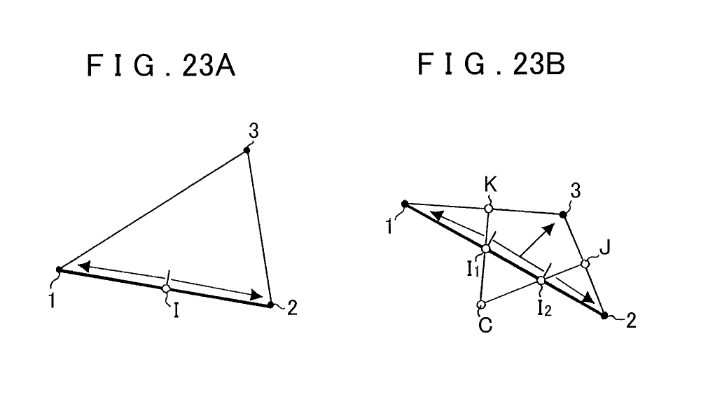

In the boundary condition introducing step of step S6, a boundary condition is introduced in the following manner. Namely, a natural boundary where the heat flux is not zero is processed as shown in FIG. 23A or 23B. When the line connecting node 1 and node 2 is a boundary, and the interior angle at node 3 is equal to or smaller than π/2 (namely, an acute angle is formed at node 3), the quantity of heat that passes between point 1 and point I and flows out as shown in FIG. 23A

$$- {\int }_{1}^{I} λ \frac{\partial T}{\partial n} d l$$

is added to the equation of node 1, and the quantity of heat that passes between point I and point 2

$$- {\int }_{I}^{2} λ \frac{\partial T}{\partial n} d l$$

is added to the equation of node 2. In the above expressions,

∫dl

is a integral on a line, and n is the direction of the outward normal.

When the interior angle at node 3 exceeds π/2 (namely, an obtuse angle is formed at node 3), the quantity of heat passing between point 1 and point I₁

$$- {\int }_{1}^{{I}_{1}} λ \frac{\partial T}{\partial n} d l$$

is added to the equation of node 1, and the quantity of heat passing between point I₂ and point 2

$$- {\int }_{{I}_{2}}^{2} λ \frac{\partial T}{\partial n} d l$$

is added to the equation of node 2, while the quantity of heat passing between point I₁ and

$$- {\int }_{{I}_{1}}^{{I}_{2}} λ \frac{\partial T}{\partial n} d l$$

is added to the equation of node 3.

The source term distributed on a line is also allocated to the equations of the nodes, in the same manner in which the natural boundary condition is distributed as illustrated in FIGS. 23A and 23B.

The method of analyzing a two-dimensional triangle using the finite element method according to this embodiment as described above has the following features.
(1) Since the source amount commensurate with the size of the nodal domain is incorporated, the conservation rule at the node level is satisfied with second-order accuracy.
(2) The effect of correction is larger as the quality of the element is lower.
(3) The source term outside the element is not introduced no matter what shape the element has.
(4) Since the sum of the nodal domains possessed by the three nodes of the element is equal to S, namely,

ND₁+ND₂+ND₃=S (35)

no matter what shape the element has, the conservation rule at the element level is also satisfied, even if the additional term is introduced into the source term.
(5) The superiority of the finite element method as the optimum discretization method for the elliptic operator is maintained.
(6) The correction of the algorism results in substantially no increase in the amount of calculation.

(Analysis of Three-dimensional Tetrahedron) In the analysis of a three-dimensional tetrahedron, too, the general function term in the general function term integrating step of step S4 is calculated, using a typical value of the element e, in the analysis method using the finite element method as described above.

More specifically, the elliptic operator on the left-hand side of Equation (8) is discretized according to the known finite element method, and an additional term

$$( ND - \frac{V}{4} ) {Q}_{G}$$

is added to the source term on the right-hand side. Thus, Equation (36) below is proposed, in place of the known Equation (10).

$$- {\sum }_{e} \int \int {\int }_{e} W \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = {\sum }_{e} \{ \int \int {\int }_{e} WQ d x d y d z + ( ND - \frac{V}{4} ) {Q}_{G} \} \qquad ( 36 )$$

In the above equation, too, Q_{G} is a typical source value, and ND is a volume of a nodal domain of an object node in the element e. The nodal domain ND is determined in the following manner. Where the node number of the object node in the element e is 1, and the origin of a local coordinate system is placed on the object node (node number 1), the result of integration on the left-hand side of Equation (36) can be arranged into the form of products of coefficients and heat fluxes as indicated on the right-hand side of the following equation, using integration by parts and the Gauss-Green theorem.

$$- \int \int {\int }_{e} W \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = {S}_{12} \times λ \frac{{T}_{1} - {T}_{2}}{\sqrt{{x}_{2}^{2} + {y}_{2}^{2} + {z}_{2}^{2}}} + {S}_{13} \times λ \frac{{T}_{1} - {T}_{3}}{\sqrt{{x}_{3}^{2} + {y}_{3}^{2} + {z}_{3}^{2}}} + {S}_{14} \times λ \frac{{T}_{1} - {T}_{4}}{\sqrt{{x}_{4}^{2} + {y}_{4}^{2} + {z}_{4}^{2}}} \qquad ( 37 )$$

where boundary integration is separately considered.

In Equation (37),

$$λ \frac{{T}_{1} - {T}_{2}}{\sqrt{{x}_{2}^{2} + {y}_{2}^{2} + {z}_{2}^{2}}} λ \frac{{T}_{1} - {T}_{3}}{\sqrt{{x}_{3}^{2} + {y}_{3}^{2} + {z}_{3}^{2}}} λ \frac{{T}_{1} - {T}_{4}}{\sqrt{{x}_{4}^{2} + {y}_{4}^{2} + {z}_{4}^{2}}}$$

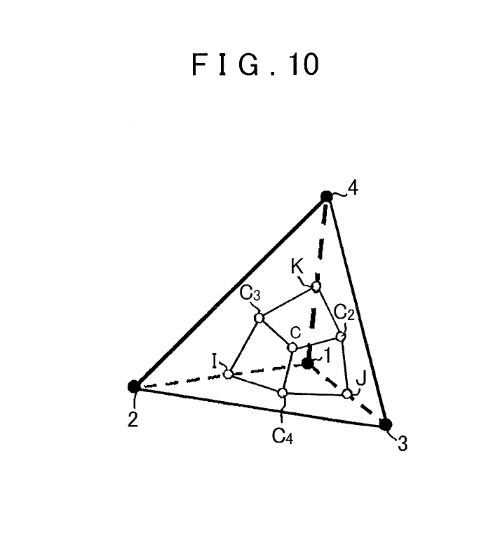

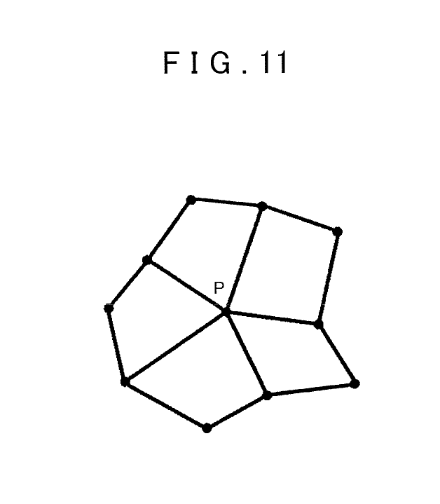

are second-order accurate approximations of heat fluxes directed from node 1 to nodes 2, 3, 4, respectively, at the middle points I, J, K of the sides of the element as shown in FIG. 10, and coefficients S₁₂, S₁₃, S₁₄ correspond to areas through which the respective heat fluxes pass vertically. The two subscripts attached to S represent the direction of the heat flux. The volume of the nodal domain of node 1 is obtained according to the following equation, as the sum of the volumes of the pyramids each having a bottom equal to the area of passage of the heat flux, and a height equal to the distance between node 1 and each of the middle points.

$${ND}_{1} = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} ) \qquad ( 38 )$$

Also, a general formula representing the area Sij (i, j=1, 2, 3, 4, i≠j) of passage of heat flux is derived in the following manner. Initially, the following equation is obtained by developing the left-hand side of Equation (37), using an approach of the finite element method.

$$- \int \int {\int }_{e} W \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = \int \int {\int }_{e} λ \{ \frac{\partial W}{\partial x} \frac{\partial T}{\partial x} + \frac{\partial W}{\partial y} \frac{\partial T}{\partial y} + \frac{\partial W}{\partial z} \frac{\partial T}{\partial z} \} d x d y d z = \int \int {\int }_{e} \frac{λ}{{( 6 v )}^{2}} \{ {a}_{i} {\sum }_{j = 1}^{4} {a}_{j} {T}_{j} + {b}_{i} {\sum }_{j = 1}^{4} {b}_{j} {T}_{j} + {c}_{i} {\sum }_{j = 1}^{4} {c}_{j} {T}_{j} \} d x d y d z ( i = 1 , 2 , 3 , 4 ) = \frac{- λ}{36 V} {\sum }_{j = 1}^{4} \{ ( {a}_{i} {a}_{j} + {b}_{i} {b}_{j} + {c}_{i} {c}_{j} ) ( {T}_{i} - {T}_{j} ) \} ( j \neq i ) \qquad ( 39 )$$

Here, the element volume V is obtained according to the following equation.

$$V = \frac{1}{6} \vert \begin{matrix}{x}_{2} & {y}_{2} & {z}_{2} \\ {x}_{3} & {y}_{3} & {z}_{3} \\ {x}_{4} & {y}_{4} & {z}_{4}\end{matrix} \vert \qquad ( 40 )$$

The coefficients in Equation (39) are indicated below.

$${a}_{1} = - \vert \begin{matrix}{y}_{3} & {z}_{3} \\ {y}_{4} & {z}_{4}\end{matrix} \vert + \vert \begin{matrix}{y}_{2} & {z}_{2} \\ {y}_{4} & {z}_{4}\end{matrix} \vert - \vert \begin{matrix}{y}_{2} & {z}_{2} \\ {y}_{3} & {z}_{3}\end{matrix} \vert , \\ {a}_{2} = \vert \begin{matrix}{y}_{3} & {z}_{3} \\ {y}_{4} & {z}_{4}\end{matrix} \vert , \\ {a}_{3} = \vert \begin{matrix}{y}_{4} & {z}_{4} \\ {y}_{2} & {z}_{2}\end{matrix} \vert , \\ {a}_{4} = \vert \begin{matrix}{y}_{2} & {z}_{2} \\ {y}_{3} & {z}_{3}\end{matrix} \vert \\ {b}_{1} = \vert \begin{matrix}{x}_{3} & {z}_{3} \\ {x}_{4} & {z}_{4}\end{matrix} \vert - \vert \begin{matrix}{x}_{2} & {z}_{2} \\ {x}_{4} & {z}_{4}\end{matrix} \vert + \vert \begin{matrix}{x}_{2} & {z}_{2} \\ {x}_{3} & {z}_{3}\end{matrix} \vert , \\ {b}_{2} = - \vert \begin{matrix}{x}_{3} & {z}_{3} \\ {x}_{4} & {z}_{4}\end{matrix} \vert , \\ {b}_{3} = - \vert \begin{matrix}{x}_{4} & {z}_{4} \\ {x}_{2} & {z}_{2}\end{matrix} \vert , \\ {b}_{4} = - \vert \begin{matrix}{x}_{2} & {z}_{2} \\ {x}_{3} & z3\end{matrix} \vert \\ {c}_{1} = - \vert \begin{matrix}{x}_{3} & {y}_{3} \\ {x}_{4} & {y}_{4}\end{matrix} \vert + \vert \begin{matrix}{x}_{2} & {y}_{2} \\ {x}_{4} & {y}_{4}\end{matrix} \vert - \vert \begin{matrix}{x}_{2} & {y}_{2} \\ {x}_{3} & {y}_{3}\end{matrix} \vert , \\ {c}_{2} = \vert \begin{matrix}{x}_{3} & {y}_{3} \\ {x}_{4} & {y}_{4}\end{matrix} \vert , \\ {c}_{3} = \vert \begin{matrix}{x}_{4} & {y}_{4} \\ {x}_{2} & {y}_{2}\end{matrix} \vert , \\ {c}_{4} = \vert \begin{matrix}{x}_{2} & {y}_{2} \\ {x}_{3} & {y}_{3}\end{matrix} \vert \qquad ( 41 )$$

It is understood from Equation (39) that the coefficient of λ(Tᵢ−Tⱼ) is

$$\frac{- 1}{36 V} ( {a}_{i} {a}_{j} + {b}_{i} {b}_{j} + {c}_{i} {c}_{j} )$$

If the distance between node i and node j is denoted as lᵢⱼ, Equation (42) is obtained, and the coefficient of λ(Ti−Tj) can be rewritten into Equation (43).

$$\begin{matrix}{l}_{ij} = \sqrt{{( {x}_{i} - {x}_{j} )}^{2} + {( {y}_{i} - {y}_{j} )}^{2} + {( {z}_{i} - {z}_{j} )}^{2}} & ( 42 ) \\ \frac{- 1}{36 V} ( {a}_{i} {a}_{j} + {b}_{i} {b}_{j} + {c}_{i} {c}_{j} ) = \frac{- {l}_{ij}}{36 V} ( {a}_{i} {a}_{j} + {b}_{i} {b}_{j} + {c}_{i} {c}_{j} ) \times \frac{1}{{l}_{ij}} & ( 43 )\end{matrix}$$

Referring to the right-hand side of Equation (37), the area of passage of heat flux transmitted between node i and node j can be determined according to the following equation.

$${S}_{ij} = \frac{- {l}_{ij}}{36 V} ( {a}_{i} {a}_{j} + {b}_{i} {b}_{j} + {c}_{i} {c}_{j} ) \qquad ( 44 )$$

Using this Equation (44), the nodal domain of each node is calculated according to the same concept as that of Equation (38).

Also, in the boundary condition introducing step of step S6, a boundary condition is introduced in the following manner. Namely, at a natural boundary where the heat flux is not zero, an additional term

$$- ( ND - \frac{S}{3} ) \frac{\partial T}{\partial n} {\vert}_{SG}$$

is added to the result of processing according to the known finite element method

$$- \int {\int }_{S} W \frac{\partial T}{\partial n} d s$$

$$and \\ - \{ \int {\int }_{S} W \frac{\partial T}{\partial n} d s + ( ND - \frac{S}{3} ) \frac{\partial T}{\partial n} {\vert}_{SG} \}$$

is introduced as a boundary condition into Equation (36). In the above expressions, s represents a boundary that belongs to the element e, S is the area of s, and SG means the geometric center of s, while n is the direction of the outward normal, and ND is the area of each of the nodal domains into which s is divided by the method of two-dimensional triangle analysis as described above.

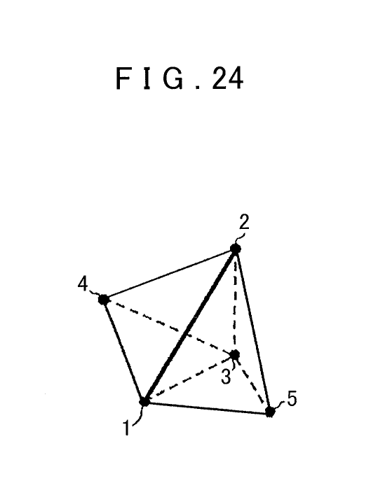

The source term Q distributed on a line is uniformly allocated or distributed to surface triangles of the respective elements which share the line. In the case of a line connecting node 1 and node 2 as shown in FIG. 24, for example, there are four element surface triangles that contain the line, namely, triangles 124, 123, 123, 125. The triangle 123 is counted as two triangles since it belongs to two elements. Q/4 is allocated to each triangle. The source term (Q/4) is further distributed to three nodes in the triangle in the same manner in which the source term distributed on a line is divided in the two-dimensional triangle analysis as described above. The source term distributed on a plane is also divided or distributed in the same manner as that of the method of two-dimensional triangle analysis.

The method of analyzing a three-dimensional tetrahedron using the finite element method according to this embodiment as described above has the following features.
(1) Since the source term commensurate with the size of the nodal domain is allocated to each node, the conservation rule at the node level is satisfied with higher accuracy than that of the known method.
(2) The effect of correction is larger as the quality of the element is lower.
(3) The source term outside the element is not introduced even when the element has an arbitrary tetrahedral shape.
(4) Since the sum of the nodal domains that belong to four nodes of the element is equal to the element volume even when the element has an arbitrary tetrahedral shape, the conservation rule at the element level is satisfied even if the additional term is introduced.
(5) The superiority of the finite element method as the optimum discretization method for the elliptic operator is maintained.
(6) The correction of the algorism results in substantially no increase in the amount of calculation.

(Two-dimensional Triangle Analysis and Three-dimensional Tetrahedron Analysis in Other Fields) In the above description of the two-dimensional triangle analysis and three-dimensional tetrahedron analysis, the analysis method of the embodiment is applied to the heat conduction problem by way of example. However, the analysis method may be applied as it is to all of the phenomena described by the Poisson equation. The fields to which the analysis method may be applied include, for example, flow problems, electrical and magnetic problems, elastic deformation problems, and substance diffusion problems.

The basic concept of the present invention is to find the control volume in the result of discretization of the elliptic operator from the viewpoint of the conservation rule of second-order accuracy, and match the integral domain of the source term with the control volume. Accordingly, this concept can be easily applied to finite element analyses of various governing operations including elliptic operators derived from the conservation rule. Namely, when generation and disappearance, and outflow and inflow, of a physical quantity are calculated, the concept of the nodal domain derived from the present invention may be introduced or applied to an integral domain over which integration is performed. For example, in a non-steady advection-diffusion analysis, the concept of the integral domain of the source term according to the invention can be applied to discretization of a non-steady term and an advective term.

In the analysis concerned with the load, body force and mass (which will be generically called “force”) according to the known finite element method, the forces are handled in the same manner as the source term of the Poisson equation (see “Basic Finite Element Method” written by Shao Changcheng (see, in particular, Chapter 4), published by Morikita Shuppan, 2008) (namely, the force term is multiplied by the Galerkin weight function and integrated with respect to each element). Therefore, there is a problem that the force term is uniformly or evenly distributed to the node equations irrespective of the shape of the element, as discussed above with regard to the prior art, but the manner of handling the source term as explained above in the embodiment may be used to solve the problem.

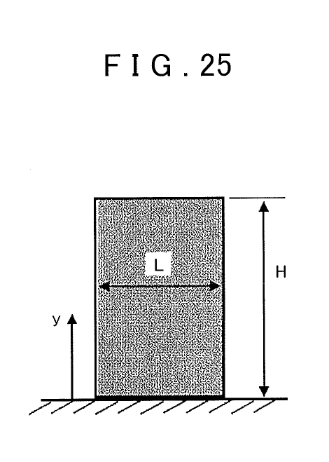

The problem encountered in the prior art will be explained in an example below. Displacement of a plate having a width of L, a height of H and a thickness of 1 due to the self-weight, which is vertically placed as shown in FIG. 25, will be considered. In the equations below, ρ]represents the density, g represents the gravitational acceleration, and E represents the modulus of elasticity. In order to clarify the essence of the problem, it is considered as a plane stress problem, and the Poisson's ratio ν is set to 0 (ν=0). Where the amount of change in the overall height of the plate is represented by V, and the upward coordinate is denoted as y, the stress is expressed as σ=−(H−y)ρg, and the distortion is expressed as ε=σ/E; thus, an exact solution of the following equation is obtained.

$$\begin{matrix}V = {\int }_{0}^{H} ɛ d y \\ = - \frac{{H}^{2} ρ g}{2 E}\end{matrix}$$

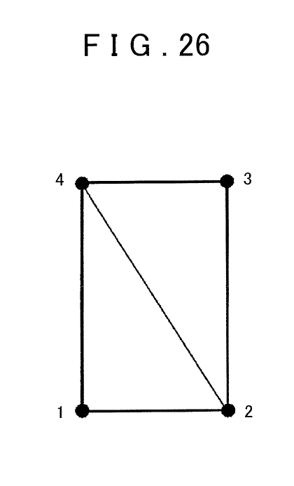

On the other hand, the plate is divided into two triangular elements as shown in FIG. 26. If the quantities of forces applied to node 3 and node 4 in the y direction are represented by f₃ and f₄, respectively, one third of the weight of the element is distributed to each node as indicated in Equation (5), according to the known finite element method. Therefore, the quantities of the forces f₃ and f₄ are given by

$${f}_{3} = - \frac{HL}{6} ρ g$$

$${f}_{4} = - \frac{HL}{3} ρ g$$

Since node 4 possesses two elements, the load allocated to node 4 is twice as large as the load allocated to node 3. As a result of the analysis, displacements ν₃ and ν₄ of node 3 and node 4 in the y direction are given by

$${v}_{3} = - \frac{{H}^{2} ρ g}{2 E} + \frac{{H}^{2} {L}^{2} ρ g}{6 ( {L}^{2} + {H}^{2} ) E}$$

$${v}_{4} = - \frac{{H}^{2} ρ g}{2 E} - \frac{{H}^{2} {L}^{2} ρ g}{6 ( {L}^{2} + {H}^{2} ) E}$$

It can be ascertained that these results deviate from the exact solution.

(When Force is Distributed on Line) In the two-dimensional triangle analysis, when the interior angle at node 3 is equal to or smaller than π/2, as shown in FIG. 23A,

∫^{I}₁ƒdl [symbol] ∫²_{I}ƒdl

are added to the equations of nodes 1, 2, respectively. In the above expression represents a given component of the load, a given component of the body force, or mass. When the interior angle at node 3 exceeds π/2,

∫₁^{I}^{₁}ƒdl [symbol] ∫²_{I}_{₂}ƒdl [symbol] ∫_{I}_{₁}^{I}_{₂}ƒdl

are added to the equations of nodes 1, 2, 3, respectively.

In the three-dimensional tetrahedron analysis, the force is uniformly or evenly distributed to surface triangles of the respective elements that share the line in question. For example, in the case of the line connecting node 1 and node 2 as shown in FIG. 24, f/4 is allocated to each of four surface triangles. Furthermore, the force is distributed to three nodes in each triangle, in the same manner as the manner of dividing the source term distributed on the line in the above-described two-dimensional triangle analysis.

(When Force is Distributed over Plane) In the two-dimensional triangle, or three-dimensional tetrahedron analysis, the load, body force, or the mass distributed over a plane s is corrected in the same manner as the source term of the right-hand side of Equation (33), and

$$\{ \int {\int }_{S} Wf d s + ( ND - \frac{S}{3} ) {f}_{G} \} \qquad {( 33 )}^{′}$$

is given to an object node after the correction. In Equation (33′), S is the area of s, and subscript G represents a typical value of the element (e.g., a value at the geometric center, a value at the position of the average of node coordinates, or an element average value).

(When Force is distributed in Space) The load, body force, or the mass distributed in space is corrected in the same manner as the source term of the right-hand side of Equation (36), and

$$\{ \int \int {\int }_{e} Wf d x d y d z + ( ND - \frac{V}{4} ) {f}_{G} \} \qquad {( 36 )}^{′}$$

is obtained after the correction.

(Effect of the Invention in Two-dimensional Triangle Analysis and Three-dimensional Tetrahedron Analysis) The following example indicates that the analysis accuracy is improved if the analysis method of this invention is employed.

If the concept of the nodal domain is applied to the problem of displacement of the plate due to its self-weight, and reference is made to Equation (33)' and FIG. 21, it is found that the quantities of forces applied to node 3 and node 4 in the y direction are given by

$${f}_{3} = - \frac{HL}{4} ρ g$$

$${f}_{4} = - \frac{HL}{4} ρ g$$

Here, the quantity of force given to node 4 is the sum of those of two elements. As a result of the analysis, the displacements of node 3 and node 4 in the y direction are:

$${v}_{3} = {v}_{4} = - \frac{{H}^{2}}{2 E} ρ g$$

This result coincides with the exact solution, and it is ascertained that the analysis accuracy is improved.

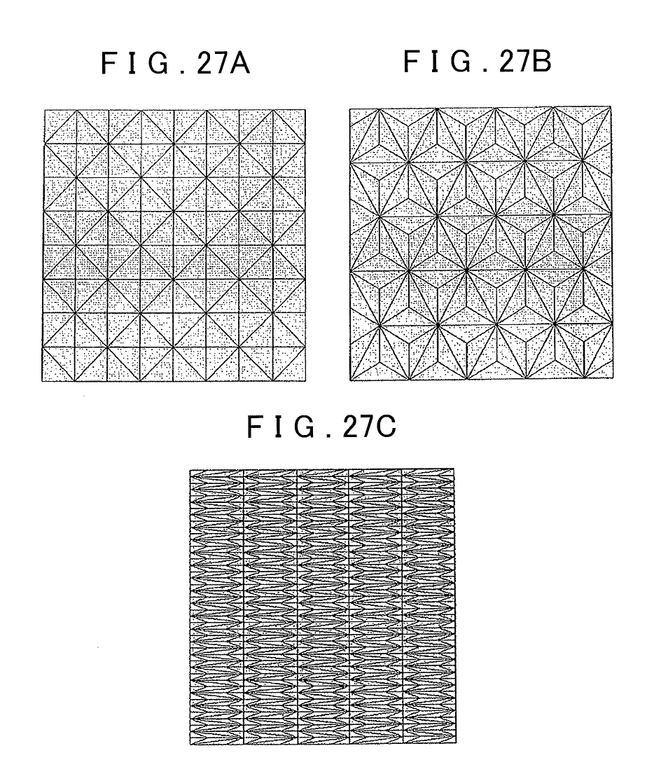

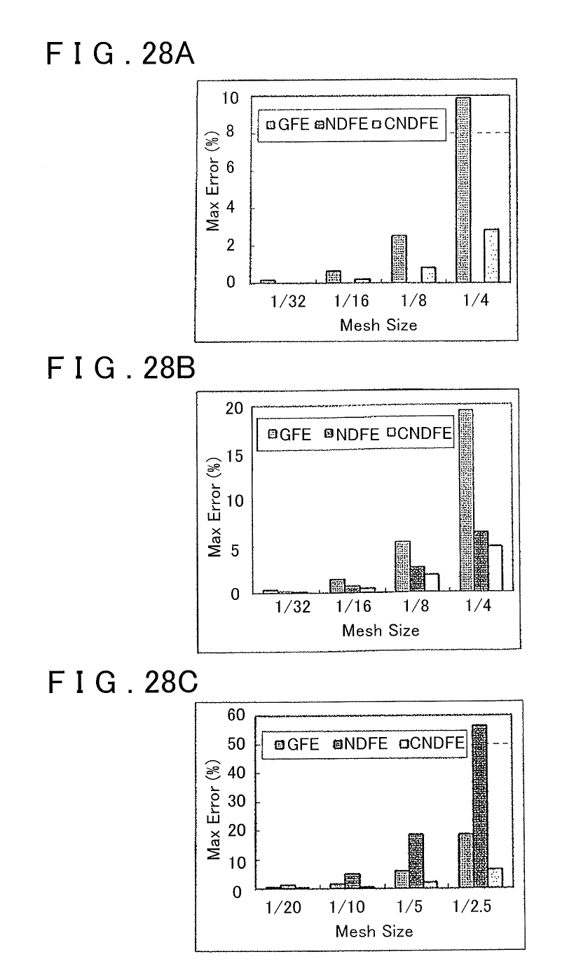

As a two-dimensional triangle problem, the heat conduction problem defined by Equations (6) and (7) was analyzed using mesh patterns of FIGS. 27A-27C, and the maximum errors in the analysis are shown in FIGS. 28A-28C. Where λ=1, and the geometric center is used as an element typical value of the source term, the maximum error is defined by the following equation.

$$Max . Error = \frac{Max . \vert {T}_{Ai} - {T}_{Ni} \vert}{{T}_{Amax}} \times 100 ( \% ) \qquad ( 45 )$$

In Equation (45), T_{Ai} denotes an exact solution at node i, and T_{Ni} denotes a numeral solution at node i, while T_{Amax} is the maximum value of the exact solutions. The horizontal axis of FIG. 28 represents a typical length of the mesh (mesh size), and the mesh size of the same pattern is doubled at a time along the horizontal axis. Of the mesh sizes indicated in FIGS. 28A-28C, ⅛ in FIG. 28A, ⅛ in FIG. 28B and ⅕ in FIG. 28C are those of the meshes of FIGS. 27A-27C, respectively, when they are used as they are. “GFE” denotes the results obtained by the known finite element method, and “NDFE” denotes the results obtained by the above-described improvement method 1, while “CNDFR” denotes the results obtained according to the present invention. It is understood from FIGS. 28A-28C that, in any of the mesh patterns, analysis errors that occurred when the proposed method of the invention was employed were reduced to be one-third of those of the known finite element method. While high accuracy was achieved by the above-described improvement method 1 when a right-triangular mesh was used, it was recognized that errors significantly increased when an elongate triangular mesh was used.

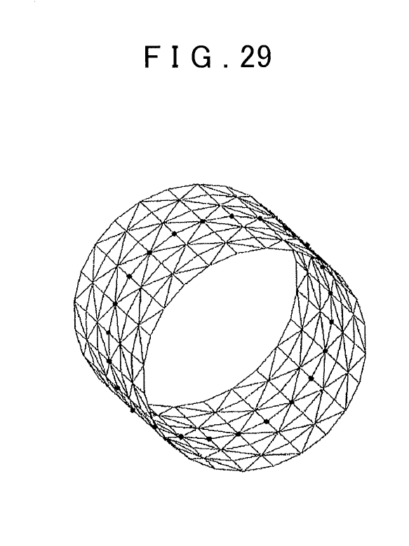

As an example of analysis concerned with the load, body force and mass according to the finite element method, (1) a problem of deformation caused by a uniform internal pressure applied to a thin cylinder, and (2) a uniform rotation problem in which the cylinder rotates at a uniform or constant velocity about the center axis of the cylinder were presented. FIG. 29 illustrates a mesh to be analyzed, which was formed by dividing the cylinder into shell elements of right-angled, equilateral triangles. In this case, constraint conditions in the circumferential direction and axial direction were given to nodes (indicated by •) located at middle positions as viewed in the axial direction.

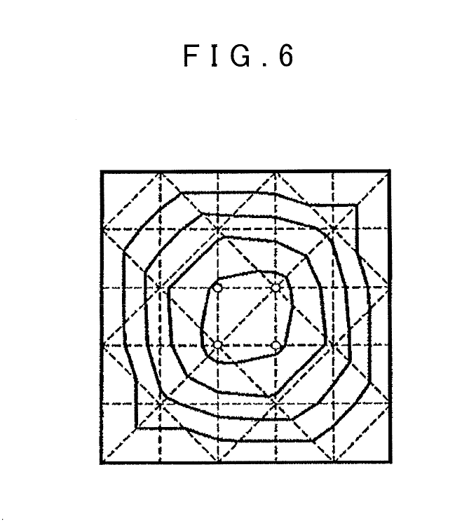

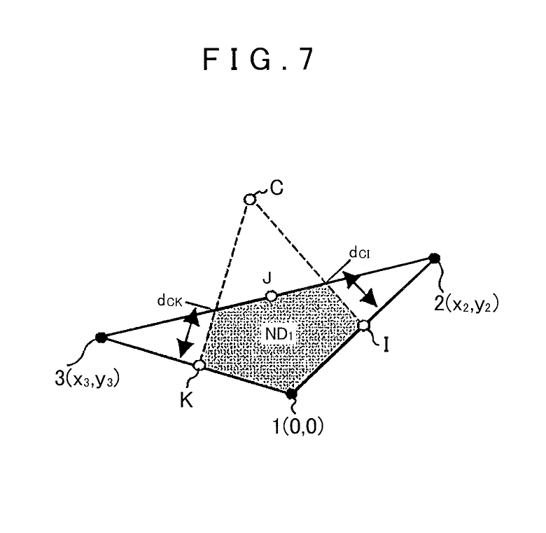

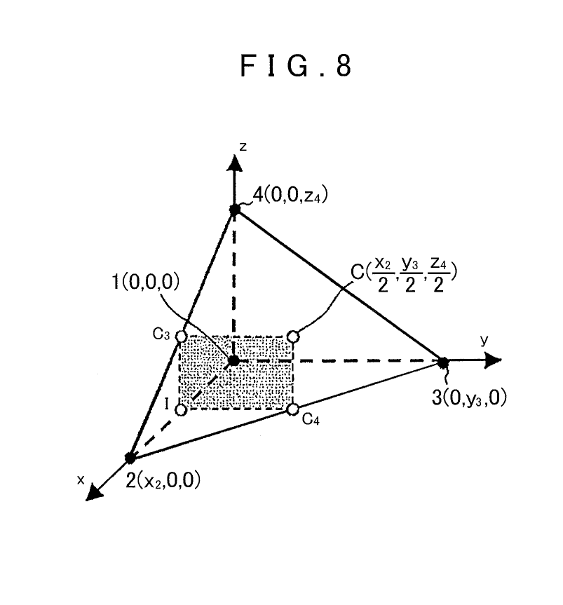

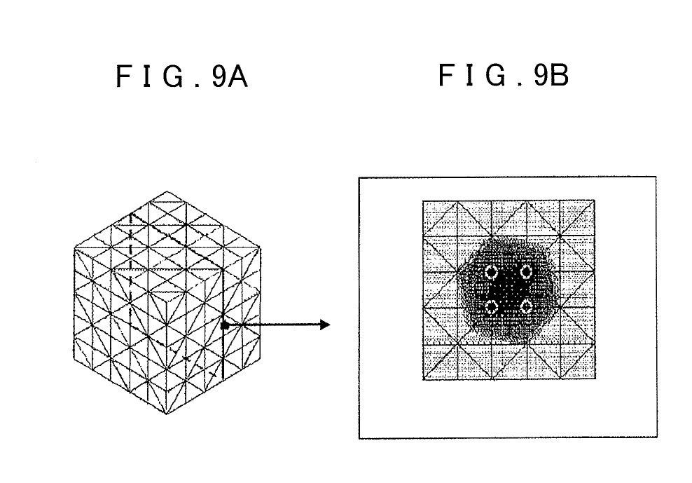

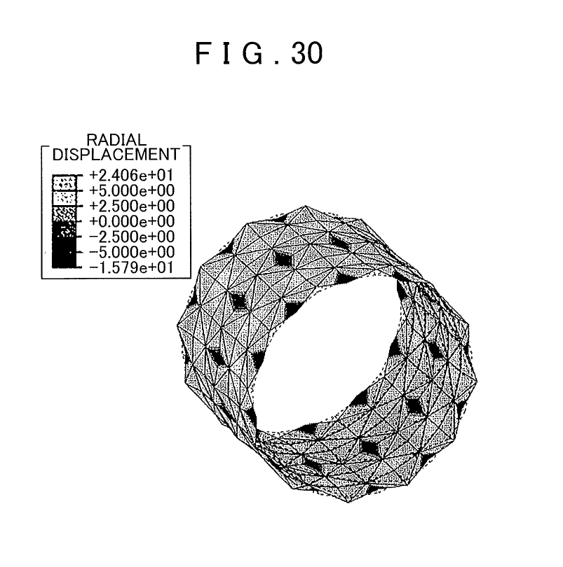

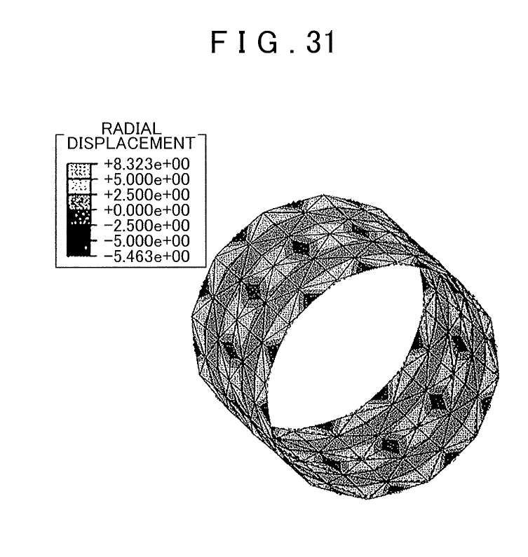

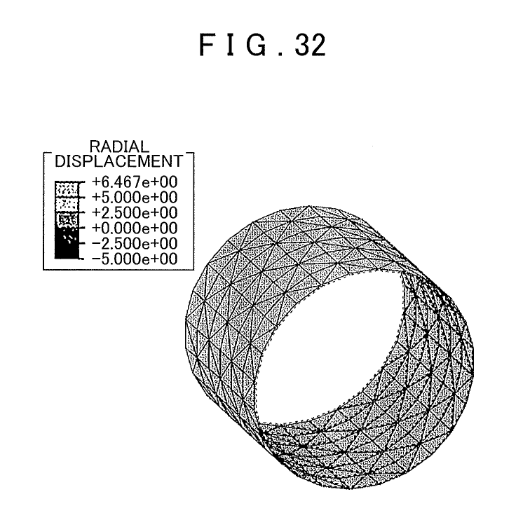

FIG. 30 shows displacements in radial directions due to the internal pressure when the known finite element method was used, and FIG. 31 shows displacements in radial directions due to rotation when the known finite element method was used. In these figures, dotted lines indicate the initial shape, and gray regions indicate displacements in expansion directions, while black regions indicate displacements in contraction directions. Unlike the actual phenomena where the same displacement occurs at each node, differences in displacement appeared, depending on local mesh patterns around the nodes. The reason for this result is common to the inconsistency problem as described above with reference to FIG. 6. FIG. 32 shows the result of displacements in radial directions due to the internal pressure when the proposed method of the invention (“When Force is Distributed over Plane” as discussed above) was used. It can be recognized that the application or distribution of the load to the nodes according to the element shape results in uniform displacement. Since the same analysis principle is applied to the rotation problem, it is clear that uniform displacement is achieved if the centrifugal force is distributed to the respective nodes according to the same concept.

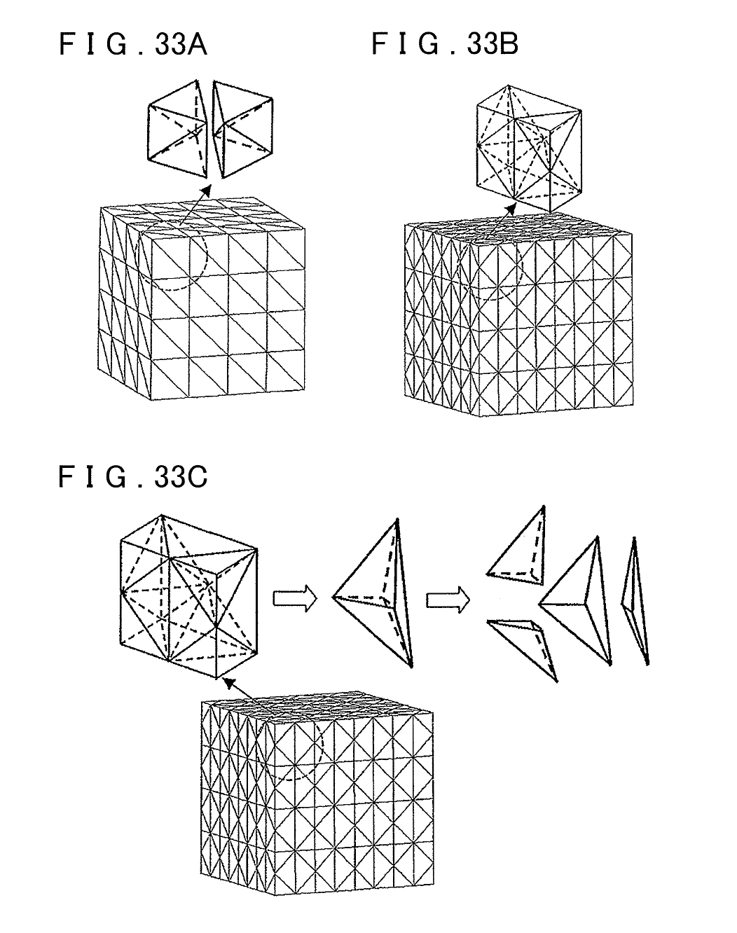

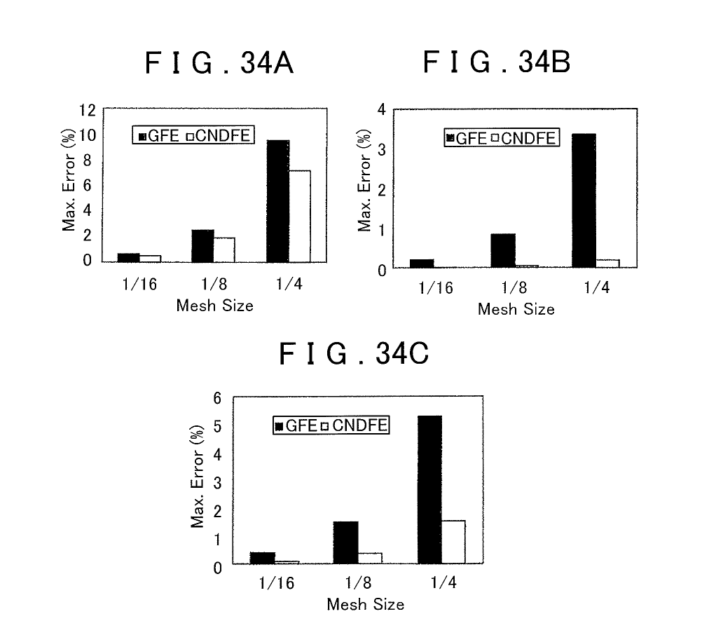

As a three-dimensional tetrahedron problem, the heat conduction problem defined by Equations (13) and (14) was analyzed using mesh patterns of FIGS. 33A-33C, and the maximum errors in the analysis are shown in FIGS. 34A-34C. In the analysis, λ was set to 1 (λ=1), and the geometric center was used as an element typical value of the source term. As a mesh pattern, FIG. 33A shows an example in which one cube is divided into six tetrahedrons, and FIG. 33B shows an example in which one rectangular parallelepiped is divided into fourteen tetrahedrons, while FIG. 33C shows an example in which each tetrahedron of FIG. 33B is further divided into four tetrahedrons. It is understood from FIGS. 34A-34C that, according to the analysis method of the invention, the analysis accuracy was improved in any of the mesh patterns, and errors that occurred in low-quality elements, in particular, were reduced to be equal to or smaller than a half of those of the known finite element method.

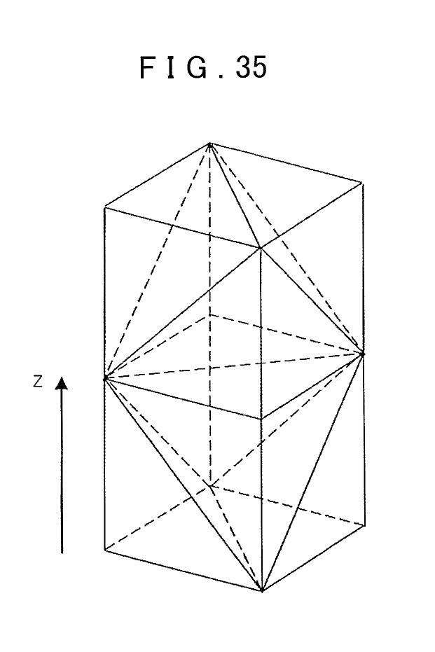

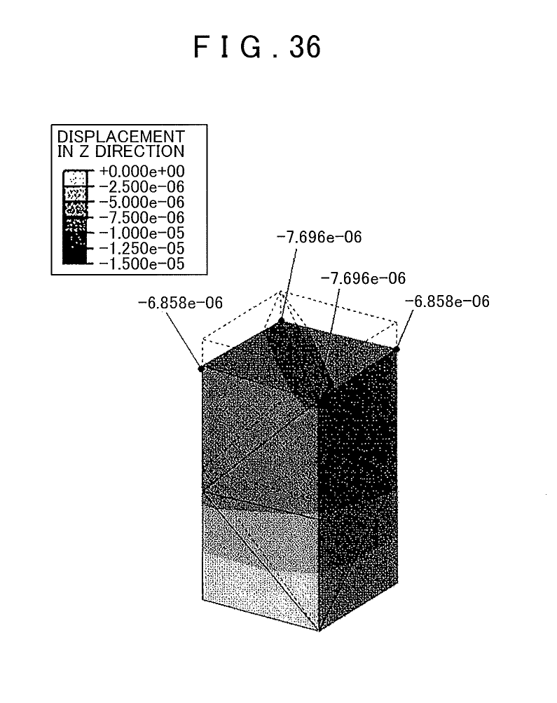

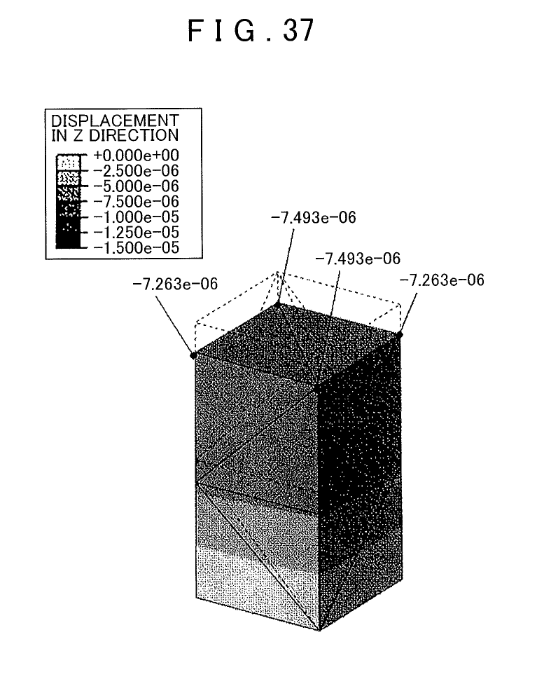

As an example of analysis concerned with the load, body force and mass according to the finite element method, a problem of deformation due to the self-weight of a square column as shown in FIG. 35 is presented, and the effect of improvement provided by the invention will be illustrated. FIG. 36 shows the result of displacement in the height direction according to the known finite element method, and FIG. 37 shows the result of displacement in the height direction according to the present invention, namely, when Equation (36)′ was used. It can be recognized that, in contrast to an actual phenomena where the same displacement takes place at four nodes on the top face, differences in displacement among four nodes in the analysis result of this invention were significantly reduced as compared with the known finite element method. The reason for the improvement will be explained with regard to the leftmost node on the top face by way of example. According to the known finite element method, only one-fourth of the self-weight of the element is given to the node in question; therefore, the absolute value of the displacement is small. According to the invention, one half of the self-weight of the element is given to the node in question, based on Equation (36′), thus assuring an improvement effect in terms of displacement.

(Analysis of Two-dimensional Quadrangle) Next, analysis of a two-dimensional quadrangle will be explained. In order to solve a problem that the conservation rule is not satisfied in the two-dimensional quadrangle analysis, a conservation type discretization method of discretizing a source term, which can be easily implemented, is proposed. The left-hand side of Equation (3)′ is discretized according to the finite element method, whereas an additional term

(ND_{P}−∫∫ₑW_{P}dxdy)ƒ_{O}

is added to the right-hand side of Equation (3)′ so as to perform finite element analysis according to the following equation.

$$- {\sum }_{e} \int {\int }_{e} {W}_{P} \{ \frac{\partial }{\partial x} ( λ \frac{\partial T}{\partial x} ) + \frac{\partial }{\partial y} ( λ \frac{\partial T}{\partial y} ) \} d x d y = {\sum }_{e} \{ \int {\int }_{e} {W}_{P} Q d x d y + ( {ND}_{P} - \int {\int }_{e} {W}_{P} d x d y ) {Q}_{O} \} \qquad ( 46 )$$

In Equation (46), ND_{P} denotes a nodal domain of node P in the element e, and Q_{O} is a source value at point O. If ND_{P} is equal in area to the control volume derived from the integral of the left-hand side of Equation (15), the conservation rule can be satisfied with second-order accuracy, and the mesh dependence is improved; in particular, the effect of improvement in accuracy in low-quality elements can be expected. It may also be proposed to substitute another typical value of the element source term, such as a source value at the center of gravity, or an element average value, for Q_{O} in Equation (46). Also, the element integral of the right-hand side of Equation (3)′ may be simply approximated by ND_{P}Q_{G}.

In a quadrilateral element of a general shape, nodal domains are calculated by a universal method as described below. If the local number of node P in the element e is 1, the result of element integration of the left-hand side of Equation (15) can be arranged or simplified into the following general formula.

$$\int {\int }_{e} λ ( \frac{\partial {W}_{1}}{\partial x} \frac{\partial T}{\partial x} + \frac{\partial {W}_{1}}{\partial y} \frac{\partial T}{\partial y} ) d x d y = λ {\sum }_{i = 1}^{4} {A}_{i} {T}_{i} \qquad ( 47 )$$

where coefficient Aᵢ is a constant determined only by the coordinates of the four nodes. According to the property of the finite element method, the following expressions are established.

$${A}_{1} > 0 , {\sum }_{i = 1}^{4} {A}_{i} = 0 \qquad ( 48 )$$

(Method 1 of Calculating Nodal Domain in Two-dimensional Quadrangle) Suppose i, j, k represent different nodes selected from nodes 2, 3, 4, and the order or correspondence between i, j, k and the node numbers is not limited. With all of the combinations of signs possessed by the coefficients A₂, A₃, A₄ and Equation (48) taken into consideration, Equation (47) can be rewritten into the following form of node temperature differences.

$$\begin{matrix}\int {\int }_{e} λ ( \frac{\partial {W}_{1}}{\partial x} \frac{\partial T}{\partial x} + \frac{\partial {W}_{1}}{\partial y} \frac{\partial T}{\partial y} ) d x d y = λ [ - {A}_{2} ( {T}_{1} - {T}_{2} ) - {A}_{3} ( {T}_{1} - {T}_{3} ) - {A}_{4} ( {T}_{1} - {T}_{4} ) ] \\ ( {A}_{2} \leq 0 , {A}_{3} \leq 0 , {A}_{4} \leq 0 ) \\ = λ [ - {A}_{j} ( {T}_{1} - {T}_{j} ) + ( {A}_{1} + {A}_{j} ) ( {T}_{1} - {T}_{k} ) + {A}_{i} ( {T}_{i} - {T}_{k} ) ] ( 49 \text{-} 2 ) \\ ( {A}_{i} > 0 , {A}_{j} \leq 0 , {A}_{k} \leq 0 , {A}_{1} \geq \vert {A}_{j} \vert ) \\ = λ [ {A}_{1} ( {T}_{1} - {T}_{j} ) - ( {A}_{1} + {A}_{j} ) ( {T}_{i} - {T}_{j} ) - {A}_{k} ( {T}_{i} - {T}_{k} ) ] ( 49 \text{-} 3 ) \\ ( {A}_{i} > 0 , {A}_{j} \leq 0 , {A}_{k} \leq 0 , {A}_{1} < \vert {A}_{j} \vert ) \\ = λ [ {A}_{1} ( {T}_{1} - {T}_{k} ) + {A}_{i} ( {T}_{i} - {T}_{k} ) + {A}_{j} ( {T}_{j} - {T}_{k} ) ] ( 49 \text{-} 4 ) \\ ( {A}_{i} > 0 , {A}_{j} > 0 , {A}_{k} < 0 )\end{matrix} \qquad ( 49 \text{-} 1 )$$

Namely, Equation (49-1) is employed when only A₁ is positive, Equation (49-2) or (49-3) is employed when two coefficients out of A₁, A₂, A₃, A₄ are positive, and Equation (49-4) is employed when three coefficients are positive. Also, it is understood that the coefficients of the respective terms on the right-hand sides of Equations (49-1) through (49-4) have positive values.

The terms of the right-hand sides of Equations (49-1) through (49-4) are classified into those that do not include T₁ and those that include T₁. The development of the terms including T₁ will be explained, taking λB₁ⱼ(T₁−Tⱼ) as an example, where Bᵢⱼ represents a coefficient of the λ(T₁−Tⱼ) term. If L_{b} represents a segment between node 1 and node j, the following equation is obtained.

$$λ {B}_{1 j} ( {T}_{1} - {T}_{j} ) = {B}_{1 j} {L}_{1 j} \times λ \frac{{T}_{1} - {T}_{j}}{{L}_{1 j}} \qquad ( 50 )$$

It is understood that the right-hand side of Equation (50) is the quantity of heat that passes a segment that extends from a middle point of a segment Lᵢⱼ by a length of B₁ⱼL₁ⱼ in a direction perpendicular to L₁ⱼ, due to heat flux of second-order accuracy at the middle point of L₁ⱼ, which is directed from node 1 toward node j. This segment is denoted as BᵢⱼLᵢⱼ. From the viewpoint of the conservation rule, the domain of the source term corresponding to this term is a triangle formed by three points, i.e., node 1, middle point of segment L₁ⱼ, and an end point of segment B₁ⱼL₁ⱼ. The area of the triangle is represented by ND₁ⱼ, and may be calculated according to the following equation.

$${ND}_{1 j} = \frac{1}{4} {B}_{1 j} {L}_{1 j}^{2} \qquad ( 51 )$$

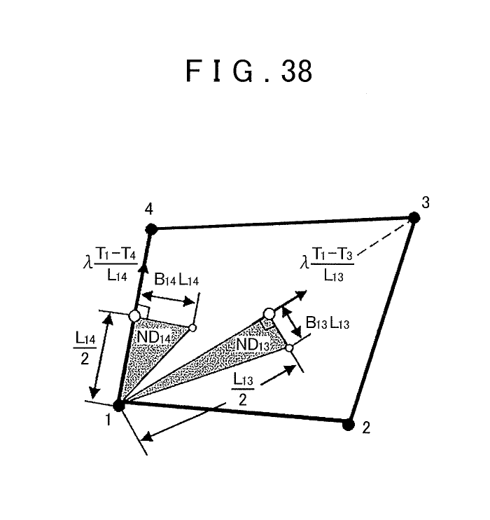

In FIG. 38, ND₁₃ and ND₁₄ are illustrated as two examples. The development of the terms that do not include T₁ will be explained, taking λBᵢⱼ(Tᵢ−Tⱼ) as an example. If Lᵢⱼ represents a segment between node i and node j, the following equation is obtained.

$$λ {B}_{ij} ( {T}_{i} - {T}_{j} ) = {B}_{ij} {L}_{ij} \times λ \frac{{T}_{i} - {T}_{j}}{{L}_{ij}} \qquad ( 52 )$$

It is understood that the right-hand side of Equation (52) is the quantity of heat that passes a segment that extends from a middle point of the segment Lᵢⱼ by a length of BᵢⱼLᵢⱼ in a direction perpendicular to Lᵢⱼ, due to heat flux of second-order accuracy at the middle point of segment Lᵢⱼ, which is directed from node i toward node j. This segment is denoted as BᵢⱼLᵢⱼ. The domain of the source term corresponding to this term is a triangle formed by three points, i.e., node 1, middle point (denoted as “m”) of L_{g}, and the other end point (denoted as “I”) of segment BᵢⱼLᵢⱼ. The area of this triangle is represented by NDᵢⱼ, and is calculated according to the following equation.

$${ND}_{ij} = \pm \frac{1}{2} \vert {x}_{1} {y}_{l} + {x}_{l} {y}_{m} + {x}_{m} {y}_{1} - {x}_{1} {y}_{m} - {x}_{l} {y}_{1} - {x}_{m} {y}_{l} \vert \qquad ( 53 )$$

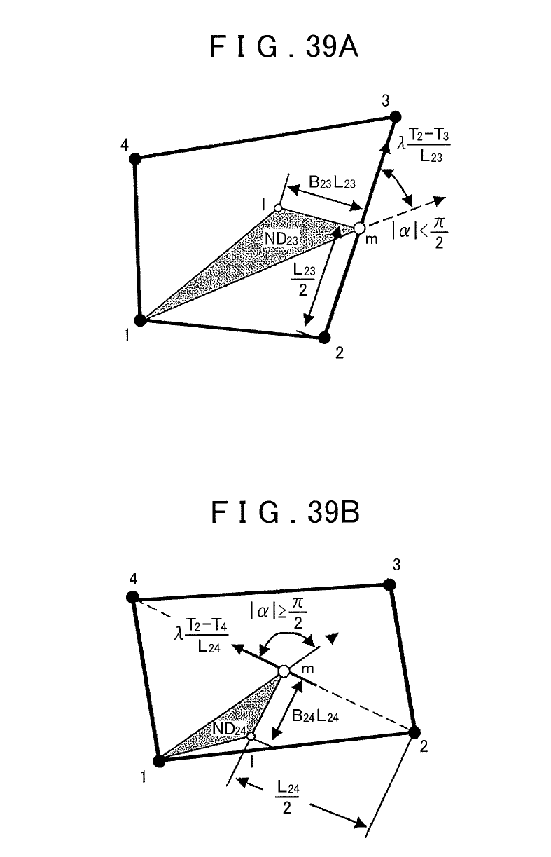

The sign of the right-hand side of Equation (53) is positive when an angle a between a vector directed from point I to the middle point m and the flux vector is within a range of |α|<π/2, namely, when the heat flux flows out of the triangle, and is negative when the angle is within a range of |α|≧π/2, namely, when the heat flux flows into the triangle. FIG. 39A and FIG. 39B show ND₂₃>0 and ND₂₄≦0 as two examples.

Finally, the area of the nodal domain of the object node 1 is calculated according to one of Equations (54-1) to (54-4), which is selected in accordance with the signs of the coefficients A₂, A₃, A₄.

$$\begin{matrix}{ND}_{1} = {ND}_{12} + {ND}_{13} + {ND}_{14} ( {A}_{2} \leq 0 , {A}_{3} \leq 0 , {A}_{4} \leq 0 ) & ( 54 \text{-} 1 ) \\ {ND}_{1} = {ND}_{1 j} + {ND}_{1 k} + {ND}_{ik} \\ ( {A}_{i} > 0 , {A}_{j} \leq 0 , {A}_{k} \leq 0 , {A}_{1} \geq \vert {A}_{j} \vert ) & ( 54 \text{-} 2 ) \\ {ND}_{1} = {ND}_{1 j} + {ND}_{ij} + {ND}_{ik} \\ ( {A}_{i} > 0 , {A}_{j} \leq 0 , {A}_{k} \leq 0 , {A}_{1} < \vert {A}_{j} \vert ) & ( 54 \text{-} 3 ) \\ {ND}_{1} = {ND}_{1 k} + {ND}_{ik} + {ND}_{jk} ( {A}_{i} > 0 , {A}_{j} > 0 , {A}_{k} < 0 ) & ( 54 \text{-} 4 )\end{matrix}$$

(Method 2 of Calculating Nodal Domain in Two-dimensional Quadrangle) ND₁ is obtained according to Equations (49-1), (50), (51) and (54-1), irrespective of the sign and magnitude of the coefficients A₂, A₃, A₄. In this case, NDᵢⱼ(j=2, 3, 4) has the same sign as Bᵢⱼ, namely, −Aⱼ.

(Consistency, Uniqueness, and Normality of the Method of Analyzing Two-dimensional Quadrangle) The consistency means that the nodal domain has the same area as the control volume. If the consistency is established, the conservation rule at the node level is satisfied with second-order accuracy, and the effect of improvement in accuracy is theoretically ensured.

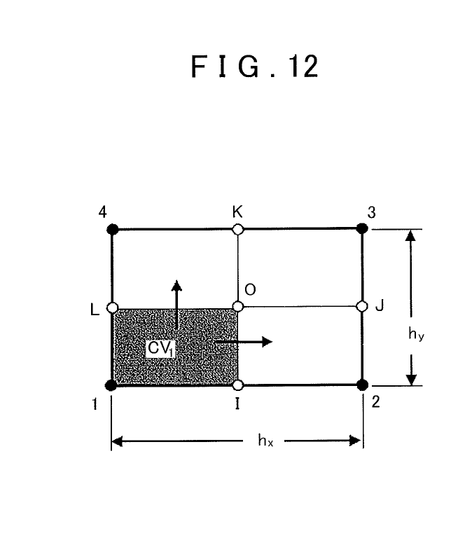

For the rectangular element of FIG. 12, Equation (16) is rewritten into the following equation.

$$\int {\int }_{e}^{ } λ ( \frac{\partial {W}_{1}}{\partial x} \frac{\partial T}{\partial x} + \frac{\partial {W}_{1}}{\partial y} \frac{\partial T}{\partial y} ) d x d y = \frac{λ}{6} [ 2 ( \frac{{h}_{y}}{{h}_{x}} + \frac{{h}_{x}}{{h}_{y}} ) {T}_{1} - ( \frac{2 {h}_{y}}{{h}_{x}} - \frac{{h}_{x}}{{h}_{y}} ) {T}_{2} - ( \frac{{h}_{y}}{{h}_{x}} + \frac{{h}_{x}}{{h}_{y}} ) {T}_{3} - ( \frac{2 {h}_{x}}{y} - \frac{{h}_{y}}{{h}_{x}} ) {T}_{4} ] \qquad ( 55 )$$

With regard to the consistency of the above-described calculation method 1, the coefficients other than T₁ are negative when h_{y}/√2≦hₓ≦√2·hₕ; therefore, Equation (49-1) applies, and the following equation is obtained.

$$\int {\int }_{e}^{ } λ ( \frac{\partial {W}_{1}}{\partial x} \frac{\partial T}{\partial x} + \frac{\partial {W}_{1}}{\partial y} \frac{\partial T}{\partial y} ) d x d y = \frac{λ}{6} [ ( \frac{2 {h}_{y}}{{h}_{x}} - \frac{{h}_{x}}{{h}_{y}} ) ( {T}_{1} - {T}_{2} ) + ( \frac{{h}_{y}}{{h}_{x}} + \frac{{h}_{x}}{{h}_{y}} ) ( {T}_{1} - {T}_{3} ) + ( \frac{2 {h}_{x}}{{h}_{y}} - \frac{{h}_{y}}{{h}_{x}} ) ( {T}_{1} - {T}_{4} ) ] \qquad ( 56 )$$

As a result, the following equation is obtained as the nodal domain.

$${ND}_{1} = \frac{1}{6} ( \frac{S}{2} - \frac{{h}_{x}^{4}}{4 S} ) + \frac{{( {h}_{x}^{2} + {h}_{y}^{2} )}^{2}}{24 S} + \frac{1}{6} ( \frac{S}{2} - \frac{{h}_{y}^{4}}{4 S} ) = \frac{S}{4} \qquad ( 57 )$$

Also, when hₓ>√2·h_{y}, the coefficient of T₂ is positive, and the coefficients of T₃, T₄ are negative. Since A₁>|A₃|, Equation (49-2) applies, and the following equation is obtained.

$$\int {\int }_{e}^{ } λ ( \frac{\partial {W}_{1}}{\partial x} \frac{\partial T}{\partial x} + \frac{\partial {W}_{1}}{\partial y} \frac{\partial T}{\partial y} ) d x d y = \frac{λ}{6} [ ( \frac{{h}_{y}}{{h}_{x}} + \frac{{h}_{x}}{{h}_{y}} ) ( {T}_{1} - {T}_{3} ) + ( \frac{{h}_{x}}{{h}_{y}} + \frac{{h}_{y}}{{h}_{x}} ) ( {T}_{1} - {T}_{4} ) + ( \frac{{h}_{x}}{{h}_{y}} - \frac{2 {h}_{y}}{{h}_{x}} ) ( {T}_{2} - {T}_{4} ) ] \qquad ( 58 )$$

As a result, the following equation is obtained as the nodal domain.

ND₁=S/4 (59)

Since it can be proved that ND₁=S/4 in the case where h_{y}>√2·hₓ, it is understood that the relationship of ND₁=CV₁ is satisfied irrespective of the ratio of h_{y}/hₓ.

With regard to the consistency of the above-indicated calculation method 2, the result is Equation (57) since Equation (49-1) is employed.

Regarding the other nodes, ND₂=ND₃=ND₄=S/4 can be obtained, in view of the symmetry of the element shape. Consequently, for the rectangular element, the addition term of the right-hand side of Equation (46) becomes equal to zero, and the conservation type discretization provides the same result as the Galerkin finite element method.

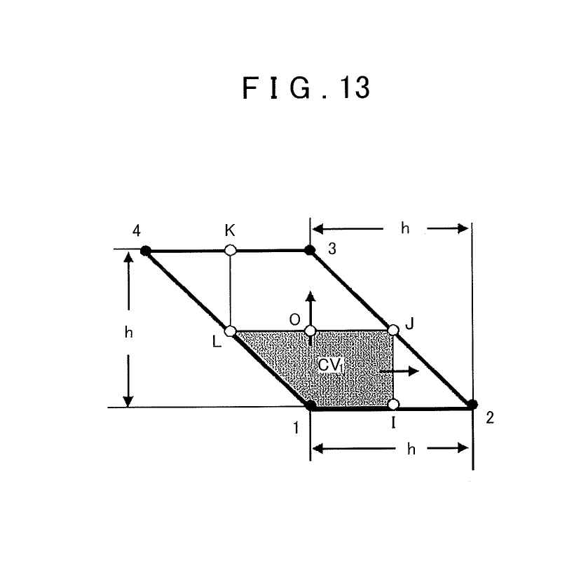

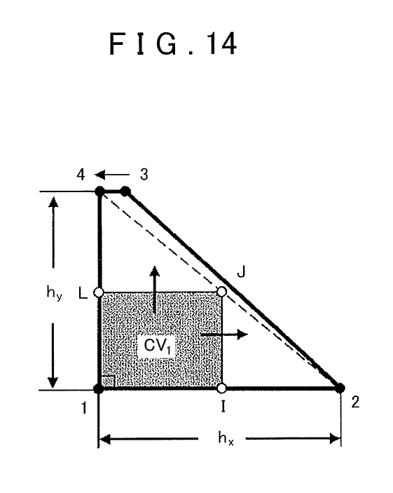

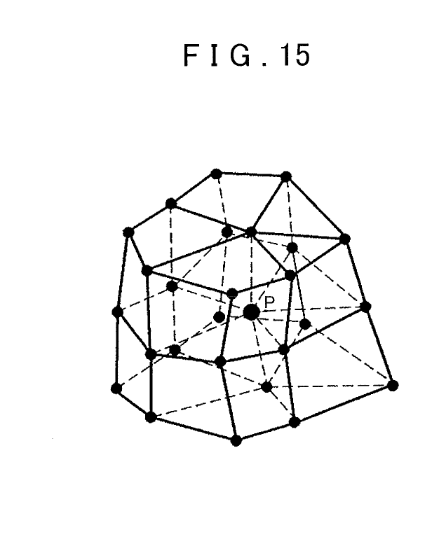

Further, if the analysis method of the invention is applied to the parallelogram element of FIG. 13, and the quadrilateral element of FIG. 14 in which two nodes lie at the same point, the nodal domains as indicated in TABLE 2 above are obtained. It can be confirmed that the nodal domain completely coincides with the control volume, with respect to the above-indicated three types of quadrilateral elements. However, the control volume is not clear with regard to quadrilateral elements of general shapes, and therefore, the effect of improvement in accuracy will be examined through numerical analyses which will be described later.

The uniqueness of the nodal domain means that the result of ND₁ obtained by Equations (54-1) to (54-4) “does not vary depending on the manner of assigning the local node numbers to i, j, k”, and “does not vary even if the calculation method 2 is used”. For example, while i=2, j=3, and k=4 in Equation (58), with respect to a rectangular element of hₓ>√2·h_{y}, it may be considered to select the local node numbers such that i=2, j=4 and k=3, and obtain the nodal domain according to the following equation.

$$\int {\int }_{e}^{ } λ ( \frac{\partial {W}_{1}}{\partial x} \frac{\partial T}{\partial x} + \frac{\partial {W}_{1}}{\partial y} \frac{\partial T}{\partial y} ) d x d y = \frac{λ}{6} [ ( - \frac{{h}_{y}}{{h}_{x}} + \frac{2 {h}_{x}}{{h}_{y}} ) ( {T}_{1} - {T}_{4} ) + \frac{3 {h}_{y}}{{h}_{x}} ( {T}_{1} - {T}_{3} ) + ( \frac{{h}_{x}}{{h}_{y}} - \frac{2 {h}_{y}}{{h}_{x}} ) ( {T}_{2} - {T}_{3} ) ] \qquad ( 60 )$$

As a result, the nodal domain of the following equation is obtained.

ND₁=S/4 (61)

Since this result is the same as the result of Equation (59), the uniqueness is proved in the calculation method 1. The uniqueness in the calculation method 2 is indicated by the result of Equation (57).

The normality is

$${\sum }_{i = 1}^{4} {ND}_{i} = S$$

Namely, it means that the sum of the additional terms put into the right-hand side of Equation (46) with respect to the four nodes of the same element is equal to zero. If the normality is established, it is assured that the conservation rule is satisfied at the element level, over the entire analysis domain. For the element shapes of FIG. 12, FIG. 13 and FIG. 14,

(ND₁=ND₂=ND₃=ND₄=S

as indicated in the last line of TABLE 2 above. Thus, the normality is maintained.

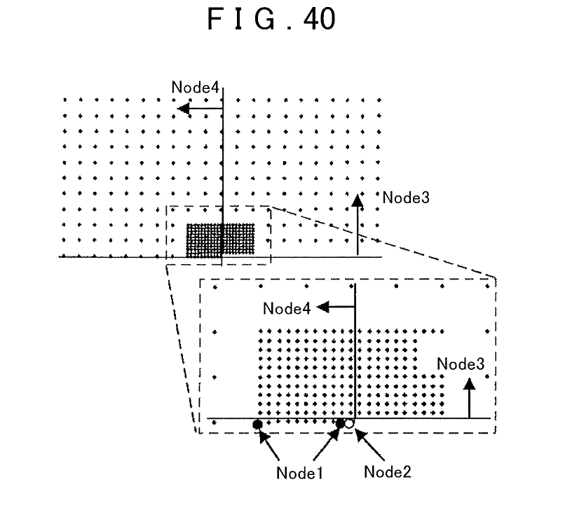

Similarly, it can be theoretically proved that the uniqueness is maintained with respect to the element shapes of FIG. 13 and FIG. 14, too. It is, however, difficult to theoretically discuss the normality and the uniqueness with respect to quadrilateral elements of general shapes because Jacobian is involved. Rather, the normality and uniqueness are examined through numerical calculations as follows. Various shapes of to quadrilateral elements were formed from combinations of node 1 placed at one of two points marked with • in FIG. 40, node 2 placed at a point marked with O, node 3 placed at any of all points other than those in the lowermost row, and node 4 placed at any of all points on the left-hand side of the center column, including those on the column, and each of the quadrilateral elements thus formed was tested. These element shapes may be considered to cover element shapes used in practical analyses. In the calculation method 1 as described above, all of the permissible combinations of local node numbers were assigned to i, j, k, and the nodal domain was calculated by numerical analysis. As a result, except for shapes having an area equal to or below zero and concaved shapes, it was confirmed that the normality and uniqueness were satisfied in all test cases of the calculation method 1, and all test cases of the calculation method 2.

(Effect of Invention when applied to Two-dimensional Quadrangle) The effect of improvement in accuracy of the conservation type discretization method will be illustrated by way of two analysis examples of heat conduction problems. In the examples, the analysis domain is limited to a square domain (0≦x<1, 0≦y≦1), and an element typical source value is set to a value at the average position of the four nodes, while λ is set to 1 (λ=1).

Analysis problem 1 is given by adding only the Dirichlet boundary condition of Equation (64) to the source term of Equation (63).

Q=2π² sin(πx)sin(πy) (63)

T=0(x=0, 1, or y=0, 1) (64)

The exact solution of this problem is given by

T=sin(πx)sin(πy) (65)

Analysis problem 2 is given by adding the Dirichlet boundary condition of Equation (67) and a Neumann boundary condition of Equation (68) to the source term of Equation (66).

$$\begin{matrix}Q = \frac{4}{{e}^{2} - 1} {e}^{( {x}^{2} + {y}^{2} )} ( 1 + {x}^{2} + {y}^{2} ) & ( 66 ) \\ T = \frac{{e}^{2} - {e}^{( 1 + {y}^{2} )}}{{e}^{2} - 1} ( x = 1 ) , T = \frac{{e}^{2} - {e}^{( {x}^{2} + 1 )}}{{e}^{2} - 1} ( y = 1 ) & ( 67 ) \\ \frac{\partial T}{\partial n} = 0 ( x = 0 , y = 0 ) & ( 68 )\end{matrix}$$

The exact solution of this problem is given by

$$T = \frac{{e}^{2} - {e}^{( {x}^{2} + {y}^{2} )}}{{e}^{2} - 1} \qquad ( 69 )$$

Numerical errors in the analyses are evaluated according to the following equation.

$$Max \cdot Error = \frac{Max \cdot \vert {T}_{Ai} - {T}_{Ni} \vert}{{T}_{Amax}} \times 100 ( \% ) \qquad ( 70 )$$

where, T_{Ai} denotes an exact solution at node i, and T_{Ni} denotes a numeral solution at node i, while T_{Amax} is the maximum value of the exact solutions.

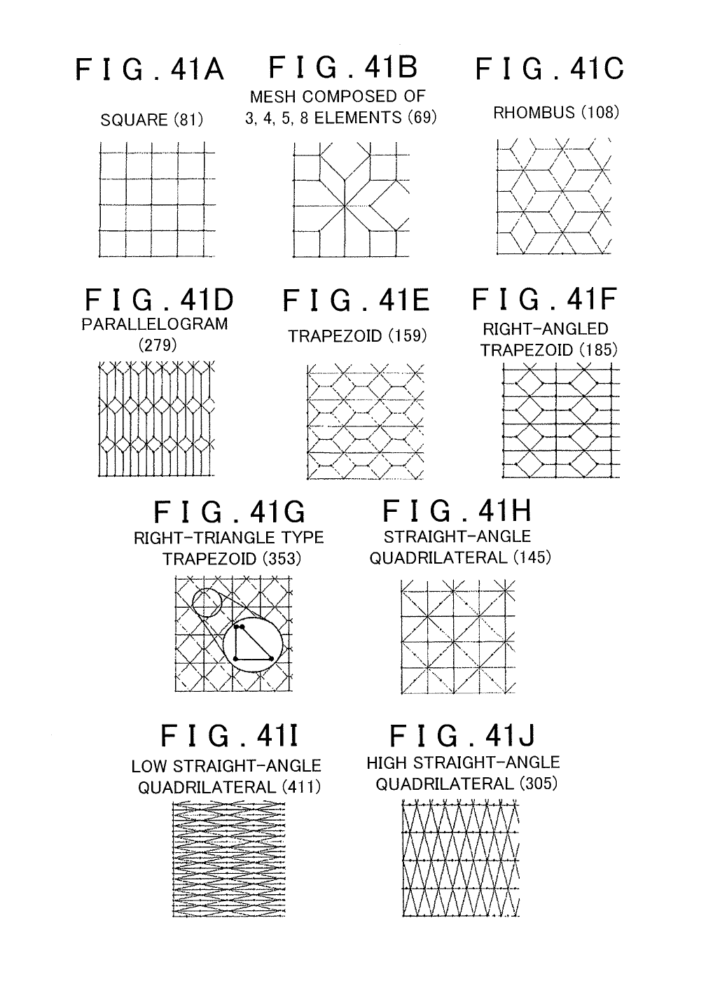

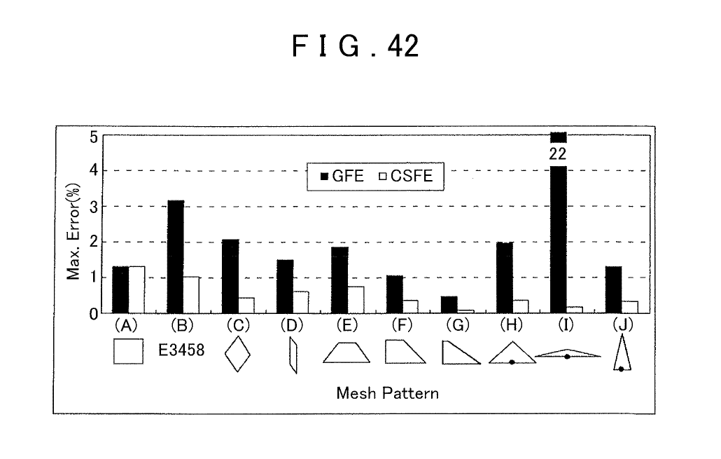

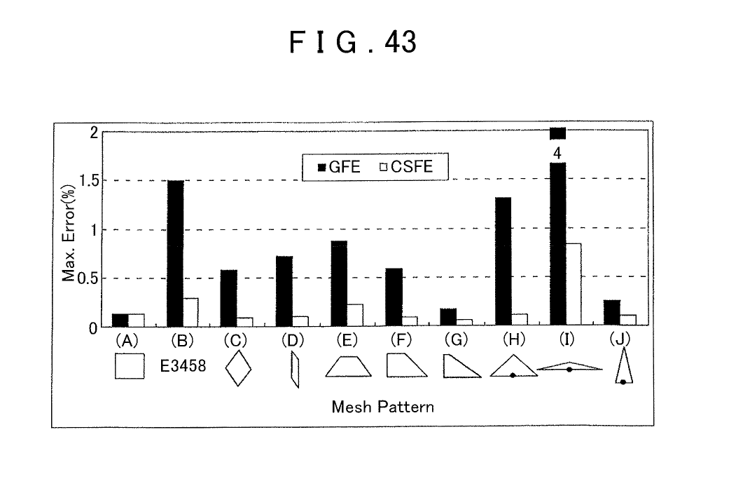

Ten mesh patterns used in the analysis examples are illustrated in FIG. 41, in which only a portion (0≦x≦0.5, 0≦y≦0.5) of each mesh pattern is shown in view of the symmetry. In FIG. 41, “·” represents a node position, and a number in parentheses in the title of each figure represents the total number of the nodes. FIG. 42 shows numerical errors under the Dirichlet boundary condition, and FIG. 43 shows numerical errors under the Dirichlet and Neumann boundary conditions. It is understood from these figures that, in all of the meshes other than the square mesh, errors in the analysis according to the method of the invention (represented by CSFE) are reduced to be one half or less of errors in the analysis according to the known finite element method (represented by GFE).

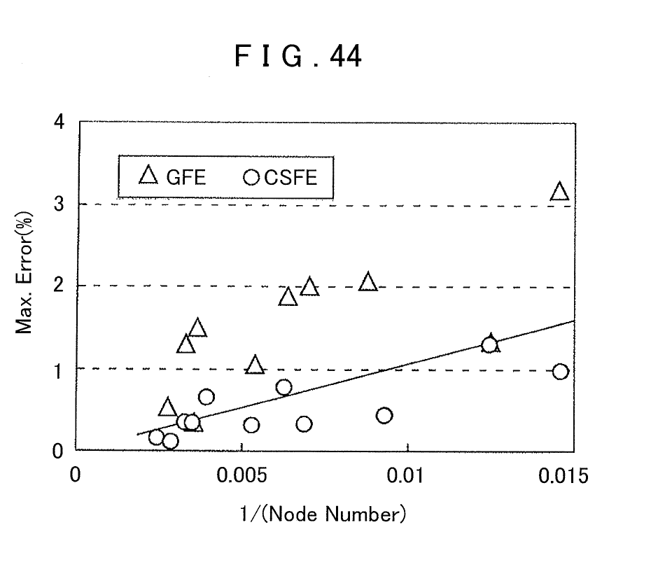

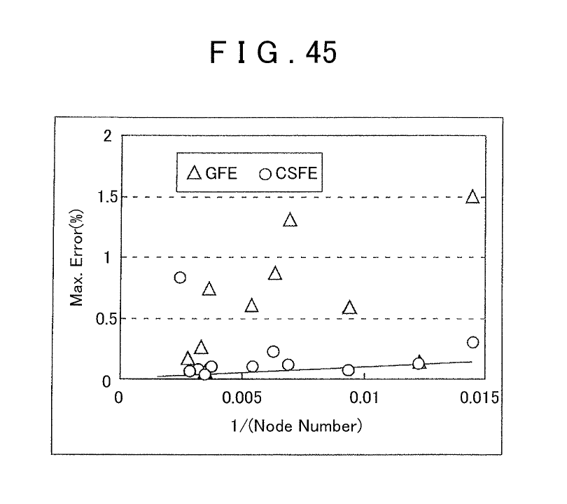

FIG. 44 and FIG. 45 indicate the relationship between the inverse of the total number of nodes in each mesh and the analysis error, and the results obtained for two patterns of square elements are connected by solid lines. It is understood from these figures that the mesh quality has a large influence on the analysis according to the known finite element method, while the mesh quality has a small influence on the analysis according to the conservation type discretization method, and that substantially the same degree of analysis accuracy as that in the case of square elements was obtained, except for the case of low straight-angle quadrilateral elements.

In conclusion, in the finite element analysis of the Poisson equation using linear quadrilateral elements, the new definition of nodal domain was developed, and the conservation type discretization method of discretizing the source term while assuring consistency with the second-order differential values was proposed. Accordingly, the effects of (1)-(4) below were obtained.

(1) The source amount given to the node equation is caused to correspond to the size of the nodal domain in relation to the element shape, so that the conservation rule at the node level is satisfied with second-order accuracy. Furthermore, the conservation rule at the element level is also satisfied.

(2) The source term outside the element is not introduced even in the obtuse-angled element shape, and numeral errors can be suppressed or reduced even in the case where the source term is rapidly changed.

(3) The effect of improvement in accuracy of the method of the invention is larger as the quality of elements is lower.

(4) As a result of numerical analyses using some mesh patterns, it was confirmed that the analysis accuracy is significantly improved as compared with the known finite element method.

(Two-dimensional Quadrangle Analysis in Other Fields) In the above description of the two-dimensional quadrangle analysis, the analysis method of this embodiment is applied to the heat conduction problem by way of example. However, the analysis method of the invention may be applied as it is to all of the phenomena described by the Poisson equation. The fields to which the analysis method may be applied include, for example, flow problems, electrical and magnetic problems, elastic deformation problems, and substance diffusion problems.

The basic concept of the present invention is to find the control volume in the result of discretization of the elliptic operator from the viewpoint of the conservation rule of second-order accuracy, and match the integral domain of the source term with the control volume. Accordingly, this concept can be easily applied to finite element analyses of various governing operations including elliptic operators derived from the conservation rule. Namely, when generation and disappearance, and outflow and inflow, of a physical quantity are calculated, the concept of the nodal domain derived from the present invention may be introduced or applied to an integral domain over which integration is performed. For example, in a non-steady advection-diffusion analysis, the concept of the integral domain of the source term according to the invention can be applied to discretization of a non-steady term and an advective term.

In the analysis concerned with the load, body force and mass according to the known finite element method, the forces are handled in the same manner as the source term of the Poisson equation. Therefore, there exists a problem that the force is evenly distributed to the node equations irrespective of the shape of the element. The problem may be solved or improved by the manner of handling the source term according to the invention. In the analysis of a two-dimensional (when the force is distributed over a plane), or three-dimensional (when the force is distributed in space) problem, if the load, body force, or mass distributed on a plane s is corrected by adding an additional term, like the source term of the right-hand side of Equation (46), the load, body force, or mass allocated to an object node is given by

∫∫_{S}W_{P}fds+(ND_{P}−∫∫_{S}W_{P}ds)f_{O} (71)

where f is a given component of the load, a given component of the body force, or the mass.

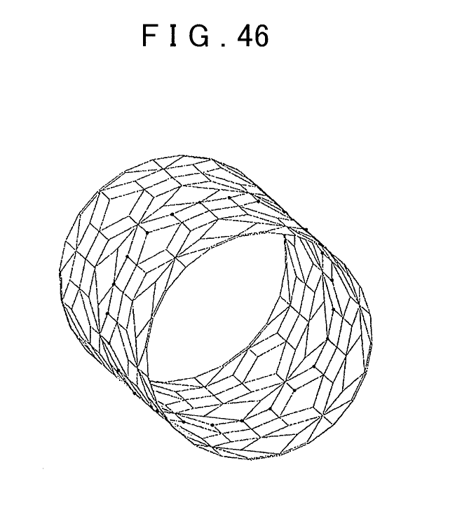

As an example of analysis concerned with the load, body force and mass according to the finite element method, a problem of deformation caused by a uniform internal pressure applied to a thin cylinder was presented. FIG. 46 illustrates a mesh to be analyzed, which was formed by dividing the cylinder into quadrangular shell elements. In this case, constraint conditions in the circumferential direction and axial direction were given to nodes (indicated by •).

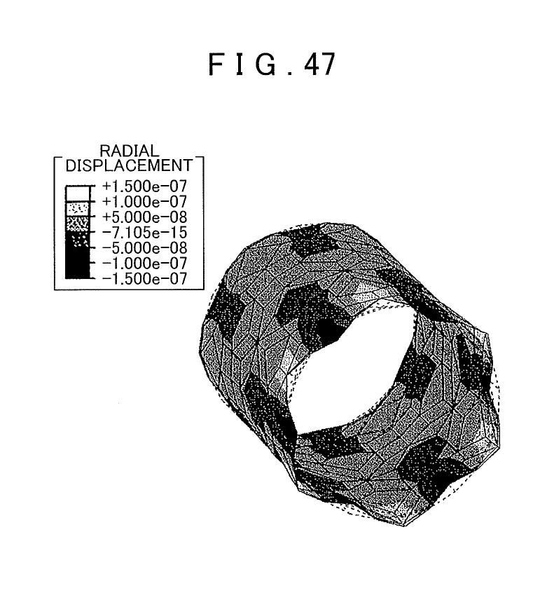

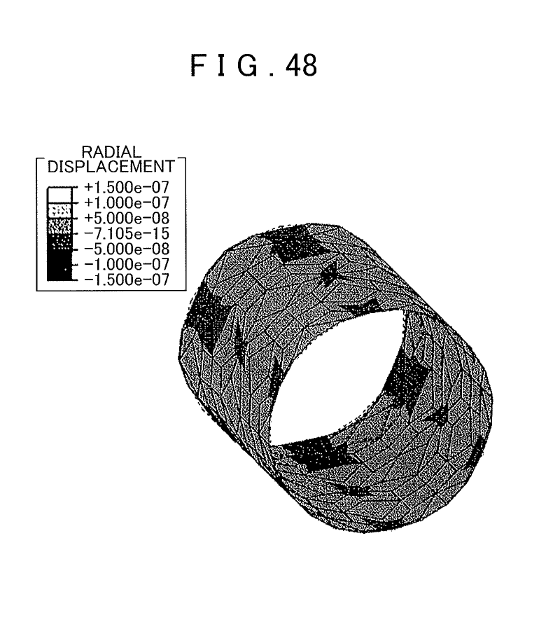

FIG. 47 shows displacements in radial directions due to the internal pressure when the known finite element method was used. In FIG. 47, dotted lines indicate the initial shape, and gray regions indicate displacements in the expansion directions, while black regions indicate displacements in the contraction directions. Unlike the actual phenomena where the same displacement occurs at each node, differences in displacement appeared, depending on local mesh patterns around the nodes. FIG. 48 shows the result of displacements in radial directions due to the internal pressure when the proposed method of the invention (Eq. (71)) was used. It can be recognized that the application or distribution of the load to the nodes according to the element shape results in a significant improvement, i.e., a significant reduction of variations in displacement. The same principle can be applied to problems associated with the body force and the mass.

(Analysis of Three-dimensional Hexahedron and Pentahedron) In order to solve the problem that the conservation rule is not satisfied, as discussed above in “Three-dimensional Hexahedron and Three-dimensional Pentahedron Problems using Known Finite Element Method”, a conservation type discretizing method of discretizing the source term, which can be simply implemented, is proposed. The left-hand side of Equation (24) is discretized according to the known finite element method, whereas an addition term

(ND_{P}−∫∫∫_{C}W_{P}dxdydz)Q_{O}

is added to the right-hand side of Equation (24), so that a finite element analysis is conducted according to the following equation.

$$- {\sum }_{e} \int \int {\int }_{e} {W}_{P} \{ \frac{\partial }{\partial x} ( λ \frac{\partial T}{\partial x} ) + \frac{\partial }{\partial y} ( λ \frac{\partial T}{\partial y} ) + \frac{\partial }{\partial z} ( λ \frac{\partial T}{\partial z} ) \} d x d y d z = {\sum }_{e} \{ \int \int {\int }_{e} Q d x d y d z + ( {ND}_{P} - \int \int {\int }_{e} {W}_{P} d x d y d z ) {Q}_{o} \} \qquad ( 72 )$$

In Equation (72), ND_{P} denotes a nodal domain of node P in the element e, and Q_{O} is a source value at the coordinate average position of all of the nodes that belong to the element in question. If ND_{P} is equal in volume to the control volume derived from the element integration of the left-hand side of Equation (24), the conservation rule can be satisfied with second-order accuracy, and the mesh dependence is improved; in particular, the effect of improvement in accuracy in low-quality elements can be expected. It may also be proposed to substitute another typical value of the element source term, such as a source value at the center of gravity, for Q_{O} in Equation (72). Also, the element integral of the right-hand side of Equation (72) may be simply approximated by ND_{P}Q_{O}.

In a hexahedral element or pentahedral element of a general shape, nodal domains are calculated by the following method. If the local number of node P in the element e is 1, the result of element integration of the left-hand side of Equation (24) can be arranged or simplified into the following general formula.

$$\int \int {\int }_{e} λ ( \frac{\partial {W}_{1}}{\partial x} \frac{\partial T}{\partial x} + \frac{\partial {W}_{1}}{\partial y} \frac{\partial T}{\partial y} + \frac{\partial {W}_{1}}{\partial z} \frac{\partial T}{\partial z} ) d x d y d z = λ {\sum }_{i = 1}^{N} {A}_{i} {T}_{i} \qquad ( 73 )$$

where N is the number of nodes in one element, namely, N=8 in the case of a hexahedral element), and N=6 in the case of a pentahedral element). Also, coefficient Aᵢ is a constant determined only by the coordinates of the nodes. According to the property of the finite element method, the following expressions are established.

$$\begin{matrix}{A}_{1} > 0 & ( 74 \text{-} 1 ) \\ {\sum }_{i = 1}^{N} {A}_{i} = 0 & ( 74 \text{-} 2 )\end{matrix}$$

(Method 1 of Calculating Nodal Domain in Three-dimensional Hexahedron or Pentahedron) Equation (73) can be rewritten into the following equation, if Equation (74-2) is used.

$$\int \int {\int }_{e} λ ( \frac{\partial {W}_{1}}{\partial x} \frac{\partial T}{\partial x} + \frac{\partial {W}_{1}}{\partial y} \frac{\partial T}{\partial y} + \frac{\partial {W}_{1}}{\partial z} \frac{\partial T}{\partial z} ) d x d y d z = - λ {\sum }_{i = 2}^{N} {A}_{i} ( {T}_{1} - {T}_{i} ) = {\sum }_{i = 2}^{N} ( - {A}_{i} ) {l}_{1 i} \times λ \frac{{T}_{1} - {T}_{i}}{{l}_{1 i}} \qquad ( 75 )$$

In Equation (75), I₁, denotes the distance between node 1 and node i, and is calculated according to the following equation.

l_{Ii}=\sqrt{(x_{I}−xᵢ)²=(y_{I}−yᵢ)²=(z_{I}−zᵢ)²}

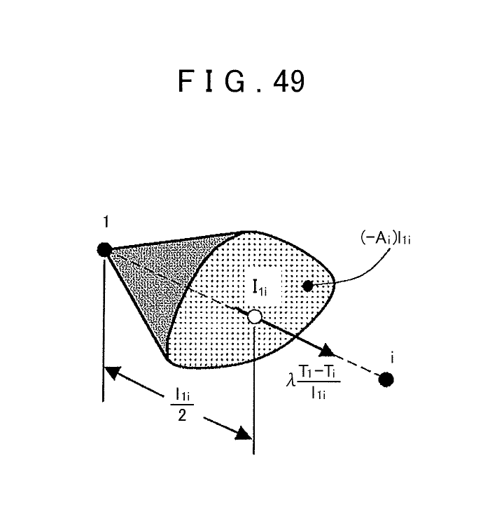

The physical meaning of the right-hand side of Equation (75) is the quantity of heat that passes through an area (−Aᵢ)I₁ᵢ that is perpendicular to the heat flux and passes a middle point (denoted as I₁ᵢ) between node 1 and node i, due to a second-order approximation λ(T₁−Tᵢ)/I₁ᵢ of the heat flux at the middle point I₁ᵢ, which is directed from node 1 toward node i. The volume of the heat source allocated to node 1 due to the quantity of heat thus obtained is that of a cone having an apex at node 1 and an area of base represented by (−Aᵢ)I₁, as shown in FIG. 49. Where ND₁ᵢ represents the volume of the cone, the following equation is obtained.

$${ND}_{1 i} = - \frac{1}{6} \times {A}_{i} {l}_{1 i}^{2} \qquad ( 77 )$$

Where the nodal domain ND₁ of node 1 represents the sum of the volumes of heat sources allocated to the respective heat fluxes, the following equation is obtained.

$${ND}_{1} = {\sum }_{i = 2}^{N} {ND}_{1 i} \qquad ( 78 )$$

The manner of obtaining the nodal domain agrees with the concept of the control volume used when a governing equation of a certain physical quantity is derived from the conservation rule. The nodal domain of Equation (78) is substituted into the right-hand side of Equation (72), so as to improve the accuracy. There may be positive values among the coefficients Aᵢ (i=2, 3, . . . , N). In this case, the heat flows into the cone, and therefore, ND₁ᵢ is negative.

(Method 2 of Calculating Nodal Domain in Three-dimensional Hexahedron, Pentahedron) Those of Aᵢ (i=1, 2, . . . , N) which are larger than 0 (Aᵢ>0) are respectively represented by Bⱼ (j=1, 2, . . . , N⁺), and N⁺ represents the number of the positive coefficients. Also, those of Aᵢ which are equal to or smaller than 0 (Aᵢ≦0) are respectively represented by Cₖ (k=1, 2, . . . , N⁻), and N⁻ represents the number of negative coefficients. In this case, Equation (73) can be expressed by the following equation.

$$\int \int {\int }_{e} λ ( \frac{\partial {W}_{1}}{\partial x} \frac{\partial T}{\partial x} + \frac{\partial {W}_{1}}{\partial y} \frac{\partial T}{\partial y} + \frac{\partial {W}_{1}}{\partial z} \frac{\partial T}{\partial z} ) d x d y d z = λ {\sum }_{j = 1}^{{N}^{+}} {B}_{j} {T}_{j} + λ {\sum }_{k = 1}^{{N}^{-}} {C}_{k} {T}_{k} \qquad ( 79 )$$

Here, subscript i represents numbers assigned to all of the nodes that belong to the element when the nodes are counted from 1 according to a rule determined by the finite element method, and subscript j represents numbers assigned only to the nodes having positive coefficients when they are counted from 1 in any order, while subscript k represents numbers assigned only to the nodes having negative coefficients when they are counted from 1 in any order. Accordingly, even if i, j, k assume the same number, Tᵢ and Tⱼ, and Tᵢ and Tₖ do not necessarily represent the temperature at the same node, and Tⱼ and Tₖ always represent temperatures at different nodes. It is understood from Equation (74-2) that the following equation is established.

$${\sum }_{j = 1}^{{N}^{+}} {B}_{j} = - {\sum }_{k = 1}^{{N}^{-}} {C}_{k} \qquad ( 80 )$$

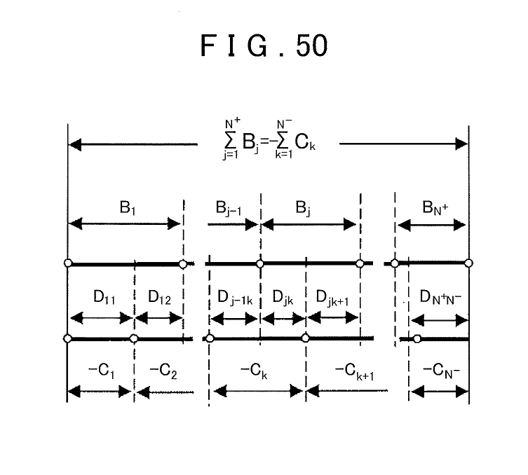

If the value of each coefficient is represented by the length of a rod, the relationship of Equation (80) can be expressed as shown in FIG. 50. If partitions are provided at points between coefficients of adjacent nodes, Equation (73) can be rewritten into the sum of differences between the node temperatures having positive coefficients and the node temperatures having negative coefficients, as indicated by the following equation.

$$\begin{matrix}\int \int {\int }_{e} λ ( \frac{\partial {W}_{1}}{\partial x} \frac{\partial T}{\partial x} + \frac{\partial {W}_{1}}{\partial y} \frac{\partial T}{\partial y} + \frac{\partial {W}_{1}}{\partial z} \frac{\partial T}{\partial z} ) d x d y d z = λ \sum {D}_{jk} ( {T}_{j} - {T}_{k} ) \\ = \sum {D}_{jk} {l}_{jk} \times \\ λ \frac{{T}_{j} - {T}_{k}}{{l}_{jk}}\end{matrix} \qquad ( 81 )$$

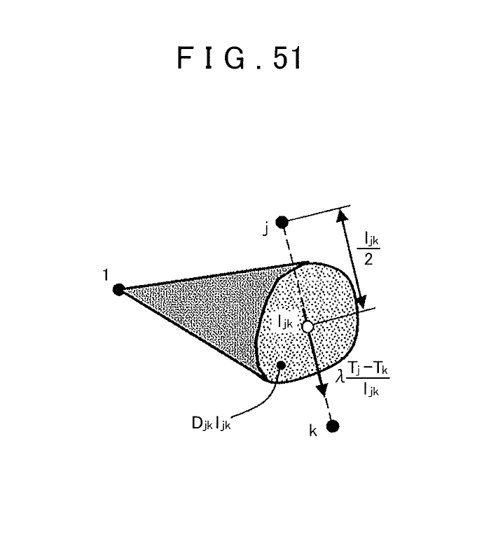

In Equation (81), Dⱼₖ is a positive value, and represents a portion where Bⱼ and −Cₖ overlap each other. σ means the total of combinations of jk, and Iⱼₖ is the distance between node j and node k. The physical meaning of the right-hand side of Equation (81) is the quantity of heat that passes through an area DⱼₖIⱼₖ that is perpendicular to the heat flux and passes a middle point (denoted as Iⱼₖ) between node j and node k, due to a second-order approximation π(Tⱼ−Tₖ)/Iⱼₖ of the heat flux at the middle point Iⱼₖ, which flux is directed from node j toward node k. The volume of the heat source allocated to node 1 due to the heat quantity is that of a cone having an apex at node 1 and an area of base equal to DⱼₖIⱼₖ, as shown in FIG. 51. This volume, which is denoted as NDⱼₖ, is expressed by the following equation.

$${ND}_{jk} = \frac{{D}_{jk}}{3} [ ( {x}_{jk} - {x}_{1} ) ( {x}_{k} - {x}_{j} ) + ( {y}_{jk} - {y}_{1} ) ( {y}_{k} - {y}_{j} ) + ( {z}_{jk} - {z}_{1} ) ( {z}_{k} - {z}_{j} ) ] \qquad ( 82 )$$

The terms in square brackets [ ] in the right-hand side of Equation (82) represent the scalar product of a vector from node 1 to the middle point Iⱼₖ and a vector from node j to node k. When the angle formed by these vectors is within the range of −π/2 to π/2, the heat quantity flows out of the cone, and therefore, NDⱼₖ becomes positive. If the angle is outside the above-indicated range, the heat quantity flows into the cone, and therefore, NDⱼₖ becomes negative. If the nodal domain ND₁ of node 1 is the total of the volumes of the heat sources allocated to the respective heat fluxes, the following equation is obtained.

ND₁=ΣNDⱼₖ (83)

The nodal domain derived in this manner is substituted into the right-hand side of Equation (72), thus assuring improved accuracy.

(About Consistency, Uniqueness, and Normality) The consistency means that the nodal domain and the control volume have the same volume. If the consistency is established, the conservation rule at the node level is satisfied with second-order accuracy, and the effect of improvement in accuracy is theoretically ensured.

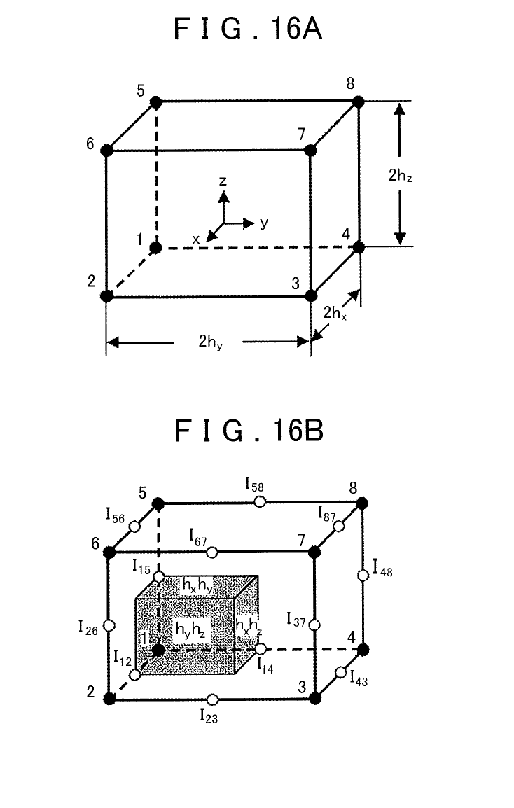

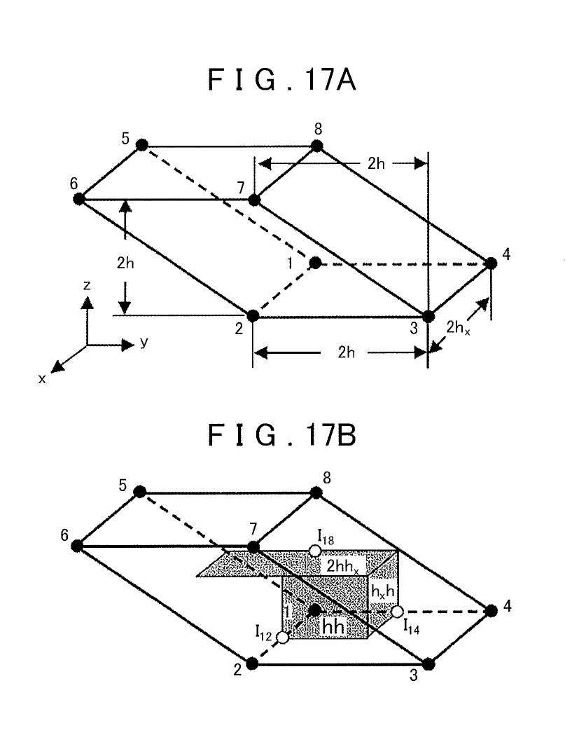

To examine the consistency when the concept of the nodal domain is applied to the rectangular parallelepiped element of FIG. 16, Equation (25) is rewritten into the following equation.

$$\int \int {\int }_{e} λ ( \frac{\partial {W}_{P}}{\partial x} \frac{\partial T}{\partial x} + \frac{\partial {W}_{P}}{\partial y} \frac{\partial T}{\partial y} + \frac{\partial {W}_{P}}{\partial z} \frac{\partial T}{\partial z} ) d x d y d z = 4 ( α + β + γ ) λ {T}_{1} + ( - 4 α + 2 β + 2 γ ) λ {T}_{2} + ( - 2 α - 2 β + γ ) λ {T}_{3} + ( 2 α - 4 β + 2 γ ) λ {T}_{4} + ( 2 α + 2 β - 4 γ ) λ {T}_{5} + ( - 2 α + β - 2 γ ) λ {T}_{6} + ( - α - β - γ ) λ {T}_{7} + ( α - 2 β - 2 γ ) λ {T}_{8} \qquad ( 84 )$$

In Equation (84), α=h_{y}h_{z}/18hₓ, β=hₓh_{z}/18h_{y}, and γ=hₓh_{y}/18h_{z}. The following equation can be obtained by the above-described method 1 of calculating a nodal region.

$$\begin{matrix}{ND}_{12} = - \frac{1}{6} \times ( - 4 α + 2 β + 2 γ ) {( 2 {h}_{x} )}^{2} \\ = \frac{16 {h}_{x}^{2} ( - 2 {h}_{y}^{2} {h}_{z}^{2} + {h}_{x}^{2} {h}_{z}^{2} + {h}_{x}^{2} {h}_{y}^{2} )}{27 V}\end{matrix} \qquad ( 85 )$$

If ND₁ᵢ (i=3, 4, . . . , 8) are obtained in a similar manner, and the sum of ND₁ᵢ is calculated, the following equation is obtained. If this equation is compared with Equation (26), it is found that the nodal region ND₁ thus obtained coincides with the control volume.

NDₗ=hₓh_{y}h_{z}

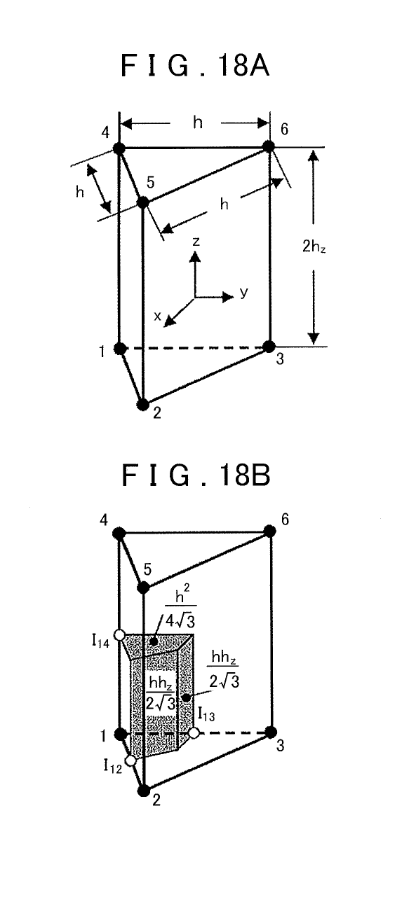

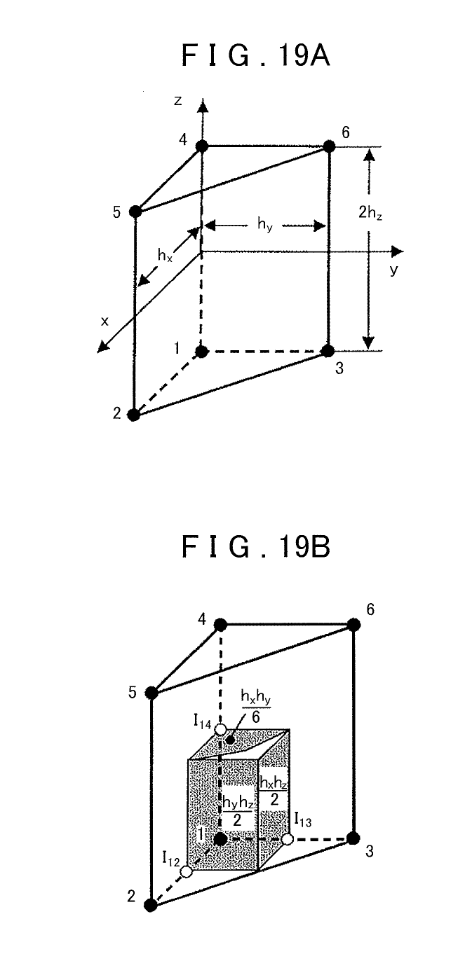

With regard to the other nodes, it is understood that the consistency is satisfied, in view of the symmetry of the element shape. Similarly, it can be proved that the following equation is established with respect to the regular-triangular prism element of FIG. 18A. If this equation is compared with Equation (30), it is found that the consistency is satisfied.

$${ND}_{1} = \frac{{h}^{2} {h}_{z}}{4 \sqrt{3}} \qquad ( 87 )$$

The normality means that the sum of the additional terms added to the right-hand side of Equation (72) with respect to all of the nodes of the same element is equal to zero. Namely,

$${\sum }_{i = 1}^{N} {ND}_{i} = V$$

If the normality is established, it is assured that the conservation rule at the element level is also satisfied in the entire analysis domain. It is understood from the results of Equation (86) and Equation (87) and the symmetry of the element shape that the normality is maintained with respect to the rectangular parallelepiped element and the regular-triangular prism element.

The uniqueness of the nodal domain means that the same result is obtained by the above-described calculation method 1 and calculation method 2. It takes time and effort to theoretically prove the uniqueness since there are numerous variations in the calculation method 2.

It is difficult to theoretically discuss the consistency, normality and the uniqueness with respect to hexahedral elements and pentahedral elements of general shapes because Jacobian is involved. Rather, the consistency is examined in terms of the improvement in accuracy, through numerical analysis as described later in paragraphs titled “Operation and Effect”. The normality and the uniqueness are examined with respect to elements having shapes as follows. A cubic domain (−5≦x, y, z≦5) was divided into a mesh of cubes each having a width of 2, and node 1 was placed at a point where x=y=z=−1, while node 2 was placed at a point where x=1, y=z=−1. The examinations or studies were conducted on all of the element shapes formed from all possible combinations of node 1, node 2, and the remaining six nodes (in the case of a hexahedral element) or four nodes (in the case of a pentahedral element) selected from all lattice points in the mesh. These element shapes may be regarded as covering element shapes used in practical analysis and having an aspect ratio of 3 or smaller. In this case, in the method 2 of calculating the nodal domain, the order in which positive coefficients are arranged starts from the node number 1, and the order in which negative coefficients are arranged is determined in two ways, i.e., it starts from the node number 1 and starts from the node number N. As a result, except for the elements having volumes equal to or below zero and concaved shapes, it was confirmed that the normality and uniqueness are satisfied with respect to all of the test elements.

(Operation and Effect of Invention when applied to Three-dimensional

Hexahedron and Pentahedron) The effect of improvement in accuracy of the conservation type discretization method will be illustrated by way of analysis examples of two heat conduction problems. In the examples, the analysis domain was a cubic domain (0≦x, y, z≦1), and λ was set to 1 (λ=1). As a Dirichlet boundary condition problem, a boundary condition of Equation (89) was added to the source term distribution of Equation (88). Its exact solution is given by Equation (90). Also, as Dirichlet and Neumann boundary condition problems, a Dirichlet boundary condition of Equations (92-1) to (92-3) and a Neumann boundary condition of Equation (93) were added to the source term distribution of Equation (91). Its exact solution is given by (94).

$$\begin{matrix}Q = 3 {π}^{2} sin ( π x ) sin ( π y ) sin ( π z ) & ( 88 ) \\ T = 0 ( x = 0 , 1 , or y = 0 , 1 , or z = 0 , 1 ) & ( 89 ) \\ T = sin ( π x ) sin ( π y ) sin ( π z ) & ( 90 ) \\ Q = \frac{6 + 4 ( {x}^{2} + {y}^{2} + {z}^{2} )}{{e}^{3} - 1} {e}^{( {x}^{2} + {y}^{2} + {z}^{2} )} & ( 91 ) \\ T = \frac{{e}^{3} - {e}^{( 1 + {y}^{2} + {z}^{2} )}}{{e}^{3} - 1} ( x = 1 ) & ( 92 - 1 ) \\ T = \frac{{e}^{3} - {e}^{( {x}^{2} + 1 + {z}^{2} )}}{{e}^{3} - 1} ( y = 1 ) & ( 92 - 2 ) \\ T = \frac{{e}^{3} - {e}^{( {x}^{2} + {y}^{2} + 1 )}}{{e}^{3} - 1} ( z = 1 ) & ( 92 - 3 ) \\ \frac{\partial T}{\partial n} = 0 ( x = 0 , y \neq 1 , z \neq 1 , or \\ y = 0 , x \neq 1 , z \neq 1 , or z = 0 , x \neq 1 , y \neq 1 ) & ( 93 ) \\ T = \frac{{e}^{3} - {e}^{( {x}^{2} + {y}^{2} + {z}^{2} )}}{{e}^{3} - 1} & ( 94 )\end{matrix}$$

Numerical errors in the analysis are evaluated according to the following equation.

$$Max \cdot Error = \frac{Max \cdot \vert {T}_{Ai} - {T}_{Ni} \vert}{{T}_{Amax}} \times 100 ( \% ) \qquad ( 95 )$$

where, T_{Ai} is an exact solution at node i, and T_{Ni} is a numeral solution at node i, while T_{Amax} is the maximum value of the exact solutions.

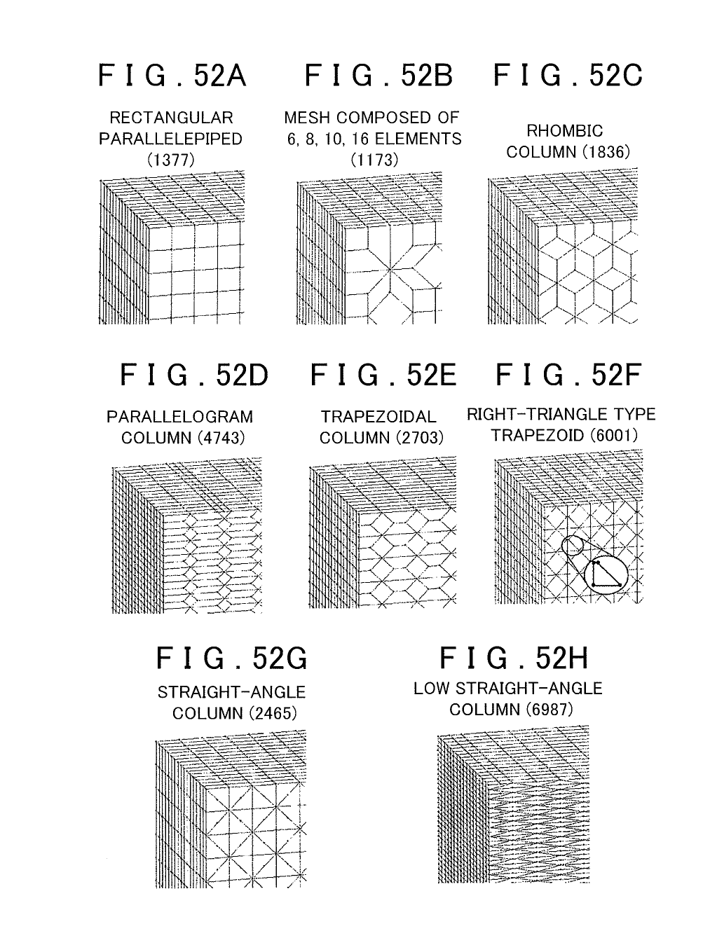

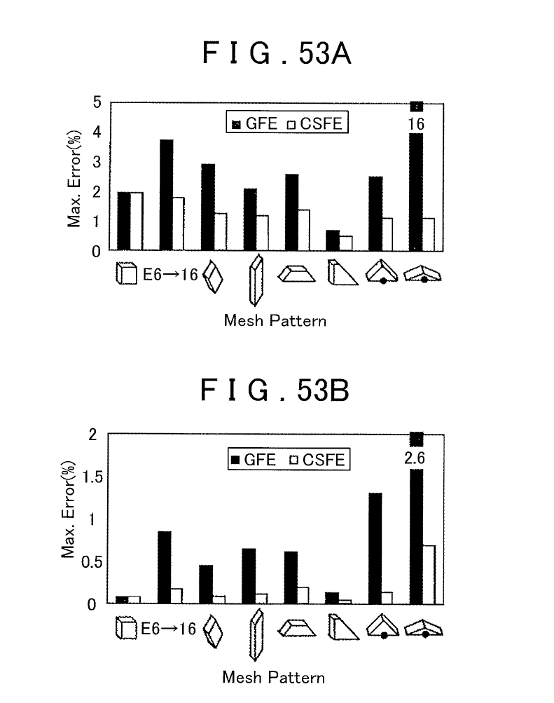

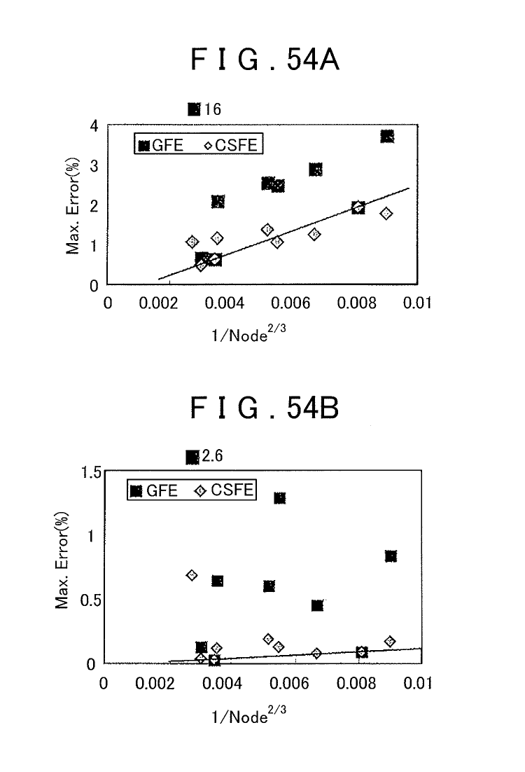

Eight patterns of hexahedral meshes used in the numerical analysis are illustrated in FIGS. 52A-52H, which are created by pushing out a quadrilateral mesh on the xy plane, in the z direction, to form 16 layers. In FIGS. 52A-52H, “•” denotes a node, and the number in parentheses represents the number of all of the nodes in each mesh pattern. Since the mesh has symmetry, only one-fourth of the mesh on the xy plane is illustrated in FIGS. 52A-52H. FIG. 53A shows analysis errors that occurred in the Dirichlet boundary condition problem, and FIG. 53B shows analysis errors that occurred in the Dirichlet and Neumann boundary condition problem. With regard to meshes other than the rectangular parallelepiped of FIG. 52A, it can be recognized that the analysis accuracy of the conservation type discretization (CSFE) of the source term was significantly improved, as compared with the known finite element method (GFE). Also, it is well known that analysis errors are proportional to the square of the mesh width, namely, are proportional to 1/Node^{2/3} in three-dimensional problems. Thus, FIGS. 54A and FIG. 54B show the relationship between the number of nodes in each element shape and analysis errors, with reference to the results indicated by straight lines in FIGS. 54A and 54B with respect to the rectangular parallelepiped mesh. It can be recognized that the analysis accuracy in the conservation type discretization (CSFE) of the source term improved to a level close to that of the rectangular parallelepiped.

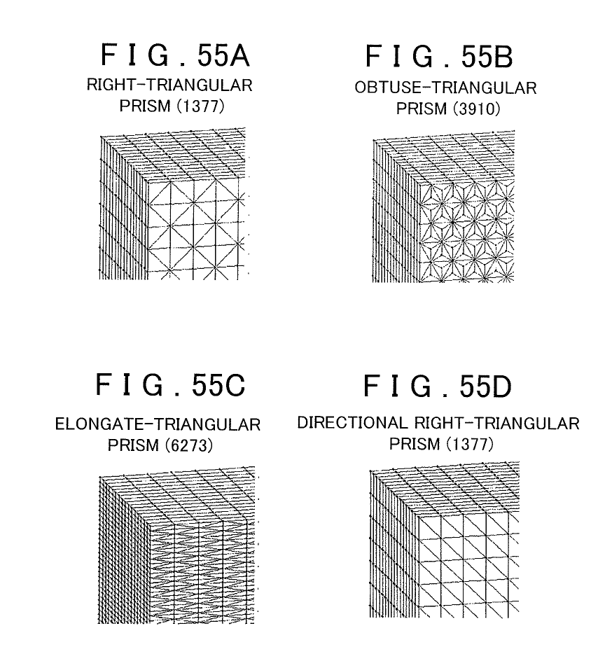

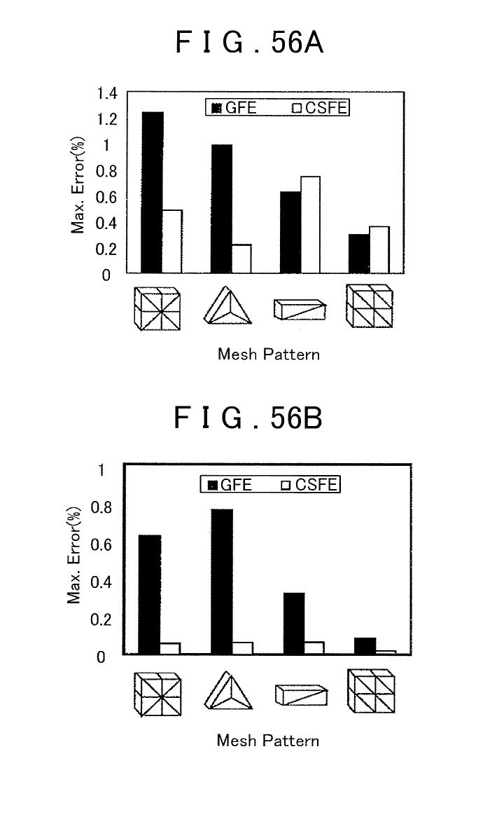

Four patterns of pentahedral meshes used in the numerical analysis are illustrated in FIGS. 55A-55D, which are created by pushing out a triangular mesh on the xy plane, in the z direction, to form 16 layers. In FIGS. 55A-55D, only one-fourth of the mesh on the xy plane is illustrated, in view of the symmetry of the mesh. FIG. 56A shows analysis errors that occurred in the Dirichlet boundary condition problem, and FIG. 56B shows analysis errors that occurred in the Dirichlet and Neumann boundary condition problem. It can be recognized that the analysis accuracy of the conservation type discretization (CSFE) of the source term, under analysis conditions including the natural boundary condition, in particular, significantly improved, as compared with the known finite element method (GFE).

The proposal of this invention yields effects, such as improvement of analysis accuracy, reduction in the number of steps of creating a mesh, and reduction in the analysis time. The proposed method can be implemented only by adding simple correction to a commercially available analysis software, without increasing the calculation cost.

(Analysis Fields to which the Invention can be Simply Applied and Developed) While the application of the present invention has been explained above, taking the heat conduction problem as an example, the analysis method of the invention may be applied as it is to all of the phenomena described by the Poisson equation. The fields to which the analysis method may be applied include, for example, flow problems, electrical and magnetic problems, elastic deformation problems, and substance diffusion problems.

The basic concept of the present invention is to find the control volume in the result of discretization of the elliptic operator from the viewpoint of the conservation rule of second-order accuracy, and match the integral domain of the source term with the control volume. Accordingly, this concept can be easily applied to finite element analyses of various governing equations including elliptic operators derived from the conservation rule. Namely, when generation and disappearance, and outflow and inflow, of a physical quantity are calculated, the concept of the nodal domain derived from the present invention may be introduced or applied to an integral domain over which integration is performed. For example, in a non-steady advection-diffusion analysis, the concept of the integral domain of the source term according to the invention can be applied to discretization of a non-steady term and an advective term.

In the analysis concerned with the load, body force and mass according to the known finite element method, the forces are handled in the same manner as the source term of the right-hand side of Equation (24), namely, the force is distributed into node equations as indicated by

∫∫∫ₑW_{P}fdxdydz

Therefore, an inconsistency problem exists in the analysis according to the known finite element method. The problem may be solved by the manner of handling the source term according to the invention. In the analysis of a three-dimensional problem, if the load, body force, or mass is corrected by adding an additional term thereto, like the source term of the right-hand side of Equation (72), the load, body force, or mass allocated to an object node P is given by

∫∫∫ₑW_{P}fdxdydz+(ND_{P}−∫∫∫ₑW_{P}dxdydz)f_{O} (96)

where f is a given component of the load, a given component of the body force, or the mass.

As explained above, in the analysis method using the finite element method according to the present invention, in the general function term integrating step (source term integrating step, force term integrating step) (step S4) of integrating a general function term (a source term in the case of a heat problem, or the like, or a force term in the case of a problem concerned with the load, body force, or mass), the concept of the nodal domain defined based on the result of discretization of a second-order differential term according to the Galerkin finite element method is introduced, and the general function term (source term, force term) is integrated using a typical value of the element, so that a value (source amount) commensurate with the size of the nodal domain can be incorporated. As a result, analysis errors depending on the mesh pattern can be reduced, and high-accuracy numerical solutions can be obtained from low-quality elements (low-quality mesh patterns). Therefore, an operation to enhance the quantity of the mesh pattern (an operation to make the mesh pattern closer to a pattern of regular triangles, regular tetrahedrons, or squares, for example) is not required, and substantially no increase in the calculation amount arises from correction of the algorithm (program); therefore, an otherwise possible increase in computations performed by the computer can be prevented, and the overall analysis time can be reduced.

With regard to the boundary conditions, the boundary condition introducing step (step S6) is provided for introducing a boundary condition that matches the range of the nodal domain, thus assuring improved accuracy at the node level. As a result, analysis errors depending on the mesh pattern can be further reduced, and high-quality numerical solutions can be obtained from low-quality elements (low-quality mesh patterns).

In the embodiment as described above, in a heat problem, or the like, in particular, (ND−S/3)Q_{G} is added as an additional term to the source term in the case of a two-dimensional triangular element, and (ND−V/4)Q_{G} is added as an additional term to the source term in the case of a three-dimensional tetrahedral element. Also,

(ND_{P}−∫∫ₑW_{P}dxdy)Q_{O}

is added as an additional term to the source term in the case of a two-dimensional quadrangular element, and

(ND_{P}−∫∫∫ₑW_{P}dxdydz)Q_{O}

is added as an additional term to the source term in the case of a three-dimensional hexahedral or pentahedral element. However, the invention is not limited to the use of these additional terms, but another method of changing the source term using a source value at the geometrical center of the element may be used. In this case, the source term (the part in the { } of the right-hand side of Eq. (33), Eq. (36), Eq. (46), or Eq. (72)) may be simply replaced by “ND·Q_{G}”.

In the embodiment as described above, in a problem concerned with the load, body force, or mass, in particular, (ND−S/3)f_{G} is added as an additional term to the general function term in the case of a two-dimensional triangular element, and (ND−V/4)f_{G} is added as an additional term to the general function term in the case of a three-dimensional tetrahedral element. Also,

(ND_{P}−∫∫ₑW_{P}dxdy)fₒ

is added as an additional term to the general function term in the case of a two-dimensional quadrangular element, and

(ND_{P}−∫∫∫ₑW_{P}dxdydz)ƒ_{O}

is added as an additional term to the general function term in the case of a three-dimensional hexahedral or pentahedral element. However, the invention is not limited to the use of these additional terms, but another method of changing the general function term using a value at the geometrical center of the element may be used. In this case, the general function term may be simply replaced by “ND·f_{G}”.

In the embodiment as described above, the invention in the form of the analysis method using the finite element method, and the analysis program using the finite element method, has been explained. However, this invention may be applied to, or may be utilized in the form of an analysis device (analysis system) that implements the analysis method or analysis program, and a recording medium in which the program is recorded or stored.

The analysis method using the finite element method according to the invention, and the analysis program using the finite element method, may be used in various types of analyses of an analysis object, such as heat conduction analysis, fluid flow analysis, electricity flow analysis, magnetic flow analysis, elastic deformation analysis, substance diffusion analysis, load analysis, body force analysis, and mass analysis. In particular, the analysis method or program according to the invention is favorably used in the analysis of the finite element method in which it is desired to reduce errors even if the mesh pattern has a low quality.

What is claimed is:

1. An analysis method using a finite element method, comprising the steps of:
selecting an analysis domain to be analyzed;
dividing the analysis domain into a plurality of elements as calculation objects;
applying a Galerkin weight function with respect to a given node in a given element as one of the plurality of elements, and performing element integration so as to create a matrix of each of the elements;
integrating a general function term as a product of the Galerkin weight function and a general function;
creating simultaneous equations, based on a sum of matrices of respective elements in a domain around the given node, and a sum of values obtained by integrating the general function term;
introducing a boundary condition into the simultaneous equations; and
obtaining a numerical solution by solving the simultaneous equations, wherein
in the general function term integrating step, a concept of a nodal domain defined based on a result of discretization of a second-order differential term according to a Galerkin finite element method is introduced, and the general function term using a typical value of the element is integrated.

2. The analysis method using the finite element method according to claim 1, wherein, in the general function term integrating step, the general function is distributed to the node in accordance with a size of the nodal domain.

3. The analysis method using the finite element method according to claim 1, wherein:
the general function term integrating step is a source term integrating step of integrating a source term as the general function term; and
in the source term integrating step, the source term using a typical source value of the element is integrated.

4. The analysis method using the finite element method according to claim 1, wherein:
the general function term integrating step is a force term integrating step of integrating a force term as the general function term representing load, body force, and mass; and
in the force term integrating step, the force term using a typical force value of the element is integrated.

5. The analysis method using the finite element method according to claim 3, wherein:
the plurality of elements are two-dimensional triangular elements; and
in the source term integrating step, (ND−S/3)Q_{G} is added as an additional term to the source term, where ND is an area of a nodal domain in each of the elements, Q_{G} is a typical source value of the element, and S is an area of the element.

6. The analysis method using the finite element method according to claim 4, wherein:
the plurality of elements are two-dimensional triangular elements; and
in the force term integrating step, (ND−S/3)f_{G} is added as an additional term to the force term, where ND is an area of a nodal domain in each of the elements, f_{G} is a typical force value of the element, and S is an area of the element.

7. The analysis method using the finite element method according to claim 3, wherein:
the plurality of elements are three-dimensional tetrahedral elements; and
in the source term integrating step, (ND·V/4)Q_{G} is added as an additional term to the source term, where ND is a volume of a nodal domain in each of the elements, Q_{G} is a typical source value of the element, and V is a volume of the element, and the ND of node 1 is given by
$$ND = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} )$$

8. The analysis method using the finite element method according to claim 4, wherein:
the plurality of elements are three-dimensional tetrahedral elements; and
in the force term integrating step, (ND−V/4)f_{G} is added as an additional term to the force term, where ND is a volume of a nodal domain in each of the elements, f_{G} is a typical force value of the element, and V is a volume of the element, and the ND of node 1 is given by
$$ND = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} )$$

9. The analysis method using the finite element method according to claim 3, wherein:
the plurality of elements are two-dimensional quadrangular elements; and
in the source term integrating step,
(ND_{P}−∫∫ₑW_{P}dxdy)Q_{O}
is added as an additional term to the source term, where ND_{P} is a nodal domain in each of the elements, W_{P} is the Galerkin weight function, and Q_{O} is a typical source value of the element.

10. The analysis method using the finite element method according to claim 4, wherein:
the plurality of elements are two-dimensional quadrangular elements; and
in the force term integrating step,
(ND_{P}−∫∫ₑW_{P}dxdy)fₒ
is added as an additional term to the force term, where ND_{P} is a nodal domain in each of the elements, W_{P} is the Galerkin weight function, and f_{O} is a typical force value of the element.

11. The analysis method using the finite element method according to claim 3, wherein:
the plurality of elements are three-dimensional hexahedral or pentahedral elements; and
in the source term integrating step,
(ND_{P}−∫∫∫ₑW_{P}dxdydz)Q_{O}
is added as an additional term to the source term, where ND_{P} is a nodal domain in each of the elements, W_{P} is the Galerkin weight function, and Q_{O} is a typical source value of the element.

12. The analysis method using the finite element method according to claim 4, wherein:
the plurality of elements are three-dimensional hexahedral or pentahedral elements; and
in the force term integrating step,
(ND_{P}−∫∫∫ₑW_{P}dxdydz)f_{O}
is added as an additional term to the force term, where ND_{P} is a nodal domain in each of the elements, W_{P} is the Galerkin weight function, and f_{O} is a typical force value of the element.

13. The analysis method using the finite element method according to claims 2, wherein, in the boundary condition introducing step, when a heat flux that passes a natural boundary of each of the elements is not equal to zero, a boundary heat flux is allocated to the node in accordance with a range of the nodal domain.

14. The analysis method using the finite element method according to any one of claims 2, wherein, in the boundary condition introducing step, when the load, body force, or mass at a boundary of each of the elements is not equal to zero, the load, body force, or mass is allocated to the node in accordance with a range of the nodal domain.

15. An analytical computation program using a finite element method, for causing a computer to perform analytical computations using the finite element method, which causes the computer to execute the steps of:
selecting an analysis domain to be analyzed;
dividing the analysis domain into a plurality of elements as calculation objects;
applying a Galerkin weight function with respect to a given node in a given element as one of the plurality of elements, and performing element integration so as to create a matrix of each of the elements;
integrating a general function term as a product of the Galerkin weight function and a general function, wherein a concept of a nodal domain defined based on a result of discretization of a second-order differential term according to a Galerkin finite element method is introduced, and the general function term using a typical value of the element is integrated;
creating simultaneous equations, based on a sum of matrices of respective elements in a domain around the given node, and a sum of values obtained by integrating the general function term;
introducing a boundary condition into the simultaneous equations; and
obtaining a numerical solution by solving the simultaneous equations.

16. The analytical computation program using the finite element method according to claim 15, wherein, in the general function term integrating step, the general function is distributed to the node in accordance with a size of the nodal domain.

17. The analytical computation program using the finite element method according to claim 15, wherein:
the general function term integrating step is a source term integrating step of integrating a source term as the general function term, in which the source term using a typical source value of the element is integrated.

18. The analytical computation program using the finite element method according to claim 15, wherein:
the general function term integrating step is a force term integrating step of integrating a force term as the general function term representing load, body force, and mass, in which the force term using a typical force value of the element is integrated.

19. The analytical computation program using the finite element method according to claim 17, wherein:
the plurality of elements are two-dimensional triangular elements; and
in the source term integrating step, (ND−S/3)Q_{G} is added as an additional term to the source term, where ND is an area of a nodal domain in each of the elements, Q_{G} is a typical source value of the element, and S is an area of the element.

20. The analytical computation program using the finite element method according to claim 18, wherein:
the plurality of elements are two-dimensional triangular elements; and
in the force term integrating step, (ND−S/3)f_{G} is added as an additional term to the force term, where ND is an area of a nodal domain in each of the elements, f_{G} is a typical force value of the element, and S is an area of the element.

21. The analytical computation program using the finite element method according to claim 17, wherein:
the plurality of elements are three-dimensional tetrahedral elements; and
in the source term integrating step, (ND−V/4)Q_{G} is added as an additional term to the source term, where ND is a volume of a nodal domain in each of the elements, Q_{G} is a typical source value of the element, and V is a volume of the element, and the ND of node 1 is given by
$$ND = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} )$$

22. The analytical computation program using the finite element method according to claim 18, wherein:
the plurality of elements are three-dimensional tetrahedral elements; and
in the force term integrating step, (ND−V/4)f_{G} is added as an additional term to the force term, where ND is a volume of a nodal domain in each of the elements, f_{G} is a typical force value of the element, and V is a volume of the element, and the ND of node 1 is given by
$$ND = \frac{1}{3} \times ( \frac{{S}_{12} \sqrt{{x}_{2}^{2} + {y}_{2}^{2} + {z}_{2}^{2}}}{2} + \frac{{S}_{13} \sqrt{{x}_{3}^{2} + {y}_{3}^{2} + {z}_{3}^{2}}}{2} + \frac{{S}_{14} \sqrt{{x}_{4}^{2} + {y}_{4}^{2} + {z}_{4}^{2}}}{2} )$$

23. The analytical computation program using the finite element method according to claim 17, wherein:
the plurality of elements are two-dimensional quadrangular elements; and
in the source term integrating step,
(ND_{P}−∫∫ₑW_{P}dxdy)Qₒ
is added as an additional term to the source term, where ND_{P} is a nodal domain in each of the elements, W_{P} is the Galerkin weight function, and Q_{O} is a typical source value of the element.

24. The analytical computation program using the finite element method according to claim 18, wherein:
the plurality of elements are two-dimensional quadrangular elements; and
in the force term integrating step,
(ND_{P}−∫∫∫ₑW_{P}dxdy)fₒ
is added as an additional term to the force term, where ND_{P} is a nodal domain in each of the elements, Wₚ is the Galerkin weight function, and f_{O} is a typical force value of the element.

25. The analytical computation program using the finite element method according to claim 17, wherein:
the plurality of elements are three-dimensional hexahedral or pentahedral elements; and
in the source term integrating step,
(ND_{P}−∫∫∫ₑW_{P}dxdydz)Q_{O}
is added as an additional term to the source term, where ND_{P} is a nodal domain in each of the elements, Wₚ is the Galerkin weight function, and Q_{O} is a typical source value of the element.

26. The analytical computation program using the finite element method according to claim 18, wherein:
the plurality of elements are three-dimensional hexahedral or pentahedral elements; and
in the force term integrating step,
(ND_{P}−∫∫∫ₑW_{P}dxdydz)f_{O}
is added as an additional term to the force term, where ND_{P} is a nodal domain in each of the elements, W_{P} is the Galerkin weight function, and f_{O} is a typical force value of the element.

27. The analytical computation program using the finite element method according to any one of claims 16, wherein, in the boundary condition introducing step, when a heat flux that passes a natural boundary of each of the elements is not equal to zero, a boundary heat flux is allocated to the node in accordance with a range of the nodal domain.

28. The analytical computation program using the finite element method according to any one of claims 16, wherein, in the boundary condition introducing step, when the load, body force, or mass at a boundary of each of the elements is not equal to zero, the load, body force, or mass is allocated to the node in accordance with a range of the nodal domain.
